(19) United States
(12) Patent Application Publication
(10) Pub. No.: US 2025/0172790 A1
(43) Pub. Date: May 29, 2025

(54) TELEPHOTO ZOOM LENS

(71) Applicant: SIGMA CORPORATION, Kanagawa (JP)

(72) Inventor: Kenta FUJITA, Tokyo (JP)

(73) Assignee: SIGMA CORPORATION, Kanagawa (JP)

(21) Appl. No.: 18/944,889

(22) Filed: Nov. 12, 2024

(30) Foreign Application Priority Data
Nov. 27, 2023 (JP) 2023-199725

(51) Int. Cl. G02B 13/00; G02B 13/02; G02B 15/14

(52) U.S. Cl. CPC G02B 13/009; G02B 13/02; G02B 15/1461

(57) ABSTRACT

A telephoto zoom lens according to the present invention includes: a first lens group with a positive refractive power; a middle lens group; and a final lens group in order from an object side to an image side, and at a time of zooming from a wide-angle end to a telephoto end, the first lens group is fixed with respect to an image surface, distances between adjacent lens groups change, focusing from an infinity object distance to an extremely close range is performed by moving a part or a plurality of lens groups in the middle lens group, the first lens group includes a front sub-lens group located on the object side and a rear sub-lens group located on the image side, and predetermined conditional expressions are satisfied.

### FIELD OF THE INVENTION

The present invention relates to a telephoto zoom lens with a small size and a light weight that is suitable for a digital camera, a silver halide camera, a video camera, and the like and is particularly suitable for a mirrorless camera.

### DESCRIPTION OF THE RELATED ART

A typical telephoto lens is typically designed such that an entire length of an optical system is shortened as compared with a focal length by adopting a so-called telephoto-type power arrangement of a positive front group and a negative rear group. Also, since the diameter of the front group in the telephoto lens depends on an entrance pupil diameter of the entire system, a focal length designed to be long in order to obtain a desired angle of view leads to an increase in diameter of the front group and an increase in weight. Since the center of gravity of the optical system becomes farther from a person who captures an image by the diameter of the front group increasing and by the weight increasing, a physical burden on the person who captures an image increases in a case where the person holds the optical system in a state where the lens is kept horizontal, in particular. Furthermore, in a case where this is adopted to a zoom lens, the entire length of the optical system increases in order to secure a space necessary for zooming, and the center of gravity of the optical system becomes farther from the person who captures an image.

Japanese Patent Application Publication No. 2022-026392 and Japanese Patent No. 7324429 disclose telephoto zoom lenses in the related art.

### SUMMARY OF THE INVENTION

According to the telephoto zoom lenses disclosed in Japanese Patent Application Publication No. 2022-026392 and Japanese Patent No. 7324429, the entire lengths of the entire lens systems of the telephoto zoom lenses are reduced to be short by suppressing ratios (telephoto ratios) of the entire lens lengths with respect to focal lengths. On the other hand, weight reduction of lens groups on the side closest to objects which are the heaviest in the entire lens systems is insufficient, and there are problems that the weights of the entire lens systems increases and the centers of gravity of the entire lens systems become farther from persons who capture images.

The present invention was made in view of such circumstances, and an object thereof is to provide a telephoto zoom lens with a reduced entire length and a reduced weight of an entire lens system and with little variation in aberration in an entire imaging region.

In order to solve the above problem, a telephoto zoom lens according to the present invention includes, in order from an object side to an image side: a first lens group G1 with a positive refractive power; a middle lens group Gm; and a final lens group Gr, and is characterized in that at a time of zooming from a wide-angle end to a telephoto end, the first lens group G1 is fixed with respect to an image surface, distances between adjacent lens groups change, focusing from an infinity object distance to an extremely close range is performed by moving a part or a plurality of lens groups in the middle lens group Gm, the first lens group G1 is composed of a front sub-lens group Gif located on the object side and a rear sub-lens group G1r located on the image side, and conditional expressions below are satisfied:

$$LT / ft < 0.93 \qquad ( 1 )$$

$$0.17 < d 1 / LT < 0. 45 \qquad ( 2 )$$

where
LT is a distance from a surface on a side closest to an object in an entire lens system to an image surface,
ft is a focal length of the entire lens system at a telephoto end at the time of focusing on infinity, and
d1 is a distance from a surface of the front sub-lens group Gif on a side closest to an image to a surface of the rear sub-lens group G1r on a side closest to an object

According to the present invention, it is possible to provide a telephoto zoom lens with a reduced entire length and a reduced weight of an entire lens system and with little variation in aberration in an entire imaging region.

### BRIEF DESCRIPTION OF THE DRAWINGS

FIG. 1 is a configuration diagram according to Example 1 of a telephoto zoom lens of the present invention;

FIGS. 2A and 2B are longitudinal aberration diagrams of a wide-angle end of the telephoto zoom lens according to Example 1 of the present invention, FIG. 2A at the time of focusing on infinity and FIG. 2B at the time of a photographing magnification of 1:40;

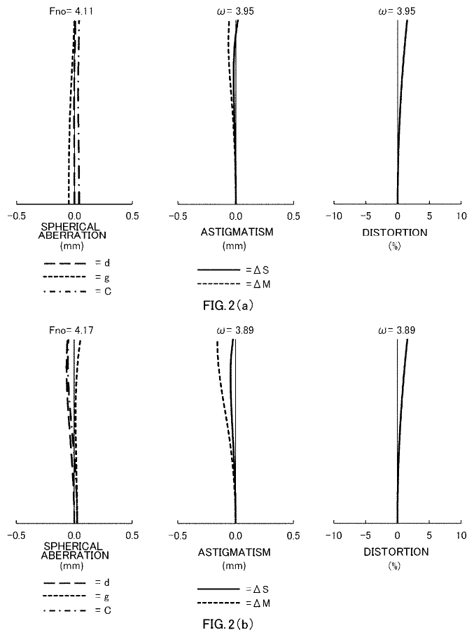

FIGS. 3A and 3B are longitudinal aberration diagrams of a zoom center position of the telephoto zoom lens according to Example 1 of the present invention FIG. 3A at the time of focusing on infinity and FIG. 3B at the time of the photographing magnification of 1:40;

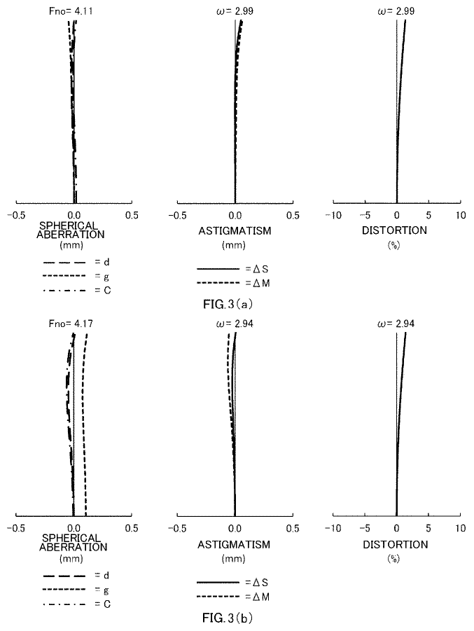

FIGS. 4A and 4B are longitudinal aberration diagrams of a telephoto end of the telephoto zoom lens according to Example 1 of the present invention, FIG. 4A at the time of focusing on infinity and FIG. 4B at the time of the photographing magnification of 1:40;

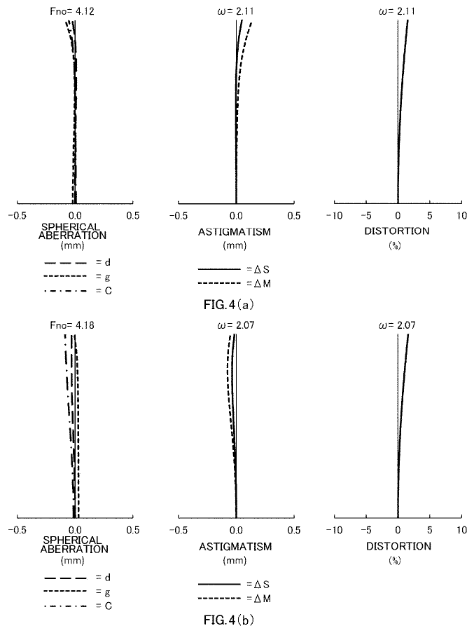

FIGS. 5A and 5B are lateral aberration diagrams of the wide-angle end of the telephoto zoom lens according to Example 1 of the present invention, FIG. 5A at the time of focusing on infinity and FIG. 5B at the time of the photographing magnification of 1:40;

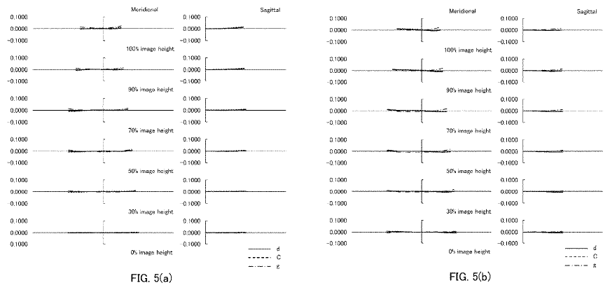

FIGS. 6A and 6B are lateral aberration diagrams of the zoom center position of the telephoto zoom lens according to Example 1 of the present invention, FIG. 6A at the time of focusing on infinity and FIG. 6B at the time of the photographing magnification of 1:40;

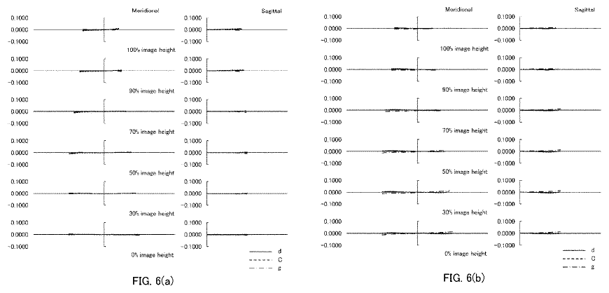

FIGS. 7A and 7B are lateral aberration diagrams of the telephoto end of the telephoto zoom lens according to Example 1 of the present invention, FIG. 7A at the time of focusing on infinity and FIG. 7B at the time of the photographing magnification of 1:40;

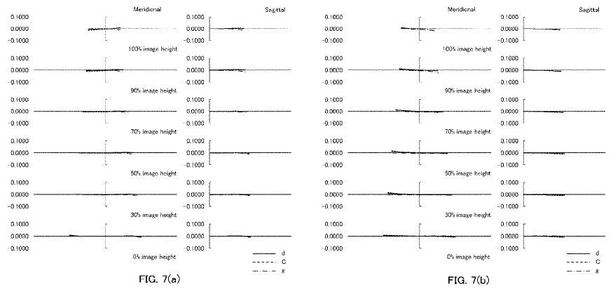

FIGS. 8A and 8B are lateral aberration diagrams during 0.3° vibration reduction FIG. 8A at the wide-angle end and FIG. 8B at the telephoto end of the telephoto zoom lens according to Example 1 of the present invention at the time of focusing on infinity;

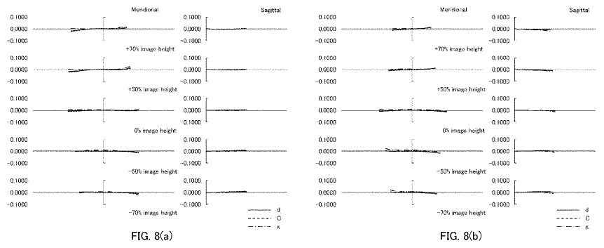

FIG. 9 is a configuration diagram according to Example 2 of a telephoto zoom lens of the present invention;

FIGS. 10A and 10B are longitudinal aberration diagrams of a wide-angle end of the telephoto zoom lens according to Example 2 of the present invention, FIG. 10A at the time of focusing on infinity and FIG. 10B at the time of a photographing magnification of 1:40;

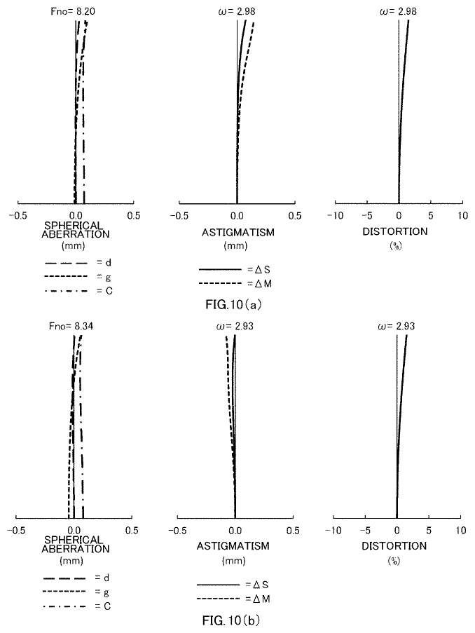

FIGS. 11A and 11B are longitudinal aberration diagrams of a zoom center position of the telephoto zoom lens according to Example 2 of the present invention, FIG. 11A at the time of focusing on infinity and FIG. 11B at the time of the photographing magnification of 1:40;

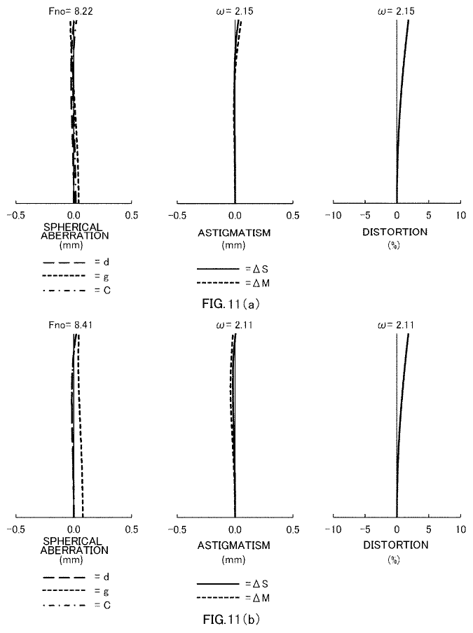

FIGS. 12A and 12B are longitudinal aberration diagrams of a telephoto end of the telephoto zoom lens according to Example 2 of the present invention, FIG. 12A at the time of focusing on infinity and FIG. 12B at the time of the photographing magnification of 1:40;

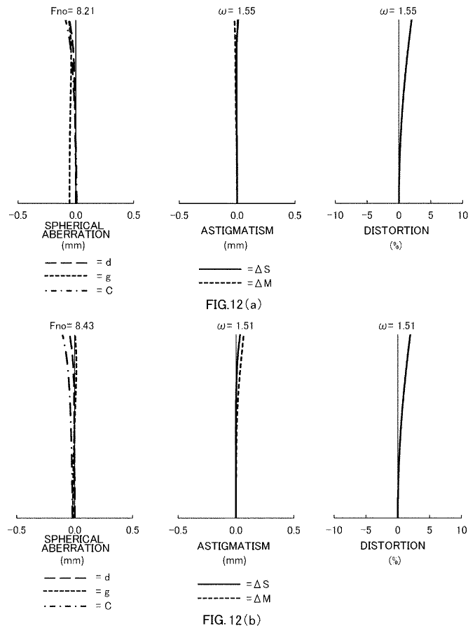

FIGS. 13A and 13B are lateral aberration diagrams of the wide-angle end of the telephoto zoom lens according to Example 2 of the present invention, FIG. 13A at the time of focusing on infinity and FIG. 13B at the time of the photographing magnification of 1:40;

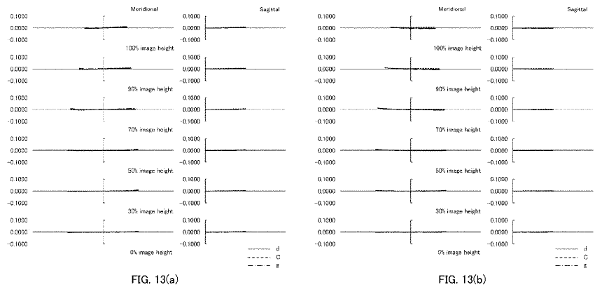

FIGS. 14A and 14B are lateral aberration diagrams of the zoom center position of the telephoto zoom lens according to Example 2 of the present invention, FIG. 14A at the time of focusing on infinity and FIG. 14B at the time of the photographing magnification of 1:40;

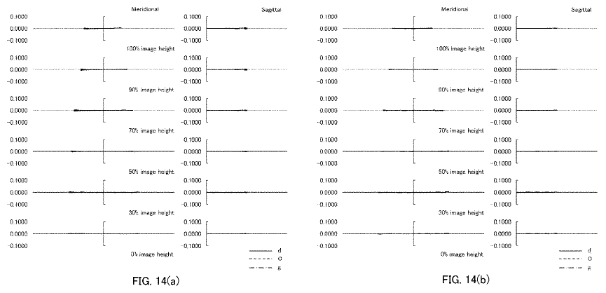

FIGS. 15A and 15B are lateral aberration diagrams of the telephoto end of the telephoto zoom lens according to Example 2 of the present invention, FIG. 15A at the time of focusing on infinity and FIG. 15B at the time of the photographing magnification of 1:40;

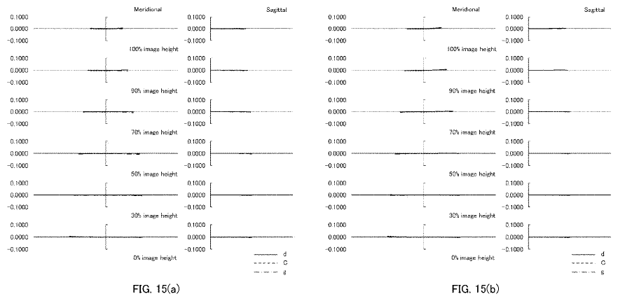

FIGS. 16A and 16B are lateral aberration diagrams during 0.3° vibration reduction FIG. 16A at the wide-angle end and FIG. 16B at the telephoto end of the telephoto zoom lens according to Example 2 of the present invention at the time of focusing on infinity;

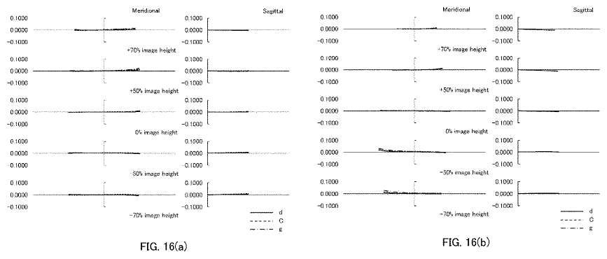

FIG. 17 is a configuration diagram according to Example 3 of a telephoto zoom lens of the present invention;

FIGS. 18A and 18B are longitudinal aberration diagrams of a wide-angle end of the telephoto zoom lens according to Example 3 of the present invention, FIG. 18A at the time of focusing on infinity and FIG. 18B at the time of a photographing magnification of 1:40;

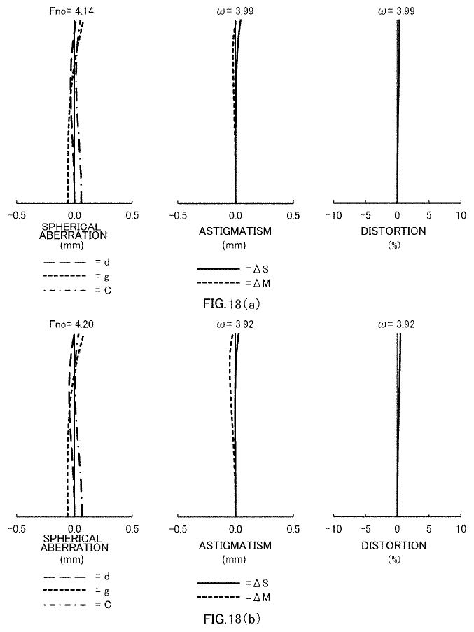

FIGS. 19A and 19B are longitudinal aberration diagrams of a zoom center position of the telephoto zoom lens according to Example 3 of the present invention, FIG. 19A at the time of focusing on infinity and FIG. 19B at the time of the photographing magnification of 1:40;

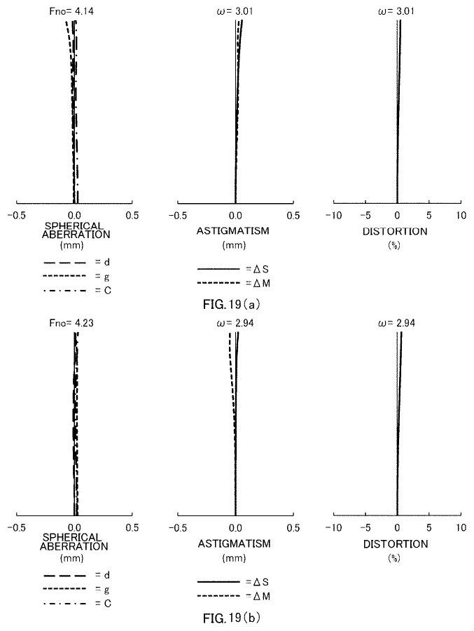

FIGS. 20A and 20B are longitudinal aberration diagrams of a telephoto end of the telephoto zoom lens according to Example 3 of the present invention, FIG. 20A at the time of focusing on infinity and FIG. 20B at the time of the photographing magnification of 1:40;

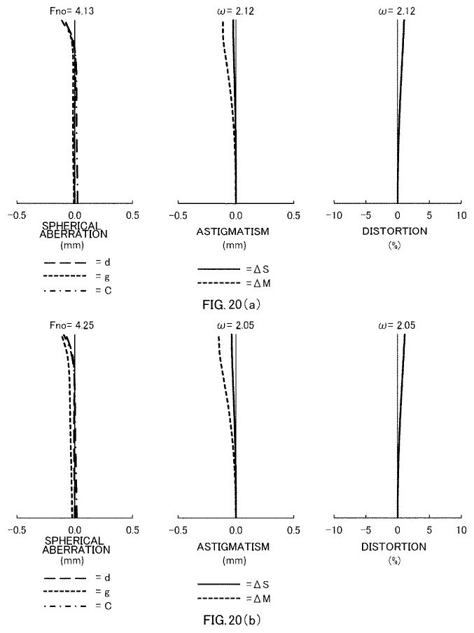

FIGS. 21A and 21B are lateral aberration diagrams of the wide-angle end of the telephoto zoom lens according to Example 3 of the present invention, FIG. 21A at the time of focusing on infinity and FIG. 21B at the time of the photographing magnification of 1:40;

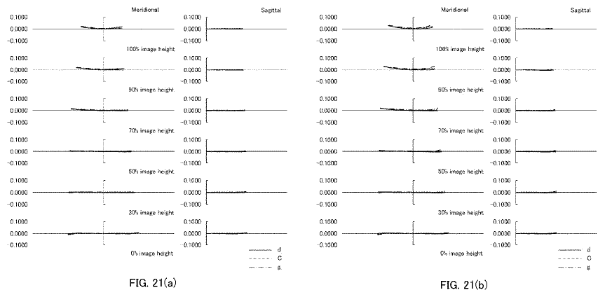

FIGS. 22A and 22B are lateral aberration diagrams of the zoom center position of the telephoto zoom lens according to Example 3 of the present invention, FIG. 22A at the time of focusing on infinity and FIG. 22B at the time of the photographing magnification of 1:40;

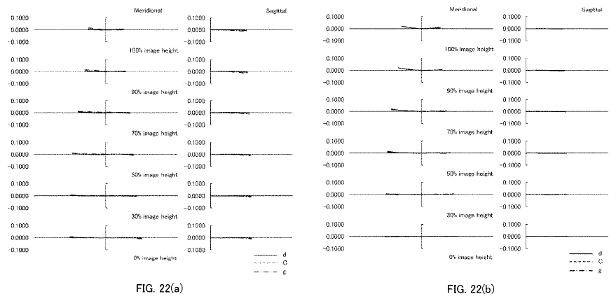

FIGS. 23A and 23B are lateral aberration diagrams of the telephoto end of the telephoto zoom lens according to Example 3 of the present invention, FIG. 23A at the time of focusing on infinity and FIG. 23B at the time of the photographing magnification of 1:40;

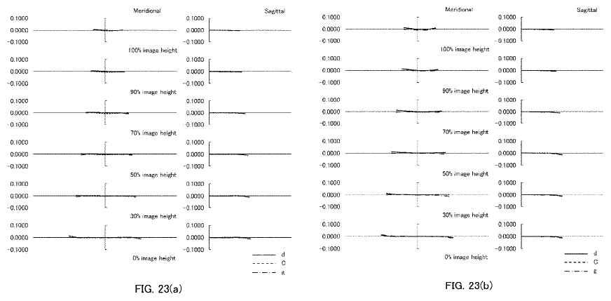

FIGS. 24A and 24B are lateral aberration diagrams during 0.3° vibration reduction FIG. 24A at the wide-angle end and FIG. 24B at the telephoto end of the telephoto zoom lens according to Example 3 of the present invention at the time of focusing on infinity;

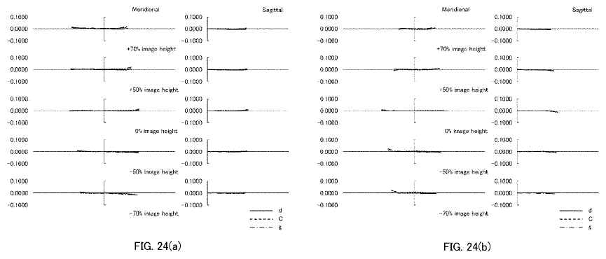

FIG. 25 is a configuration diagram according to Example 4 of a telephoto zoom lens of the present invention;

FIGS. 26A and 26B are longitudinal aberration diagrams of a wide-angle end of the telephoto zoom lens according to Example 4 of the present invention, FIG. 26A at the time of focusing on infinity and FIG. 26B at the time of a photographing magnification of 1:40;

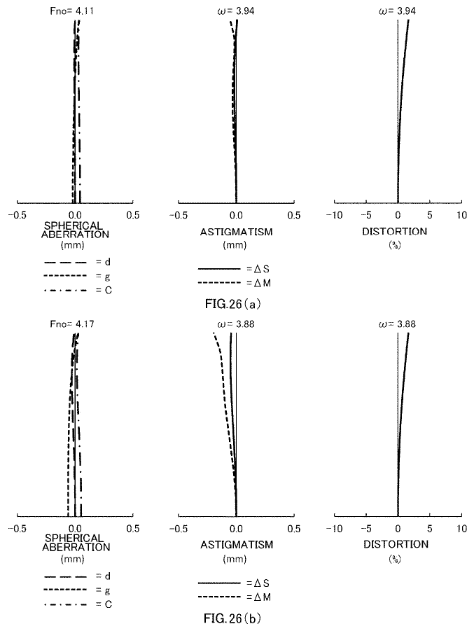

FIGS. 27A and 27B are longitudinal aberration diagrams of a zoom center position of the telephoto zoom lens according to Example 4 of the present invention, FIG. 27A at the time of focusing on infinity and FIG. 27B at the time of the photographing magnification of 1:40;

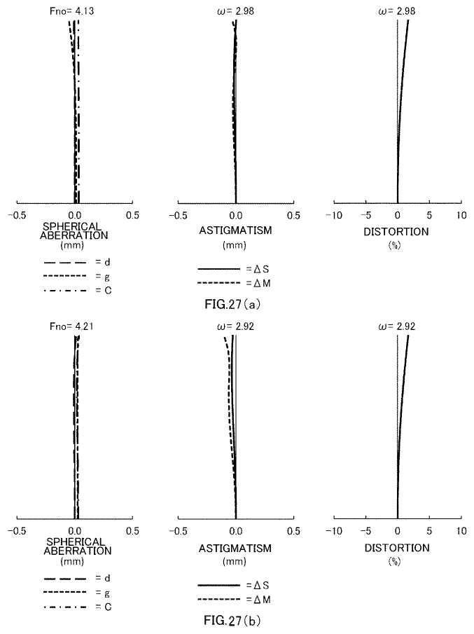

FIGS. 28A and 28B are longitudinal aberration diagrams of a telephoto end of the telephoto zoom lens according to Example 4 of the present invention, FIG. 28A at the time of focusing on infinity and FIG. 28B at the time of the photographing magnification of 1:40;

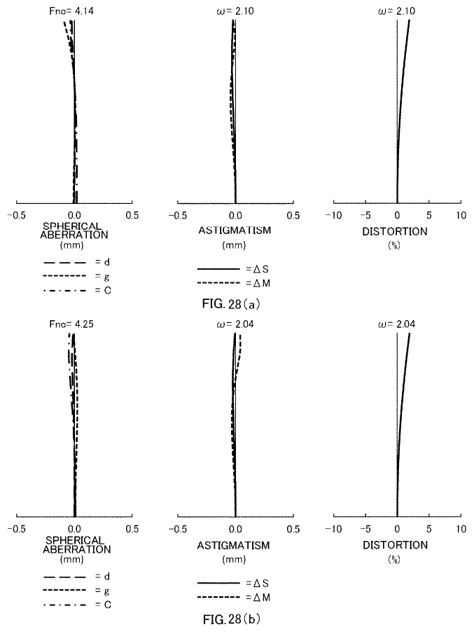

FIGS. 29A and 29B are lateral aberration diagrams of the wide-angle end of the telephoto zoom lens according to Example 4 of the present invention, FIG. 29A at the time of focusing on infinity and FIG. 29B at the time of the photographing magnification of 1:40;

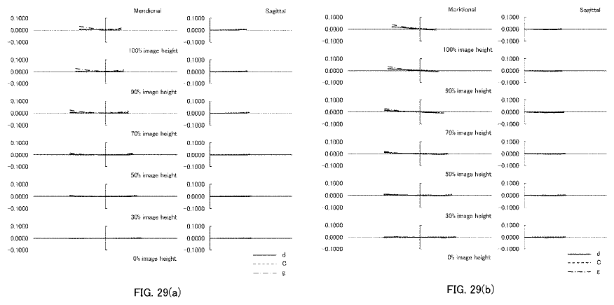

FIGS. 30A and 30B are lateral aberration diagrams of the zoom center position of the telephoto zoom lens according to Example 4 of the present invention, FIG. 30A at the time of focusing on infinity and FIG. 30B at the time of the photographing magnification of 1:40;

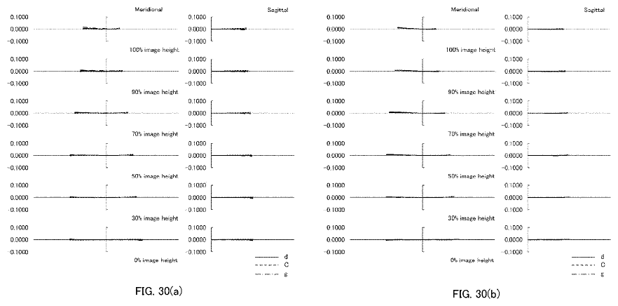

FIGS. 31A and 31B are lateral aberration diagrams of the telephoto end of the telephoto zoom lens according to Example 4 of the present invention, FIG. 31A at the time of focusing on infinity and FIG. 31B at the time of the photographing magnification of 1:40;

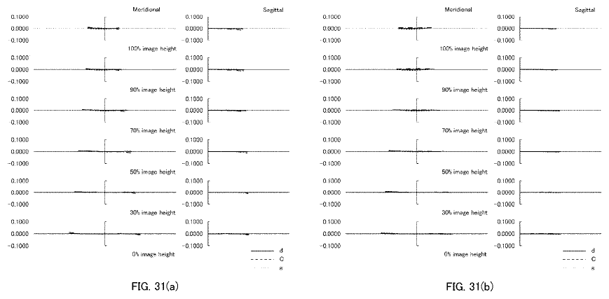

FIGS. 32A and 32B are lateral aberration diagrams during 0.3° vibration reduction FIG. 32A at the wide-angle end and FIG. 32B at the telephoto end of the telephoto zoom lens according to Example 4 of the present invention at the time of focusing on infinity;

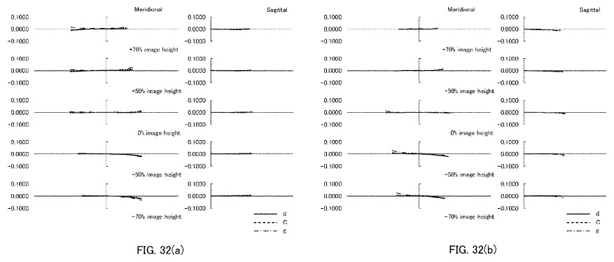

FIG. 33 is a configuration diagram according to Example 5 of a telephoto zoom lens of the present invention;

FIGS. 34A and 34B are longitudinal aberration diagrams of a wide-angle end of the telephoto zoom lens according to Example 5 of the present invention, FIG. 34A at the time of focusing on infinity and FIG. 34B at the time of a photographing magnification of 1:40;

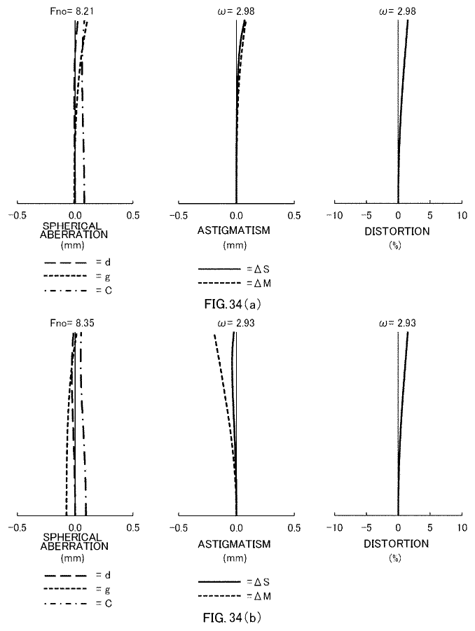

FIGS. 35A and 35B are longitudinal aberration diagrams of a zoom center position of the telephoto zoom lens according to Example 5 of the present invention, FIG. 35A at the time of focusing on infinity and FIG. 35B at the time of the photographing magnification of 1:40;

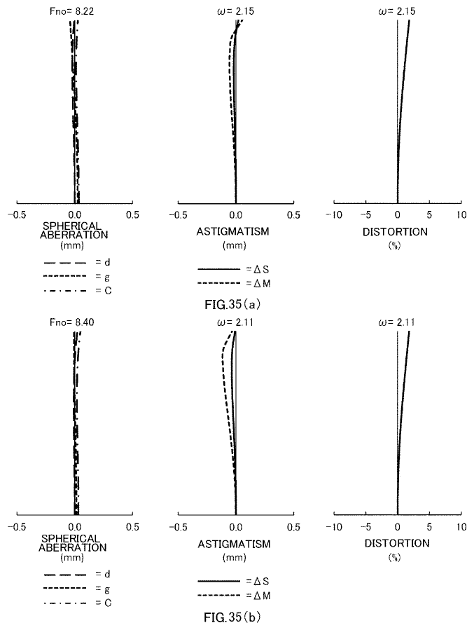

FIGS. 36A and 36B are longitudinal aberration diagrams of a telephoto end of the telephoto zoom lens according to Example 5 of the present invention, FIG. 36A at the time of focusing on infinity and FIG. 36B at the time of the photographing magnification of 1:40;

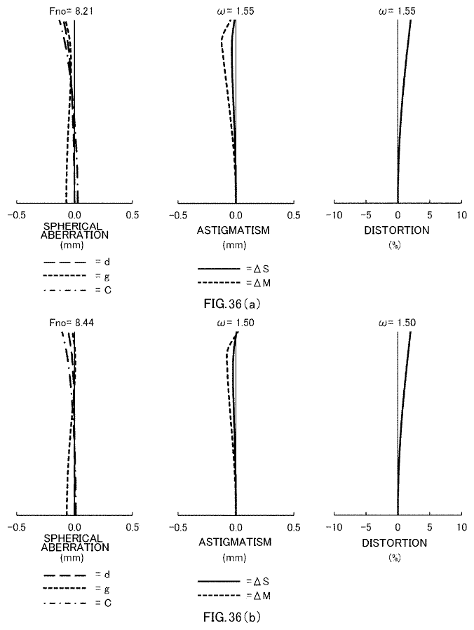

FIGS. 37A and 37B are lateral aberration diagrams of the wide-angle end of the telephoto zoom lens according to Example 5 of the present invention, FIG. 37A at the time of focusing on infinity and FIG. 37B at the time of the photographing magnification of 1:40;

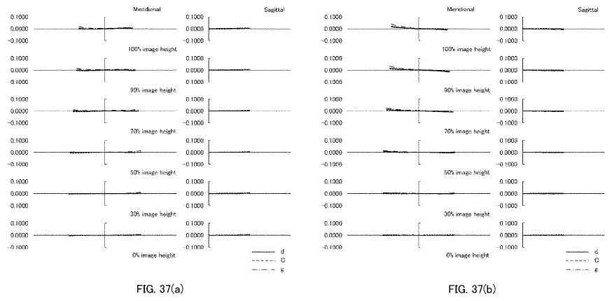

FIGS. 38A and 38B are lateral aberration diagrams of the zoom center position of the telephoto zoom lens according to Example 5 of the present invention, FIG. 38A at the time of focusing on infinity and FIG. 38B at the time of the photographing magnification of 1:40;

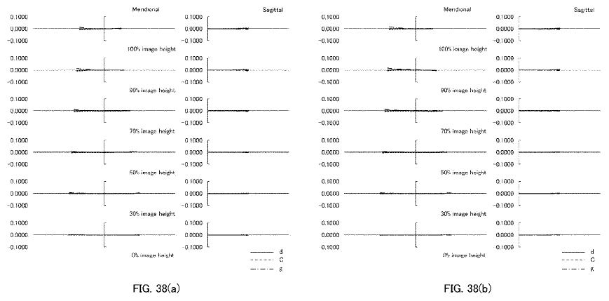

FIGS. 39A and 39B are lateral aberration diagrams of the telephoto end of the telephoto zoom lens according to Example 5 of the present invention, FIG. 39A at the time of focusing on infinity and FIG. 39B at the time of the photographing magnification of 1:40;

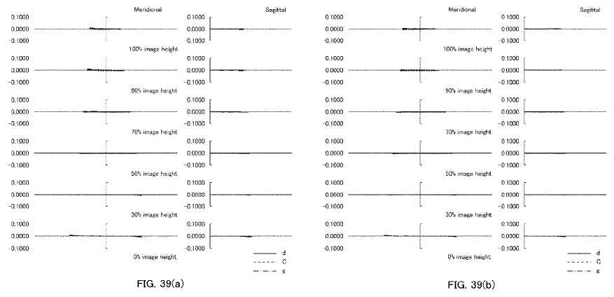

FIGS. 40A and 40B are lateral aberration diagrams during 0.3° vibration reduction FIG. 40A at the wide-angle end and FIG. 40B at the telephoto end of the telephoto zoom lens according to Example 5 of the present invention at the time of focusing on infinity;

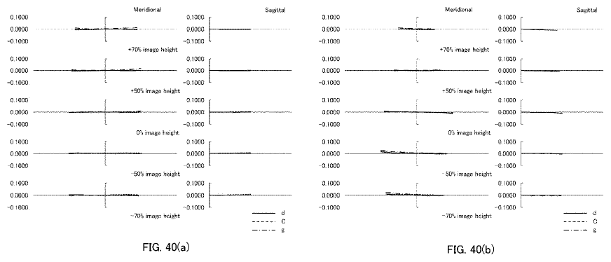

FIG. 41 is a configuration diagram according to Example 6 of a telephoto zoom lens of the present invention;

FIGS. 42A and 42B are longitudinal aberration diagrams of a wide-angle end of the telephoto zoom lens according to Example 6 of the present invention, FIG. 42A at the time of focusing on infinity and FIG. 42B at the time of a photographing magnification of 1:40;

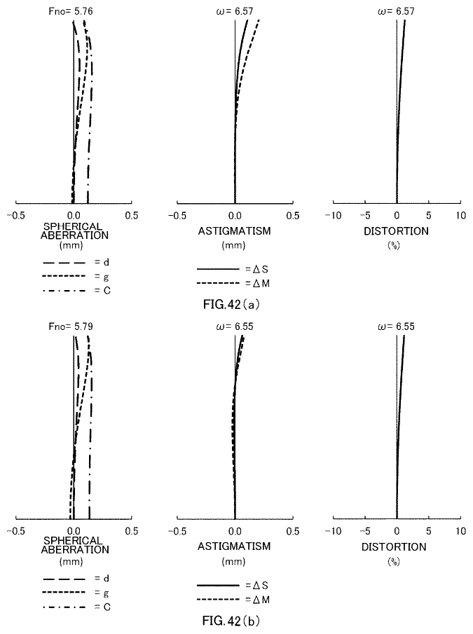

FIGS. 43A and 43B are longitudinal aberration diagrams of a zoom center position of the telephoto zoom lens according to Example 6 of the present invention, FIG. 43A at the time of focusing on infinity and FIG. 43B at the time of the photographing magnification of 1:40;

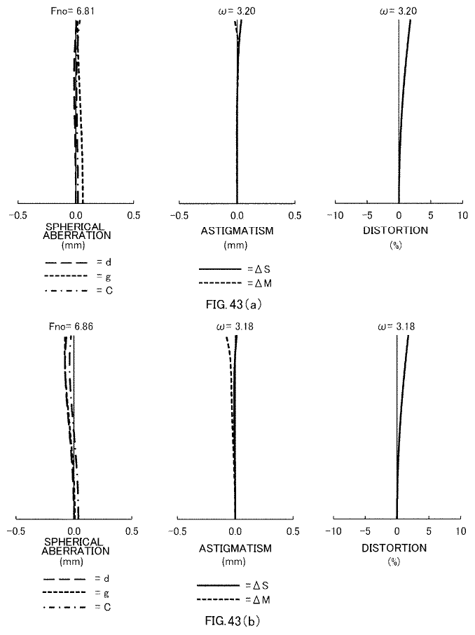

FIGS. 44A and 44B are longitudinal aberration diagrams of a telephoto end of the telephoto zoom lens according to Example 6 of the present invention, FIG. 44A at the time of focusing on infinity and FIG. 44B at the time of the photographing magnification of 1:40;

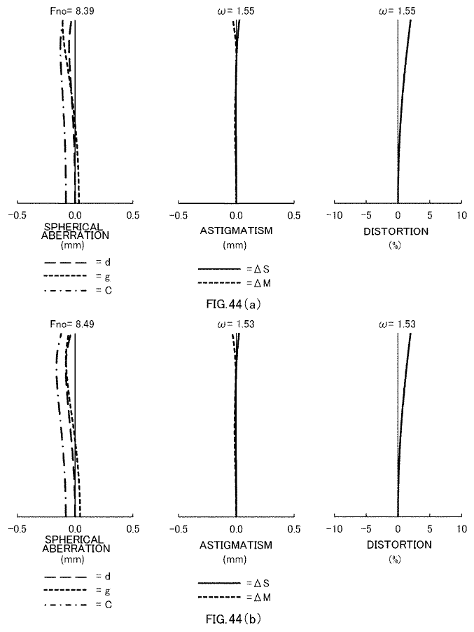

FIGS. 45A and 45B are lateral aberration diagrams of the wide-angle end of the telephoto zoom lens according to Example 6 of the present invention, FIG. 45A at the time of focusing on infinity and FIG. 45B at the time of the photographing magnification of 1:40;

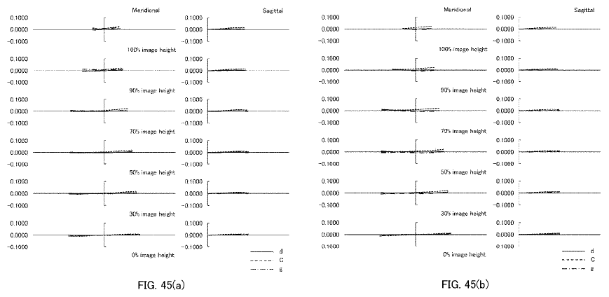

FIGS. 46A and 46B are lateral aberration diagrams of the zoom center position of the telephoto zoom lens according to Example 6 of the present invention, FIG. 46A at the time of focusing on infinity and FIG. 46B at the time of the photographing magnification of 1:40;

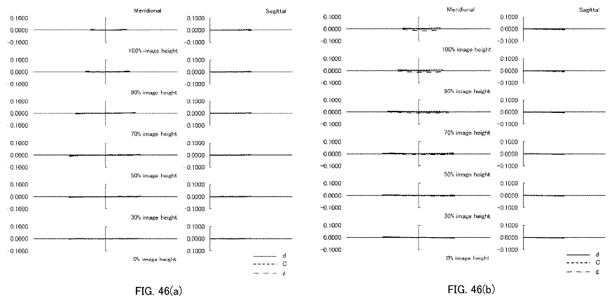

FIGS. 47A and 47B are lateral aeration diagrams of the telephoto end of the telephoto zoom lens according to Example 6 of the present invention, FIG. 47A at the time of focusing on infinity and FIG. 47B at the time of the photographing magnification of 1:40;

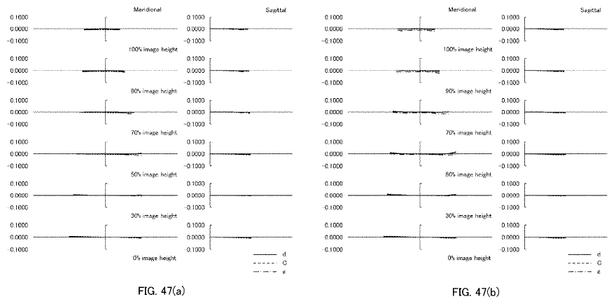

FIGS. 48A and 48B are lateral aberration diagrams during 0.3° vibration reduction FIG. 48A at the wide-angle end and FIG. 48B at the telephoto end of the telephoto zoom lens according to Example 6 of the present invention at the time of focusing on infinity;

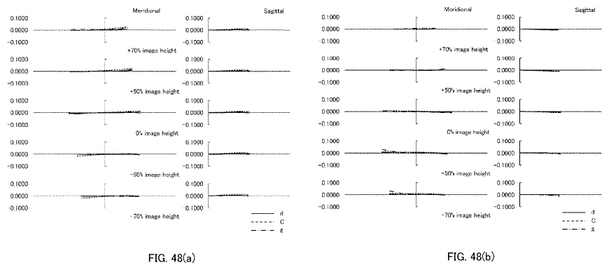

FIG. 49 is a configuration diagram according to Example 7 of a telephoto zoom lens according to the present invention;

FIGS. 50A and 50B are longitudinal aberration diagrams of a wide-angle end of the telephoto zoom lens according to Example 7 of the present invention, FIG. 50A at the time of focusing on infinity and FIG. 50B at the time of a photographing magnification of 1:40;

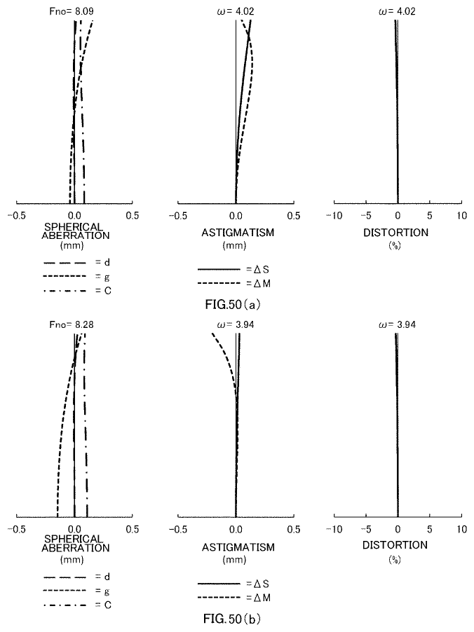

FIGS. 51A and 51B are longitudinal aberration diagrams of a zoom center position of the telephoto zoom lens according to Example 7 of the present invention, FIG. 51A at the time of focusing on infinity and FIG. 51B at the time of the photographing magnification of 1:40;

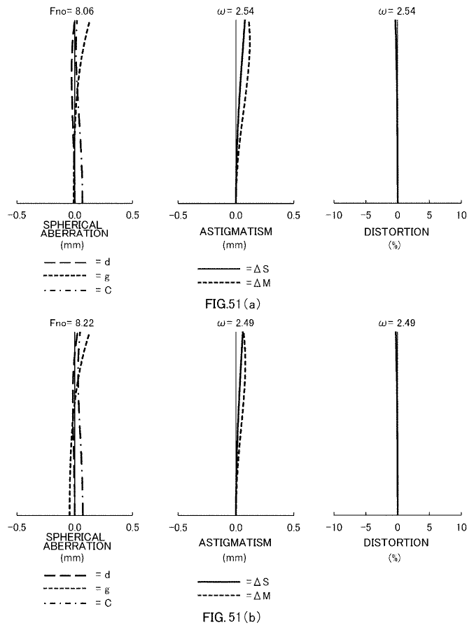

FIGS. 52A and 52B are longitudinal aberration diagrams of a telephoto end of the telephoto zoom lens according to Example 7 of the present invention, FIG. 52A at the time of focusing on infinity and FIG. 52B at the time of the photographing magnification of 1:40;

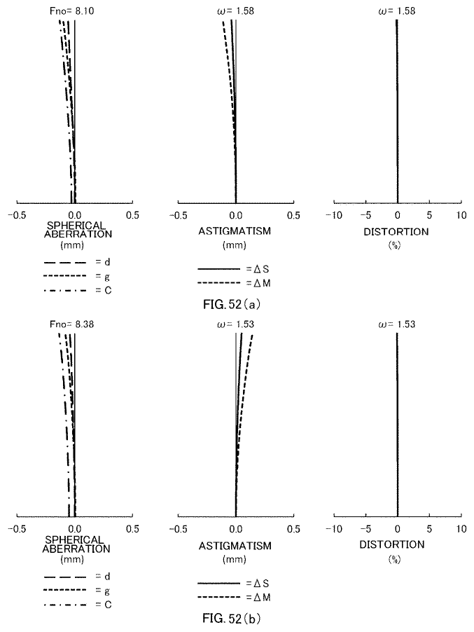

FIGS. 53A and 53B are lateral aberration diagrams of the wide-angle end of the telephoto zoom lens according to Example 7 of the present invention, FIG. 53A at the time of focusing on infinity and FIG. 53B at the time of the photographing magnification of 1:40;

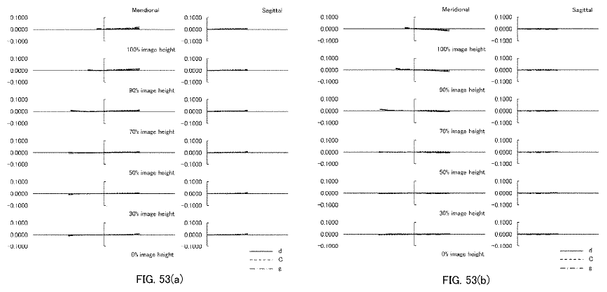

FIGS. 54A and 54B are lateral aberration diagrams of the zoom center position of the telephoto zoom lens according to Example 7 of the present invention, FIG. 54A at the time of focusing on infinity and FIG. 54B at the time of the photographing magnification of 1:40;

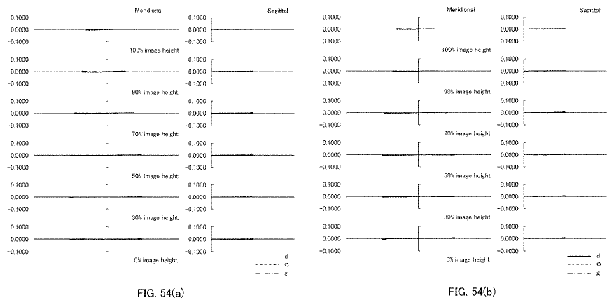

FIGS. 55A and 55B are lateral aberration diagrams of the telephoto end of the telephoto zoom lens according to Example 7 of the present invention, FIG. 55A at the time of focusing on infinity and FIG. 55B at the time of the photographing magnification of 1:40;

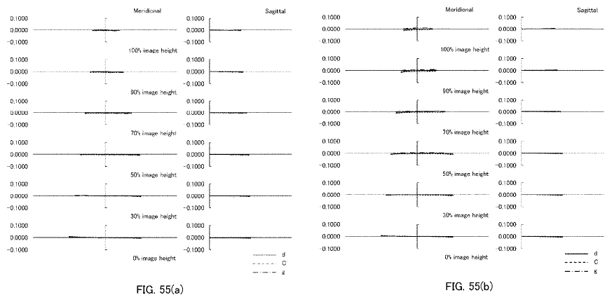

FIGS. 56A and 56B are lateral aberration diagrams during 0.3° vibration reduction FIG. 56A at the wide-angle end and FIG. 56B at the telephoto end of the telephoto zoom lens according to Example 7 of the present invention at the time of focusing on infinity;

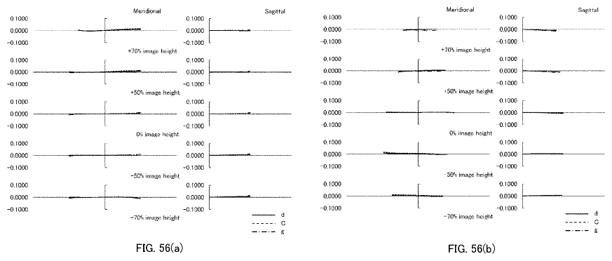

FIG. 57 is a configuration diagram according to Example 8 of a telephoto zoom lens of the present invention;

FIGS. 58A and 58B are longitudinal aberration diagrams of a wide-angle end of the telephoto zoom lens according to Example 8 of the present invention, FIG. 58A at the time of focusing on infinity and FIG. 58B at the time of a photographing magnification of 1:40;

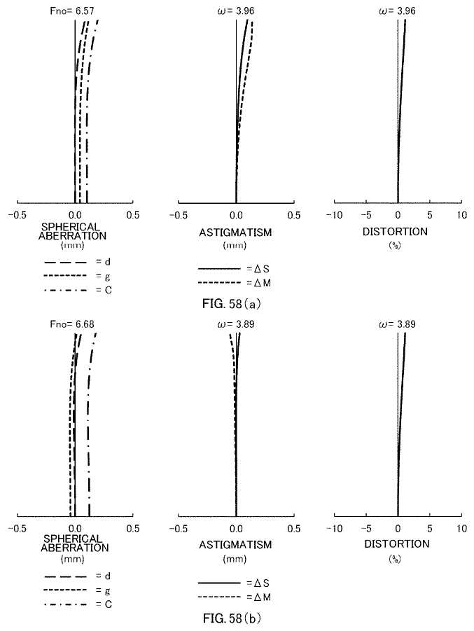

FIGS. 59A and 59B are longitudinal aberration diagrams of a zoom center position of the telephoto zoom lens according to Example 8 of the present invention, FIG. 59A at the time of focusing on infinity and FIG. 59B at the time of the photographing magnification of 1:40;

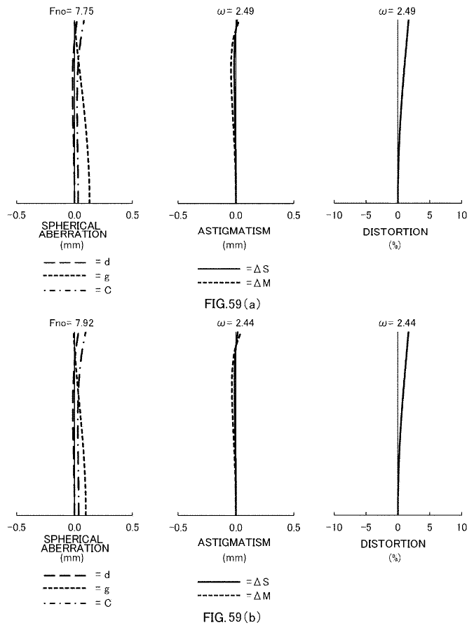

FIGS. 60A and 60B are longitudinal aberration diagrams of a telephoto end of the telephoto zoom lens according to Example 8 of the present invention, FIG. 60A at the time of focusing on infinity and FIG. 60B at the time of the photographing magnification of 1:40;

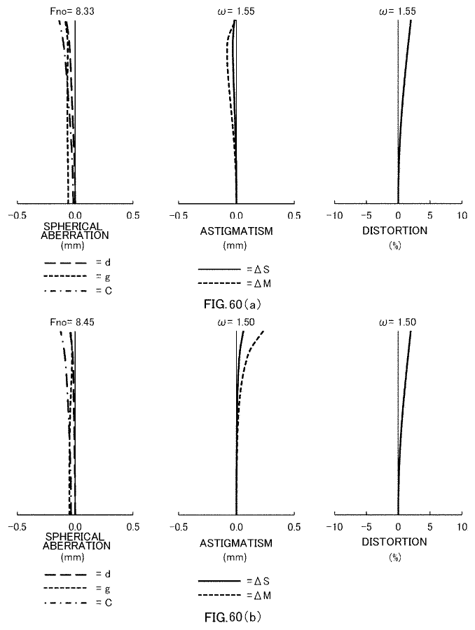

FIGS. 61A and 61B are lateral aberration diagrams of the wide-angle end of the telephoto zoom lens according to Example 8 of the present invention, FIG. 61A at the time of focusing on infinity and FIG. 61B at the time of the photographing magnification of 1:40;

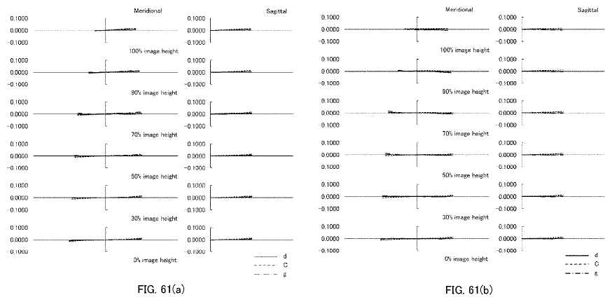

FIGS. 62A and 62B are lateral aberration diagrams of the zoom center position of the telephoto zoom lens according to Example 8 of the present invention, FIG. 62A at the time of focusing on infinity and FIG. 62B at the time of the photographing magnification of 1:40;

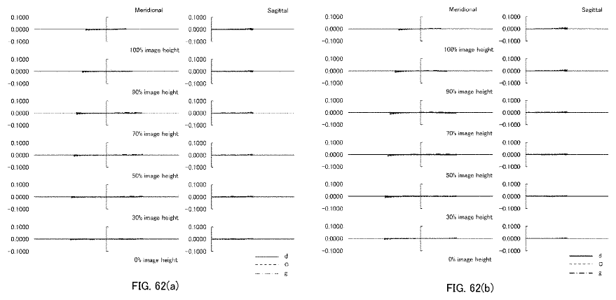

FIGS. 63A and 63B are lateral aberration diagrams of the telephoto end of the telephoto zoom lens according to Example 8 of the present invention, FIG. 63A at the time of focusing on infinity and FIG. 63B at the time of the photographing magnification of 1:40;

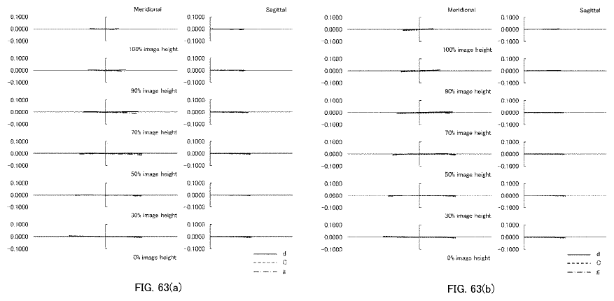

FIGS. 64A and 64B are lateral aberration diagrams during 0.3° vibration reduction FIG. 64A at the wide-angle end and FIG. 64B at the telephoto end of the telephoto zoom lens according to Example 8 of the present invention at the time of focusing on infinity;

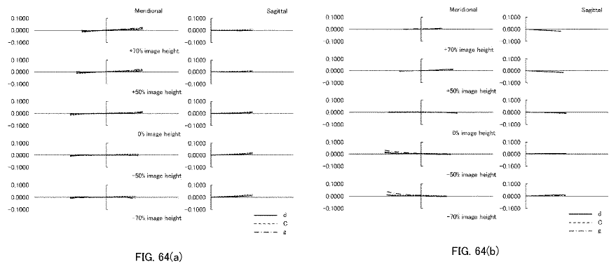

FIG. 65 is a configuration diagram according to Example 9 of a telephoto zoom lens of the present invention;

FIGS. 66A and 66B are longitudinal aberration diagrams of a wide-angle end of the telephoto zoom lens according to Example 9 of the present invention, FIG. 66A at the time of focusing on infinity and FIG. 66B at the time of a photographing magnification of 1:40;

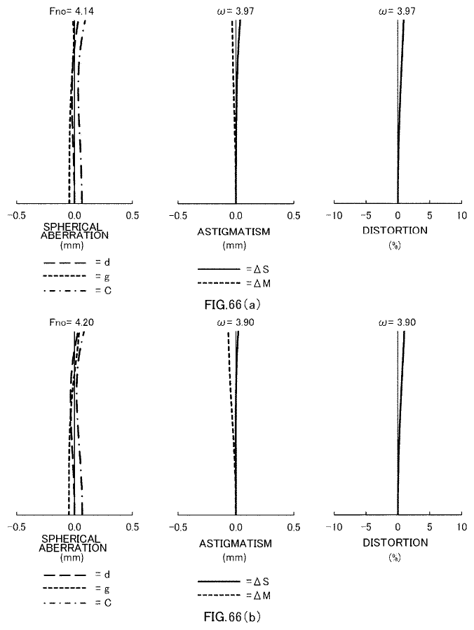

FIGS. 67A and 67B are longitudinal aberration diagrams of a zoom center position of the telephoto zoom lens according to Example 9 of the present invention, FIG. 67A at the time of focusing on infinity and FIG. 67B at the time of the photographing magnification of 1:40;

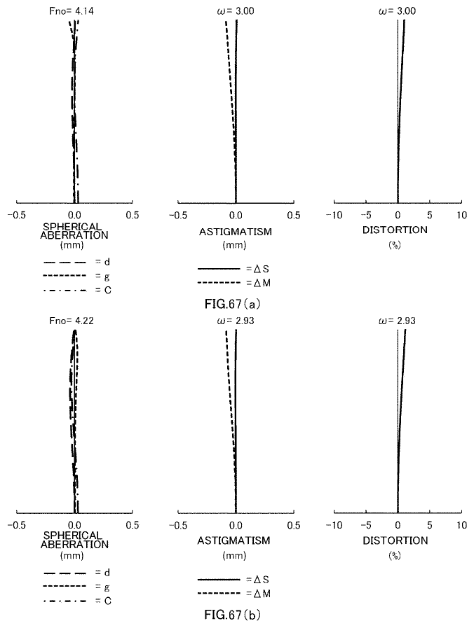

FIGS. 68A and 68B are longitudinal aberration diagrams of a telephoto end of the telephoto zoom lens according to Example 9 of the present invention, FIG. 68A at the time of focusing on infinity and FIG. 68B at the time of the photographing magnification of 1:40;

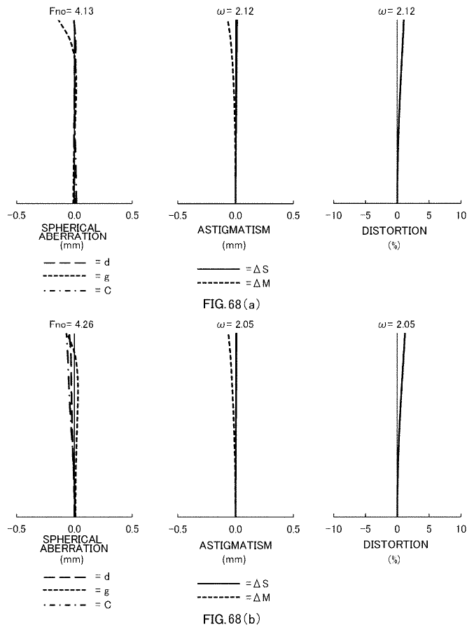

FIGS. 69A and 69B are lateral aberration diagrams of the wide-angle end of the telephoto zoom lens according to Example 9 of the present invention, FIG. 69A at the time of focusing on infinity and FIG. 69B at the time of the photographing magnification of 1:40;

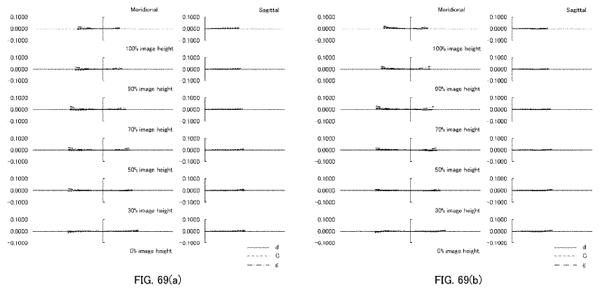

FIGS. 70A and 70B are lateral aberration diagrams of the zoom center position of the telephoto zoom lens according to Example 9 of the present invention, FIG. 70A at the time of focusing on infinity and FIG. 70B at the time of the photographing magnification of 1:40;

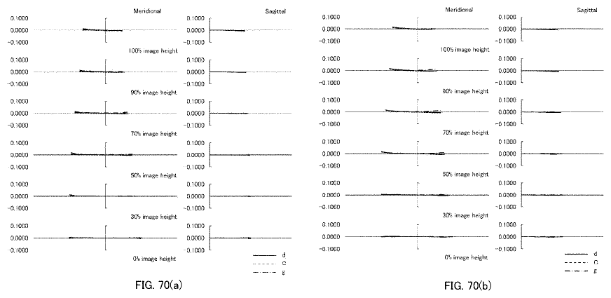

FIGS. 71A and 71B are lateral aberration diagrams of the telephoto end of the telephoto zoom lens according to Example 9 of the present invention, FIG. 71A at the time of focusing on infinity and FIG. 71B at the time of the photographing magnification of 1:40;

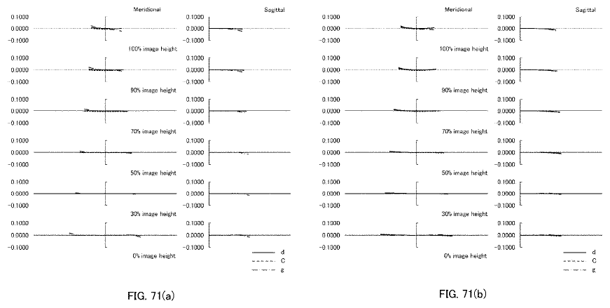

FIGS. 72A and 72B are lateral aberration diagrams during 0.3° vibration reduction FIG. 72A at the time of the wide-angle end and FIG. 72B at the telephoto end of the telephoto zoom lens according to Example 9 of the present invention at the time of focusing on infinity;

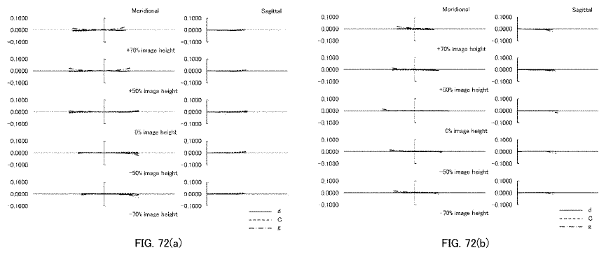

FIG. 73 is a configuration diagram according to Example 10 of a telephoto zoom lens of the present invention;

FIGS. 74A and 74B are longitudinal aberration diagrams of a wide-angle end of the telephoto zoom lens according to Example 10 of the present invention, FIG. 74A at the time of focusing on infinity and FIG. 74B at the time of a photographing magnification of 1:40;

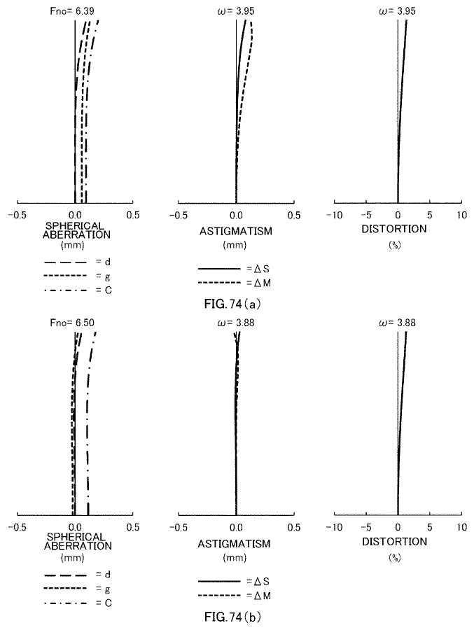

FIGS. 75A and 75B are longitudinal aberration diagrams of a zoom center position of the telephoto zoom lens according to Example 10 of the present invention, FIG. 75A at the time of focusing on infinity and FIG. 75B at the time of the photographing magnification of 1:40;

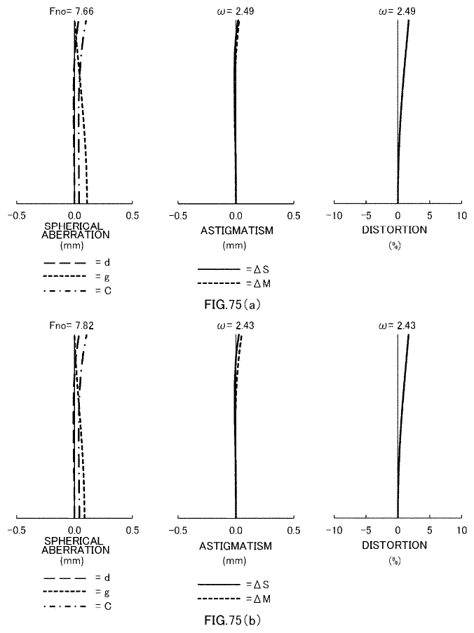

FIGS. 76A and 76B are longitudinal aberration diagrams of a telephoto end of the telephoto zoom lens according to Example 10 of the present invention, FIG. 76A at the time of focusing on infinity and FIG. 76B at the time of the photographing magnification of 1:40;

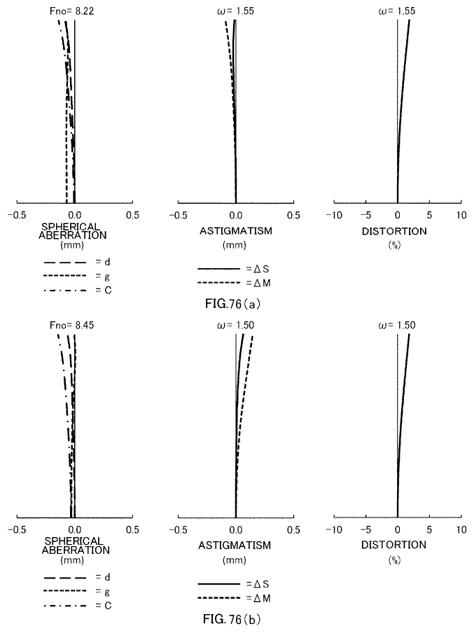

FIGS. 77A and 77B are lateral aberration diagrams of the wide-angle end of the telephoto zoom lens according to Example 10 of the present invention, FIG. 77A at the time of focusing on infinity and FIG. 77B at the time of the photographing magnification of 1:40;

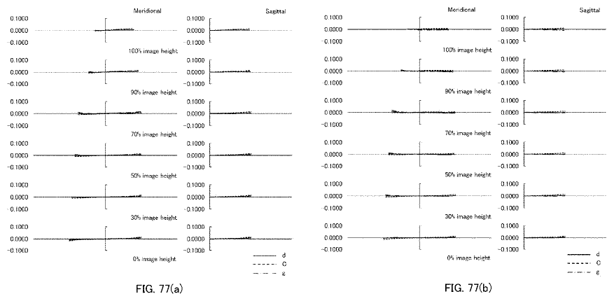

FIGS. 78A and 78B are lateral aberration diagrams of the zoom center position of the telephoto zoom lens according to Example 10 of the present invention, FIG. 78A at the time of focusing on infinity and FIG. 78B at the time of the photographing magnification of 1:40;

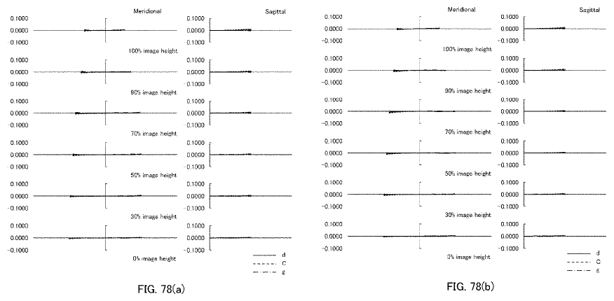

FIGS. 79A and 79B are lateral aberration diagrams of the telephoto end of the telephoto zoom lens according to Example 10 of the present invention, FIG. 79A at the time of focusing on infinity and FIG. 79B at the time of the photographing magnification of 1:40;

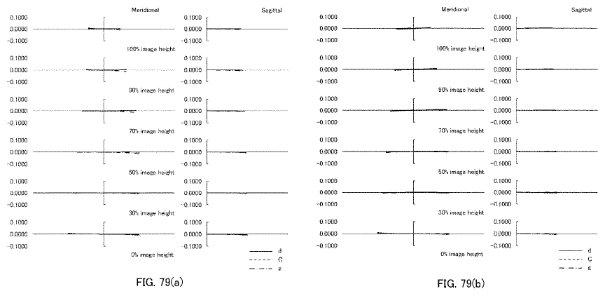

FIGS. 80A and 80B are lateral aberration diagrams during 0.3° vibration reduction FIG. 80A at the wide-angle end and FIG. 80B at the telephoto end of the telephoto zoom lens according to Example 10 of the present invention at the time of focusing on infinity;

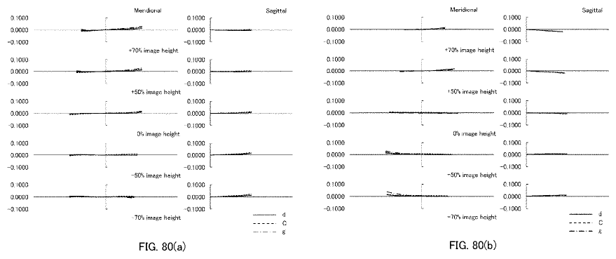

FIG. 81 is a configuration diagram according to Example 11 of a telephoto zoom lens of the present invention;

FIGS. 82A and 82B are longitudinal aberration diagrams of a wide-angle end of the telephoto zoom lens according to Example 11 of the present invention, FIG. 82A at the time of focusing on infinity and FIG. 82B at the time of a photographing magnification of 1:40;

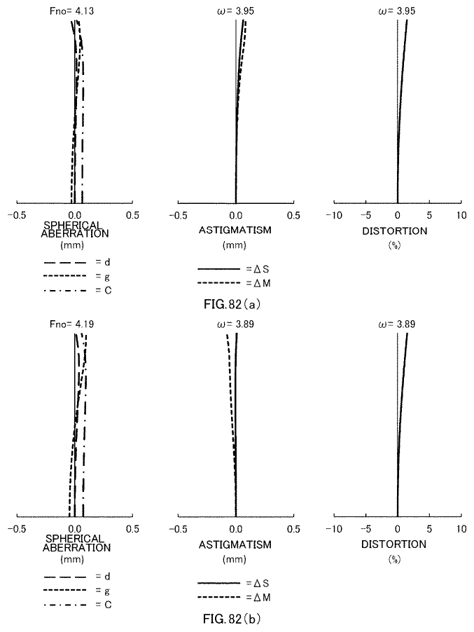

FIGS. 83A and 83B are longitudinal aberration diagrams of a zoom center position of the telephoto zoom lens according to Example 11 of the present invention, FIG. 83A at the time of focusing on infinity and FIG. 83B at the time of the photographing magnification of 1:40;

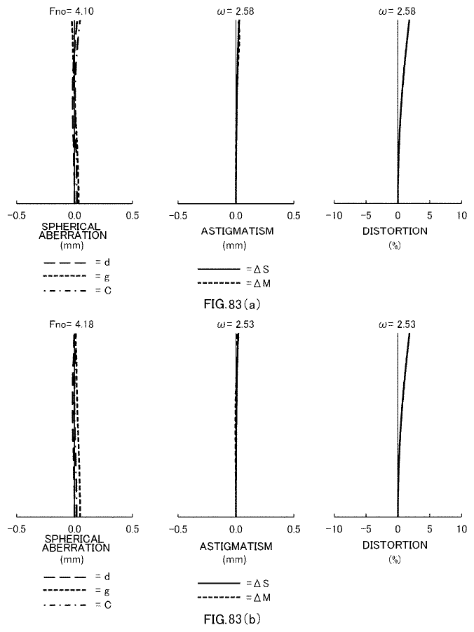

FIGS. 84A and 84B are longitudinal aberration diagrams of a telephoto end of the telephoto zoom lens according to Example 11 of the present invention, FIG. 84A at the time of focusing on infinity and FIG. 84B at the time of the photographing magnification of 1:40;

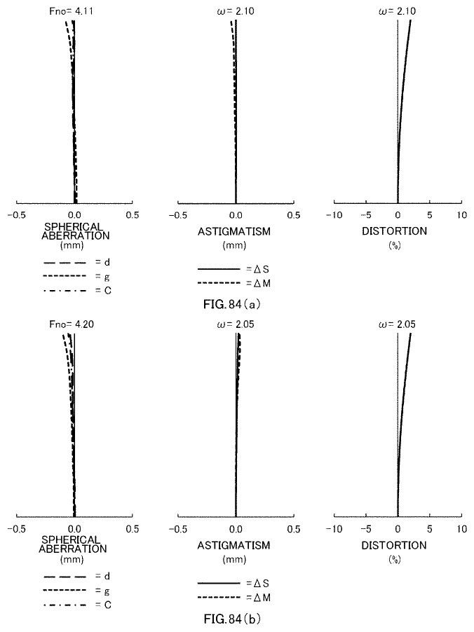

FIGS. 85A and 85B are lateral aberration diagrams of the wide-angle end of the telephoto zoom lens according to Example 11 of the present invention, FIG. 85A at the time of focusing on infinity and FIG. 85B at the time of the photographing magnification of 1:40;

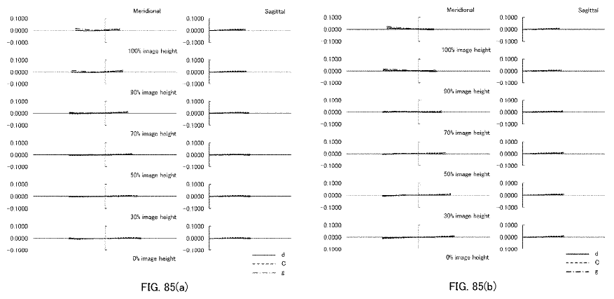

FIGS. 86A and 86B are lateral aberration diagrams of the zoom center position of the telephoto zoom lens according to Example 11 of the present invention, FIG. 86A at the time of focusing on infinity and FIG. 86B at the time of the photographing magnification of 1:40;

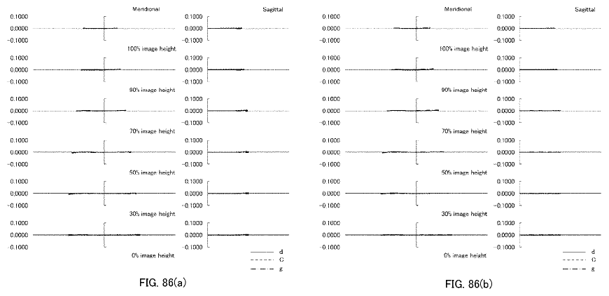

FIGS. 87A and 87B are lateral aberration diagrams of the telephoto end of the telephoto zoom lens according to Example 11 of the present invention, FIG. 87A at the time of focusing on infinity and FIG. 87B at the time of the photographing magnification of 1:40;

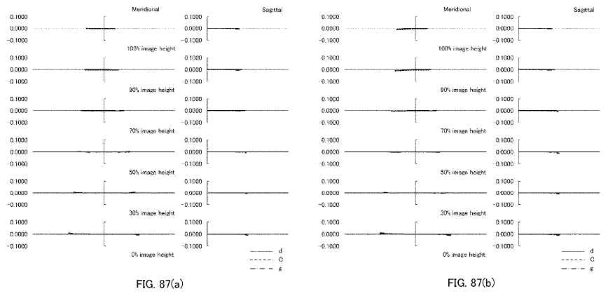

FIGS. 88A and 88B are lateral aberration diagrams during 0.3° vibration reduction FIG. 88A at the time of the wide-angle end and FIG. 88B at the telephoto end of the telephoto zoom lens according to Example 11 of the present invention at the time of focusing on infinity;

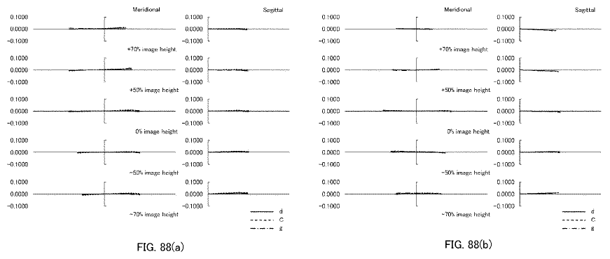

FIG. 89 is a configuration diagram according to Example 12 of a telephoto zoom lens of the present invention;

FIGS. 90A and 90B are longitudinal aberration diagrams of a wide-angle end of the telephoto zoom lens according to Example 12 of the present invention, FIG. 90A at the time of focusing on infinity and FIG. 90B at the time of a photographing magnification of 1:40;

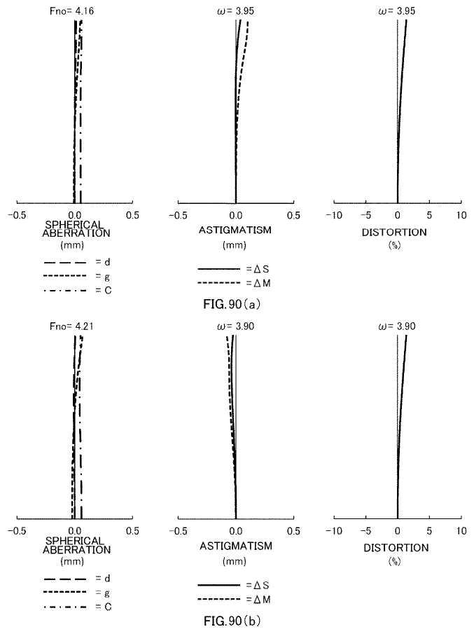

FIGS. 91A and 91B are longitudinal aberration diagrams of a zoom center position of the telephoto zoom lens according to Example 12 of the present invention, FIG. 91A at the time of focusing on infinity and FIG. 91B at the time of the photographing magnification of 1:40;

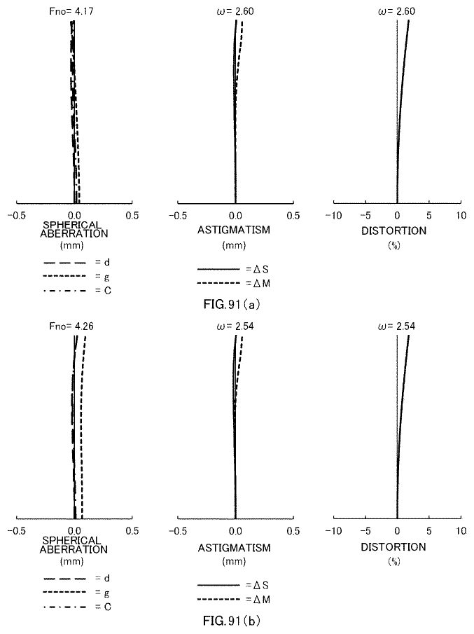

FIGS. 92A and 92B are longitudinal aberration diagrams of a telephoto end of the telephoto zoom lens according to Example 12 of the present invention, FIG. 92A at the time of focusing on infinity and FIG. 92B at the time of the photographing magnification of 1:40;

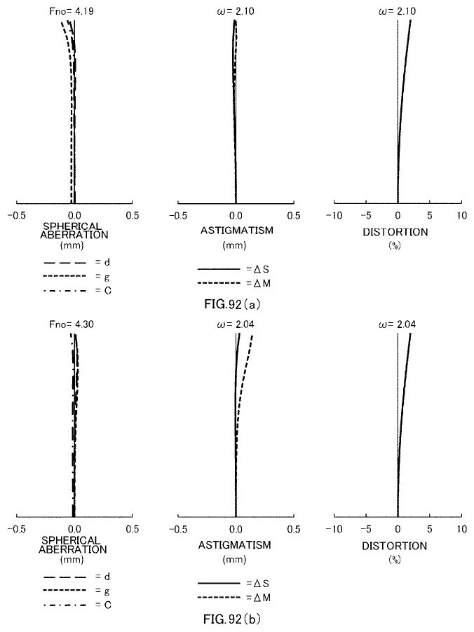

FIGS. 93A and 93B are lateral aberration diagrams of the wide-angle end of the telephoto zoom lens according to Example 12 of the present invention, FIG. 93A at the time of focusing on infinity and FIG. 93B at the time of the photographing magnification of 1:40;

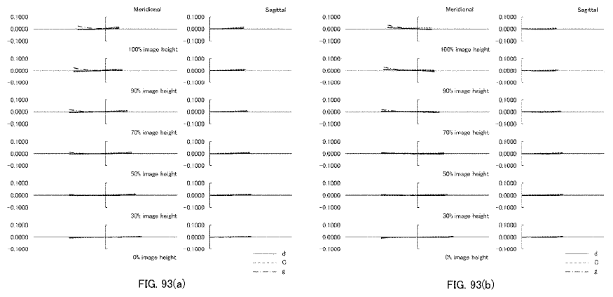

FIGS. 94A and 94B are lateral aberration diagrams of the zoom center position of the telephoto zoom lens according to Example 12 of the present invention, FIG. 94A at the time of focusing on infinity and FIG. 94B at the time of the photographing magnification of 1:40;

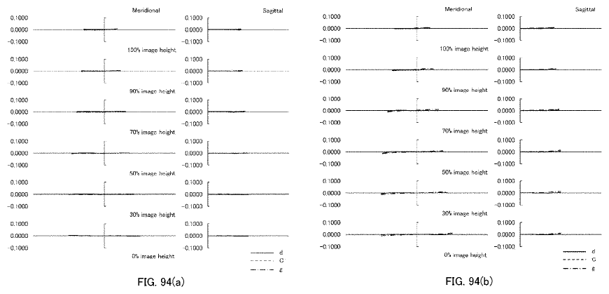

FIGS. 95A and 95B are lateral aberration diagrams of the telephoto end of the telephoto zoom lens according to Example 12 of the present invention, FIG. 95A at the time of focusing on infinity and FIG. 95B at the time of the photographing magnification of 1:40;

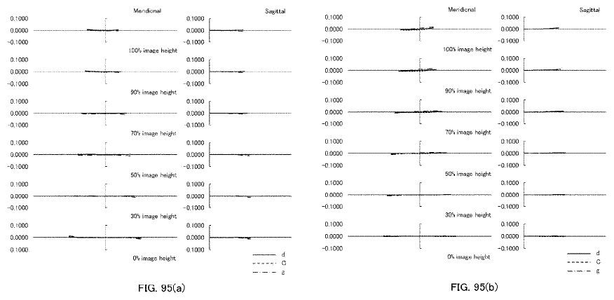

FIGS. 96A and 96B are lateral aberration diagrams during 0.3° vibration reduction FIG. 96A at the wide-angle end and FIG. 96B at the telephoto end of the telephoto zoom lens according to Example 12 of the present invention at the time of focusing on infinity;

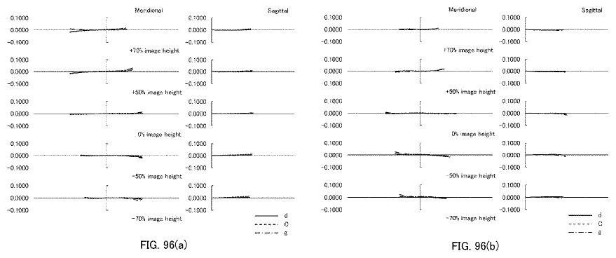

FIG. 97 is a configuration diagram according to Example 13 of a telephoto zoom lens of the present invention;

FIGS. 98A and 98B are longitudinal aberration diagrams of a wide-angle end of the telephoto zoom lens according to Example 13 of the present invention, FIG. 98A at the time of focusing on infinity and FIG. 98B at the time of a photographing magnification of 1:40;

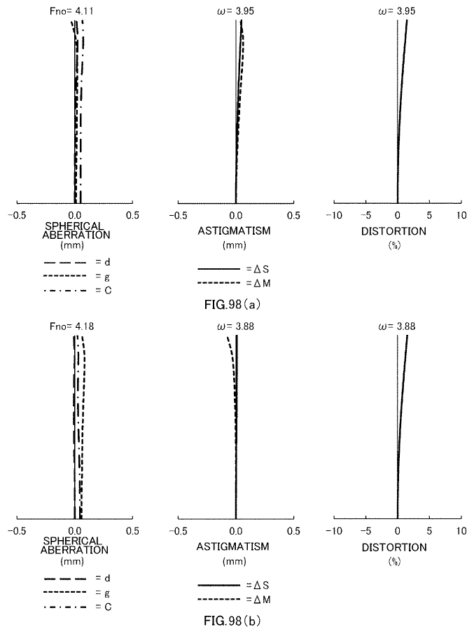

FIGS. 99A and 99B are longitudinal aberration diagrams of a zoom center position of the telephoto zoom lens according to Example 13 of the present invention, FIG. 99A at the time of focusing on infinity and FIG. 99B at the time of the photographing magnification of 1:40;

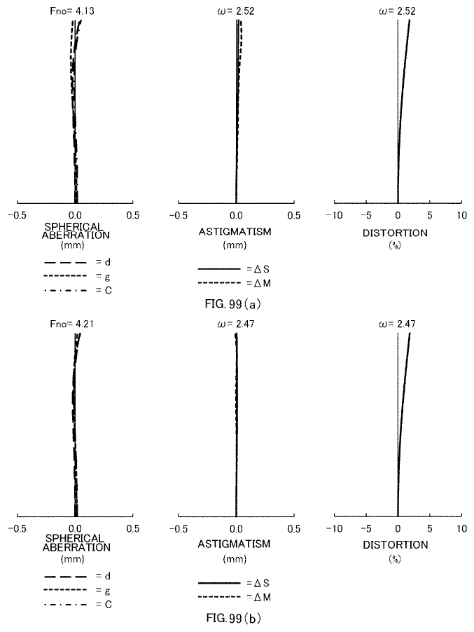

FIGS. 100A and 100B are longitudinal aberration diagrams of a telephoto end of the telephoto zoom lens according to Example 13 of the present invention, FIG. 100A at the time of focusing on infinity and FIG. 100B at the time of the photographing magnification of 1:40;

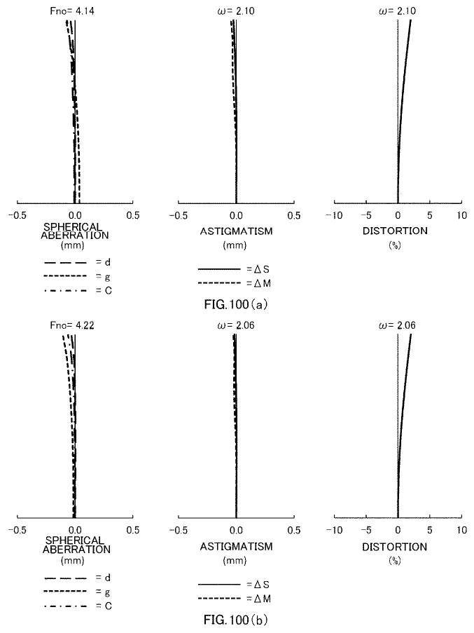

FIGS. 101A and 101B are lateral aberration diagrams of the wide-angle end of the telephoto zoom lens according to Example 13 of the present invention, FIG. 101A at the time of focusing on infinity and FIG. 101B at the time of the photographing magnification of 1:40;

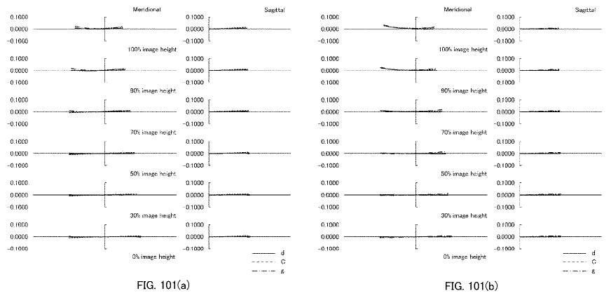

FIGS. 102A and 102B are lateral aberration diagrams of the zoom center position of the telephoto zoom lens according to Example 13 of the present invention, FIG. 102A at the time of focusing on infinity and FIG. 102B at the time of the photographing magnification of 1:40;

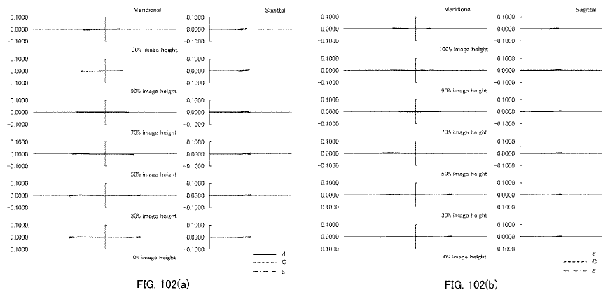

FIGS. 103A and 103B are lateral aberration diagrams of the telephoto end of the telephoto zoom lens according to Example 13 of the present invention, FIG. 103A at the time of focusing on infinity and FIG. 103B at the time of the photographing magnification of 1:40; and

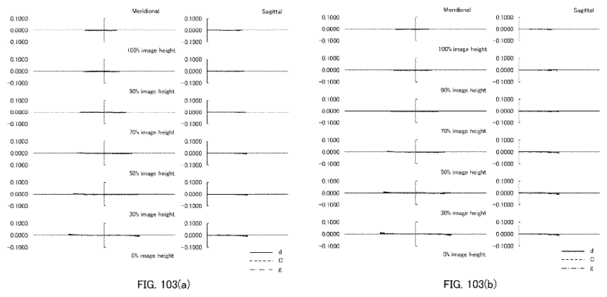

FIGS. 104A and 104B are lateral aberration diagrams during 0.3° vibration reduction FIG. 104A at the wide-angle end and FIG. 104B at the telephoto end of the telephoto zoom lens according to the Example 13 of the present invention at the time of focusing on infinity.

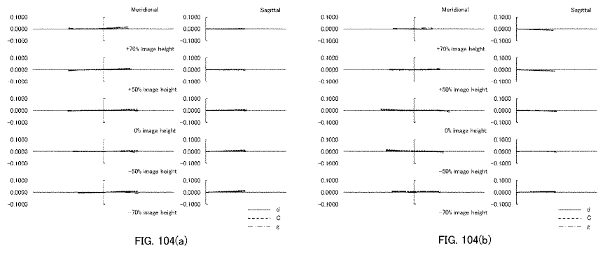

### DESCRIPTION OF EMBODIMENTS

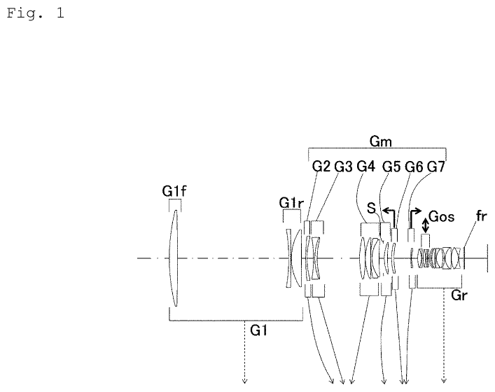

A telephoto zoom lens according to the present invention includes, in order from an object side to an image side, a first lens group G1 with a positive refractive power, a middle lens group Gm, and a final lens group Gr and is characterized in that at the time of zooming from a wide-angle end to a telephoto end, the first lens group G1 is fixed with respect to an image surface, distances between adjacent lens groups change, and focusing from an infinity object distance to an extremely close range is performed by moving a part or a plurality of lens groups in the middle lens group Gm, and the first lens group G1 is composed of a front sub-lens group Gif located on the object side and a rear sub-lens group G1r located on the image side, as can be understood from the lens configuration diagrams illustrated in FIGS. 1, 9, 17, 25, 33, 41, 49, 57, 65, 73, 81, 89, and 97.

In the telephoto zoom lens of the present invention, it is possible to reduce variations in center of gravity at the time of zooming and variations in torque of a zoom ring by fixing the first lens group G1 with the heaviest weight in the entire optical system at the time of zooming. Also, it is possible to omit a cam and the like to move the first lens group G1, thereby to simplify a mechanical structure, and to further reduce the weight. Also, since a beam diameter is relatively small in the middle lens group Gm, it is possible to reduce the weight and to increase a focusing speed by disposing a focusing group in the middle lens group Gm.

In the telephoto zoom lens of the present invention, diameter reduction and weight reduction of the rear sub-lens group G1r and the weight reduction of the entire first lens group G1 are achieved by stipulating the distance between the front sub-lens group Gif located on the object side and the rear sub-lens group G1r located on the image side with the largest distance therebetween in the group by a Conditional Expression (2) while maintaining a telephoto ratio stipulated by Conditional

$$\begin{matrix}Expression ( 1 ) & \\ LT / ft < 0.93 & ( 1 )\end{matrix}$$

$$0.17 < d 1 / LT < 0. 45 \qquad ( 2 )$$

where
LT is the distance from a surface on the side closest to the object in the entire lens system to an image surface on an optical axis,
ft is a focal length of the entire lens system at the telephoto end at the time of focusing on infinity, and
d1 is the distance from a surface of the front sub-lens group Gif on the side closest to the image side to a surface of the rear sub-lens group G1r on the side closest to the object side.

Conditional Expression (1) stipulates the entire length of the optical system for size reduction. If an upper limit of Conditional Expression (1) is exceeded, the entire length of the optical system extends, which inhibits size reduction of the optical system. Note that it is possible to further reliably achieve the aforementioned effect by stipulating the aforementioned upper limit value of Conditional Expression (1) as 0.89.

Conditional Expression (2) stipulates the distance between the front sub-lens group Gif and the rear sub-lens group G1r for weight reduction. Below a lower limit value of Conditional Expression (2), the distance between the front sub-lens group Gif and the rear sub-lens group G1r becomes smaller, and the rear sub-lens group G1r is disposed at a position closer to the front lens group Gif on the object side. Therefore, the beam height at the rear sub-lens group G1r increases, and the lens diameter increases, which leads to an increase in weight of the rear sub-lens group G1r and inhibits weight reduction of the optical system. On the other hand, if an upper limit value of Conditional Expression (2) is exceeded, the distance between the front sub-lens group Gif and the rear sub-lens group G1r is extended, and the beam height at the rear sub-lens group G1r decreases, it is possible to reduce the weight of the rear sub-lens group G1r, while extension of the entire length of the lens inhibits size reduction of the optical system. Note that it is possible to more reliably achieve the aforementioned effect by stipulating the upper limit value of Conditional Expression (2) described above as 0.42 and stipulating the lower limit value as 0.18.

The telephoto zoom lens according to the present invention is further characterized in that a conditional expression below is satisfied:

$$1.01 < f 1 f / f 1 < 3.45 \qquad ( 3 )$$

where
f1f is a focal length of the front sub-lens group G1f, and
f1 is a focal length of the first lens group G1.

Conditional Expression (3) stipulates a refractive power of the front sub-lens group Gif in order to achieve both size and weight reduction and performance enhancement. If an upper limit value of Conditional Expression (3) is exceeded, and the positive refractive power of the front sub-lens group Gif decreases, an angle of an axial beam emitted from the front sub-lens group Gif becomes moderate. Therefore, in order to reduce the beam diameter in the rear sub-lens group G1r, it is necessary to extend a distance d1, which leads to extension of the entire length of the optical system and thus inhibits size reduction. On the other hand, below a lower limit value of Conditional Expression (3), and if the positive refractive power of the front sub-lens group Gif increases, the angle of the axial beam emitted from the front sub-lens group Gif becomes steep, there is thus no need to extend the distance d1, and it is possible to reduce the lens diameter, which is advantageous for size and weight reduction. On the other hand, spherical aberration and comatic aberration occurring in the front sub-lens group Gif at the telephoto end, in particular, deteriorate and it is difficult to satisfactorily correct the deterioration in the entire lens system. Note that it is possible to more reliably achieve the aforementioned effect by stipulating the upper limit value of Conditional Expression (3) described above as 2.92 and the lower limit value as 1.20.

The telephoto zoom lens according to the present invention is further characterized in that the first lens group G1 satisfies a conditional expression below:

$$0.15 < f 1 / ft < 0.57 \qquad ( 4 )$$

Conditional Expression (4) stipulates a refractive power of the first lens group G1 in order to achieve both size reduction and performance enhancement. If an upper limit value of Conditional Expression (4) is exceeded, and the positive refractive power of the first lens group G1 decreases, the entire length of the optical system increases, and size reduction is inhibited. On the other hand, below a lower limit value of Conditional Expression (4), and if the positive refractive power of the first lens group G1 increases, it is advantageous for size reduction. However, spherical aberration and comatic aberration occurring in the first lens group G1 at the telephoto end, in particular, deteriorate, and it is difficult to satisfactorily correct the deterioration in the entire lens system. Note that it is possible to more reliably achieve the aforementioned effects by stipulating the upper limit value of Conditional Expression (4) described above as 0.49 and the lower limit value as 0.18.

The telephoto zoom lens according to the present invention is further characterized in that the first lens group G1 is composed of five or less lens elements. In this manner, it is possible to reduce the weight of the first lens group G1 while securing high optical performance.

The telephoto zoom lens according to the present invention is further characterized in that the front sub-lens group Gif includes at least one positive lens element that satisfies a conditional expression below:

$$SG 1 fp < 4 \text{.00} \qquad ( 5 )$$

$$45. < vd 1 fp \qquad ( 6 )$$

where
SG1fp is a specific weight of the positive lens element, and
vd1fp is an Abbe number of the positive lens element.

Conditional Expression (5) stipulates a specific weight of the positive lens element included in the front sub-lens group Gif for weight reduction. If an upper limit of Conditional Expression (5) is exceeded, and the specific weight of the positive lens element increases, the weight of the front sub-lens group Gif increases, and weight reduction is inhibited. Note that it is possible to more reliably achieve the aforementioned effects by stipulating the upper limit of Conditional Expression (5) described above as 3.80.

Conditional Expression (6) stipulates the Abbe number of the positive lens element included in the front sub-lens group Gif for performance enhancement. Below a lower limit of Conditional Expression (6), chromatic aberration on the axis occurring in the front sub-lens group Gif deteriorates at the telephoto end, in particular, and it is difficult to satisfactorily correct the deterioration in the entire lens system. Note that it is possible to more reliably achieve the aforementioned effects by stipulating the lower limit value of Conditional Expression (6) described above as 47.00.

The telephoto zoom lens according to the present invention is further characterized in that a second lens group G2 with a negative refractive power is disposed on the side closest to the object in the middle lens group Gm and a conditional expression below is satisfied:

$$- 0.78 < f 2 / ft < - 0.13 \qquad ( 7 )$$

where
f2 is a focal length of the second lens group G2.

Conditional Expression (7) stipulates a refractive power of the second lens group G2 to achieve both performance enhancement and size reduction. Below a lower limit value of Conditional Expression (7), and if a negative refractive power of the second lens group G2 decreases, then the amount of movement of the second lens group G2 at the time of zooming increases, the entire length of the lens increases, and size reduction is thus inhibited. On the other hand, if the upper limit of Conditional Expression (7) is exceeded, and the negative refractive power of the second lens group G2 increases, the amount of movement at the time of zooming decreases, which is advantageous for size reduction. However, variations in aberration at the time of zooming, particularly, variations in spherical aberration and field curvature from a middle of a zoom range to the telephoto end deteriorate, and it is difficult to satisfactorily correct the deterioration in the entire lens system. Note that it is possible to more reliably achieve the aforementioned effects by stipulating the upper limit value of Conditional Expression (7) described above as −0.15 and the lower limit value as −0.66.

The telephoto zoom lens according to the present invention is further characterized in that the middle lens group Gm includes a third lens group G3 that is disposed to be adjacent to the second lens group G2 on the image side and has a negative refractive index and a conditional expression below is satisfied:

$$- 0.65 < f 3 / ft < - 0.07 \qquad ( 8 )$$

where
f3 is a focal length of a third lens group G3.

Conditional Expression (8) stipulates a refractive power of the third lens group G3 to achieve both performance enhancement and size reduction. If the upper limit value of Conditional Expression (8) is exceeded, and a positive refractive power of the third lens group G3 decreases, the amount of movement at the time of zooming increases, the entire length of the lens increases, and size reduction is thus inhibited. On the other hand, below the lower limit value of Conditional Expression (8), and if the positive refractive power of the third lens group G3 increases, the amount of movement at the time of zooming decreases, which is advantageous for size reduction. However, variations in aberration at the time of zooming, particularly, variations in spherical aberration and field curvature deteriorate, and it is difficult to satisfactorily correct the deterioration in the entire lens system. Note that it is possible to more reliably achieve the aforementioned effects by stipulating the upper limit value of Conditional Expression (8) described above as −0.08 and the lower limit value as −0.55.

Also, it is possible to suppress variations in field curvature and variations in spherical aberration during zooming by configuring the second lens group G2 and the third lens group G3 to move along different paths at the time of zooming.

The telephoto zoom lens according to the present invention is further characterized in that a conditional expression below is satisfied:

$$0.13 < EXP / LT < 0.75 \qquad ( 9 )$$

where
EXP is a distance from an exit pupil to the image surface in an entire zoom range from a wide-angle end to a telephoto end at the time of focusing on infinity.

Conditional Expression (9) stipulates an exit pupil position for size reduction and performance enhancement. If an upper limit value of Conditional Equation (9) is exceeded, and the exit pupil position becomes farther from the image surface, the beam height in the last lens group increases, which leads to an increase in product diameter. Also, in a case where it is attempted to suppress the product diameter, beam vignetting is caused by mechanical components in the vicinity of the lens and the camera mounted portion, which leads to a decrease in peripheral illumination and deterioration of vignetting. On the other hand, below the lower limit value of Conditional Expression (9), and if the exit pupil position approaches the image surface, it is advantageous for size reduction of the product. However, the surrounding principal ray incident angle with respect to a camera sensor increases, which may cause dimming and coloring in the surroundings of the image. Note that it is possible to more reliably achieve the aforementioned effects by stipulating the upper limit value of Conditional Expression (9) described above as 0.60 and the lower limit value as 0.16.

The telephoto zoom lens according to the present invention is further characterized in that the final lens group Gr includes a vibration reduction lens group Gos that performs vibration reduction by moving a part of the vibration reduction lens group Gos in a substantially vertical direction and a conditional expression below is satisfied:

$$1.54 < \vert β Tosh \times ( 1 - β Tos ) \vert < 3. 30 \qquad ( 10 )$$

where
BTosb is a lateral magnification of the lens group disposed on the side closer to the image than the vibration reduction lens group Gos at the telephoto end at the time of focusing on infinity, and
BTos is a lateral magnification of the vibration reduction lens group Gos at the telephoto end at the time of focusing on infinity.

Conditional Expression (10) stipulates an absolute value of an anti-vibration coefficient of the vibration reduction lens group Gos at the telephoto end at the time of focusing on infinity for performance enhancement and size reduction. If the upper limit value of Conditional Expression (10) is exceeded, and the absolute value of the anti-vibration coefficient increases, the refractive power of the vibration reduction lens group Gos becomes strong, variations in comatic aberration and astigmatism due to eccentricity at the time of anti-vibration thus increase, and this leads not only to a difficulty in correcting the variations but also to an increase in amount of displacement of the image on the image surface per unit shift amount of the vibration reduction lens group Gos and an increase in difficulty in control of the vibration reduction mechanism. Also, since the weight of the vibration reduction lens group Gos increases, the size of an actuator that moves the vibration reduction lens group increases, which leads to an increase in product size. On the other hand, below the lower limit value of Conditional Expression (10), and if the absolute value of the anti-vibration coefficient decreases, the amount of movement of the vibration reduction lens group in the substantially vertical direction increases, the size of the vibration reduction unit thus increases, and the product size increases. Note that it is possible to more reliably achieve the aforementioned effects by stipulating the upper limit value of Conditional Expression (10) described above as 2.79 and the lower limit value as 1.82. The telephoto zoom lens according to the present invention is further characterized in that the second lens group G2 consists of one negative lens element. It is possible to reduce the weight of the lens by configuring the second lens group G2 only by the single lens element.

The telephoto zoom lens according to the present invention is further characterized in that focusing from the infinity object distance to the extremely close range by moving at least one lens group disposed on the side closer to the image than an aperture diaphragm S. Since the beam on the axis is converged on the side closer to the image than the aperture diaphragm S, and the lens diameter reduction and weight reduction are likely to be achieved as compared with the side closer to the object than the aperture diaphragm S, it is possible to achieve size reduction of the focusing unit and an increase in focusing speed by performing focusing in the lens group on the side closer to the image than the aperture diaphragm S.

The telephoto zoom lens according to the present invention is further characterized in that one or two lens groups that move at the time of focusing, each consists of a single lens element. In this manner, it is possible to reduce the weight of the focusing group and to achieve size reduction of the focusing unit and an increase in focusing speed.

The telephoto zoom lens according to the present invention is further characterized in that a diffractive optical element is not included. Although it is expected that chromatic aberration is satisfactorily corrected by using a diffractive optical element, a ghost (halo) around a light source unique to a diffractive optical element occurs, and it is difficult to satisfactorily correct the ghost on the other hand. An advantage that a ghost unique to a case where a diffractive optical element is used does not occur is achieved by not including the diffractive optical element.

Also, it is more effective that the telephoto zoom lens according to the present invention include configurations below.

It is preferable that the final lens group Gr be fixed with respect to the image surface at the time of zooming from a wide-angle end to a telephoto end and focusing from the infinity object distance to an extremely close range. In this manner, it is possible to omit mechanical components such as a cam to move the final lens group Gr, thereby to simplify the mechanical structure, and to reduce the weight.

Also, it is preferable that a conditional expression below is satisfied:

$$0.24 < Ds / LT < 0.52 \qquad ( 11 )$$

where
Ds is a distance from the aperture diaphragm S to the image surface at the wide-angle end.

Conditional Expression (11) stipulates a distance from the aperture diaphragm S to the image surface at the wide-angle end for size reduction. If an upper limit value of Conditional Expression (11) is exceeded, and the aperture diaphragm S becomes farther on the object side, the lens group distance on the side closer to the object than the aperture diaphragm S becomes smaller, a distance necessary for zooming is thus insufficient, and the entire length of the lens extend if it is attempted to compensate for the insufficient distance, which inhibits size reduction of the product. Below a lower limit value of Conditional Expression (11), and if the aperture diaphragm S approaches the image side, the outer diameter of the product, in particular, increases and size reduction of the product is inhibited when a diaphragm unit, a focusing group unit, and a vibration reduction group unit are disposed on the image side of the aperture diaphragm S so as not to interfere with each other in terms of a mechanical structure. Note that it is possible to more reliably achieve the aforementioned effects by stipulating the upper limit value of Conditional Expression (12) described above as 0.44 and the lower limit value as 0.29.

Also, it is preferable that a conditional Expression below is satisfied:

$$5.42 < 2 ω w < 14.46 \qquad ( 12 )$$

where
2ωw is a full angle of view [unit: degree] of the entire lens system at the wide-angle end at the time of focusing on infinity.

Conditional Expression (12) stipulates the full angle of view at the wide-angle end. An angle of view which is sufficient for the wide-angle end of the telephoto zoom lens is obtained by satisfying Conditional Expression (12). Note that it is more preferable that the upper limit value of Conditional Expression (12) be set to 13.81 and the lower limit value be set to 5.68.

Also, it is preferable that a conditional expression below is satisfied:

$$2. 81 < 2 ω t < 4.66 \qquad ( 13 )$$

where
2ωt is a full angle of view [unit: degree] of the entire lens system at the telephoto end at the time of focusing on infinity.

Conditional Expression (13) stipulates the full angle of view at the telephoto end. An angle of view which is sufficient for the telephoto end of the telephoto zoom lens is obtained by satisfying Conditional Expression (13). Note that it is more preferable that the upper limit value of Conditional Expression (13) is set to 4.45 and the lower limit value is set to 2.95.

Next, lens configurations in examples according to the telephoto zoom lens of the present invention will be described. Note that in the following description, the lens configuration will be described in the order from the object side to the image side.

### Example 1

FIG. 1 is a lens configuration diagram of a telephoto zoom lens according to Example 1 of the present invention.

A first lens group G1 is composed of: a front sub-lens group G1f consisting of a biconvex positive lens; and a rear sub-lens group G1r consisting of a meniscus negative lens with a concave surface directed to the object side and a meniscus positive lens with a convex surface directed to the object side, in order from the object side to the image side. The first lens group G1 has a positive refractive power as a whole and is fixed with respect to the image surface at the time of zooming.

A middle lens group Gm is composed of a second lens group G2, a third lens group G3, a fourth lens group G4, an aperture diaphragm S, a fifth lens group G5, a sixth lens group G6, and a seventh lens group G7.

The second lens group G2 is composed of a meniscus negative lens with a convex surface directed to the object side.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of: a biconvex positive lens; a meniscus positive lens with a convex surface directed to the object side; and a cemented lens of a meniscus negative lens with a convex surface directed to the object side and a meniscus positive lens with a convex surface directed to the object side, in order from the object side to the image side, and has a positive refractive power as a whole.

The aperture diaphragm S is disposed between the fourth lens group G4 and the fifth lens group G5, and moves integrally with the fifth lens group G5 at the time of zooming.

The fifth lens group G5 is composed of a meniscus positive lens with a convex surface directed to the object side.

The sixth lens group G6 is composed of a meniscus positive lens with a convex surface directed to the object side. The sixth lens group G6 moves toward the object side along an optical axis at the time of focusing from an infinity object distance to an extremely close range.

The seventh lens group G7 is composed of a meniscus negative lens with a convex surface directed to the object side. The seventh lens group G7 moves toward the image side along the optical axis at the time of focusing from the infinity object distance to the extremely close range.

A final lens group Gr is composed of: a cemented lens of a biconvex positive lens and a biconvex negative lens; a vibration reduction group Gos composed of a cemented lens of a biconvex positive lens and a biconcave negative lens, and a biconcave negative lens; a meniscus positive lens with a convex surface directed to the object side; a meniscus positive lens with a convex surface directed to the object side; a cemented lens of a biconcave negative lens and a biconvex positive lens, a cemented lens of a biconcave negative lens and a biconvex positive lens; and a cemented lens of a biconvex positive lens and a biconcave negative lens in order from the object side to the image side. The final lens group Gr has a positive refractive power as a whole, and is fixed with respect to the image surface at the time of zooming.

A filter fr is a rear filter of an insertion type.

### Example 2

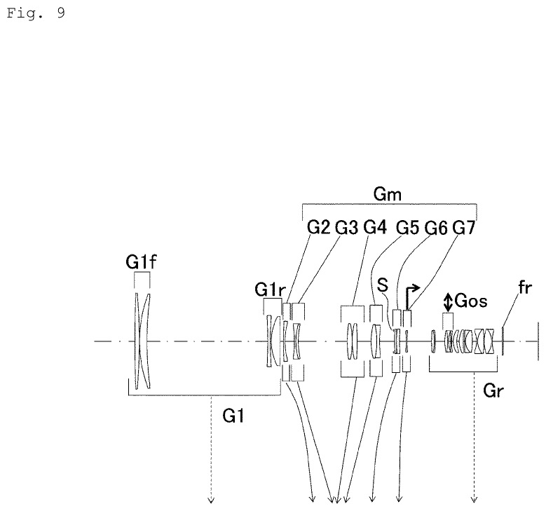

FIG. 9 is a lens configuration diagram of a telephoto zoom lens according to Example 2 of the present invention.

A first lens group G1 is composed of: a front sub-lens group G1f consisting of a biconvex positive lens; and a meniscus positive lens with a convex surface directed to an object side, in order from the object side to an image side; and a rear sub-lens group G1r consisting of a biconcave negative lens and a biconvex positive lens in order from the object side to the image side. The first lens group G1 has a positive refractive power as a whole, and is fixed with respect to an image surface at the time of zooming.

A middle lens group Gm is composed of a second lens group G2, a third lens group G3, a fourth lens group G4, a fifth lens group G5, an aperture diaphragm S, a sixth lens group G6, and a seventh lens group G7.

The second lens group G2 is composed of a meniscus negative lens with a convex surface directed to the object side.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of a biconvex positive lens and a biconvex positive lens in order from the object side to the image side, and has a positive refractive power as a whole.

The fifth lens group G5 is composed of a cemented lens of a biconvex positive lens and a biconcave negative lens in order from the object side to the image side, and has a negative refractive power as a whole.

The aperture diaphragm S is disposed between the fifth lens group G5 and the sixth lens group G6, and moves integrally with the sixth lens group G6 at the time of zooming.

The sixth lens group G6 is composed of a meniscus positive lens with a convex surface directed to the object side and a meniscus positive lens with a convex surface directed to the object side in order from the object side to the image side, and has a positive refractive power as a whole.

The seventh lens group G7 is composed of a biconcave negative lens. The seventh lens group G7 moves toward the image side along an optical axis at the time of focusing from an infinity object distance to an extremely close range.

A final lens group Gr is composed of: a cemented lens of a biconvex positive lens and a meniscus negative lens with a concave surface directed to the object side; a vibration reduction group Gos composed of a cemented lens of a biconvex positive lens and a biconcave negative lens and a biconcave negative lens; a meniscus positive lens with a convex surface directed to the object side; a meniscus positive lens with a convex surface directed to the object side, a cemented lens of a plano-concave negative lens and a biconvex positive lens; a cemented lens of a biconcave negative lens and a biconvex positive lens; and a cemented lens of a biconvex positive lens and a biconcave negative lens, in order from the object side to the image side. The final lens group Gr has a positive refractive power as a whole, and is fixed to the image surface at the time of zooming.

A filter fr is a rear filter of an insertion type.

### Example 3

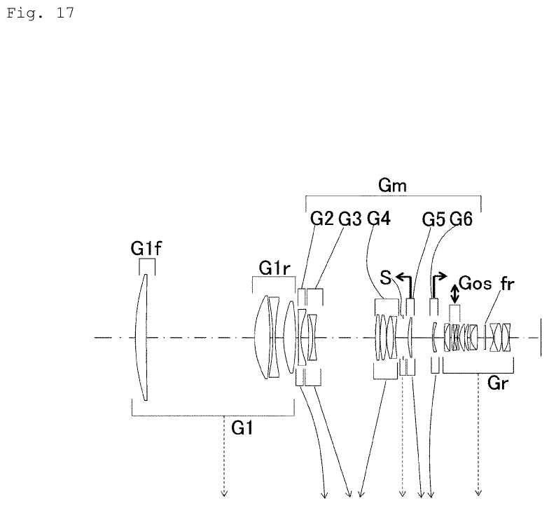

FIG. 17 is a lens configuration diagram of a telephoto zoom lens according to Example 3 of the present invention.

A first lens group G1 is composed of: a front sub-lens group Gif consisting of a meniscus positive lens with a convex surface directed to an object side; and a rear sub-lens group G1r consisting of a biconvex positive lens, a biconcave negative lens, and a biconvex positive lens in order from the object side to an image side. The first lens group G1 has a positive refractive power as a whole, and is fixed to an image surface at the time of zooming.

A middle lens group Gm is composed of a second lens group G2, a third lens group G3, a fourth lens group G4, an aperture diaphragm S, a fifth lens group G5, and a sixth lens group G6.

The second lens group G2 is composed of a biconcave negative lens.

The third lens group G3 is composed of a cemented lens of a meniscus positive lens with a concave surface directed to the object side and a biconcave negative lens in order from the object side to the image side, and has a negative refractive power as a whole.

The fourth lens group G4 is composed of a biconvex positive lens, a biconvex lens, and a cemented lens of a biconvex positive lens and a biconcave lens in order from the object side to the image side, and has a positive refractive power as a whole.

The aperture diaphragm S is disposed between the fourth lens group G4 and the fifth lens group G5, and is fixed with respect to the image surface at the time of zooming.

The fifth lens group G5 is composed of a meniscus positive lens with a convex surface directed to the object side. The fifth lens group G5 moves toward the object side along an optical axis at the time of focusing from an infinity object distance to an extremely close range.

The sixth lens group G6 is composed of a meniscus negative lens with a convex surface directed to the object side. The sixth lens group G6 moves toward the image side along the optical axis at the time of focusing from the infinity object distance to the extremely close range.

A final lens group Gr is composed of: a cemented lens of a meniscus negative lens with a convex surface directed to the object side and a biconvex positive lens; a vibration reduction group Gos composed of a cemented lens of a biconvex positive lens and a biconcave negative lens, and a biconcave negative lens; a meniscus positive lens with a convex surface directed to the object side, a meniscus positive lens with a convex surface directed to the object side; a cemented lens of a biconcave negative lens and a biconvex positive lens; a filter fr; a cemented lens of a biconcave negative lens and a biconvex positive lens; and a cemented lens of a biconvex positive lens and a biconcave negative lens in order from the object side to the image side. The final lens group Gr has a positive refractive power as a whole, and is fixed with respect to the image surface at the time of zooming.

### Example 4

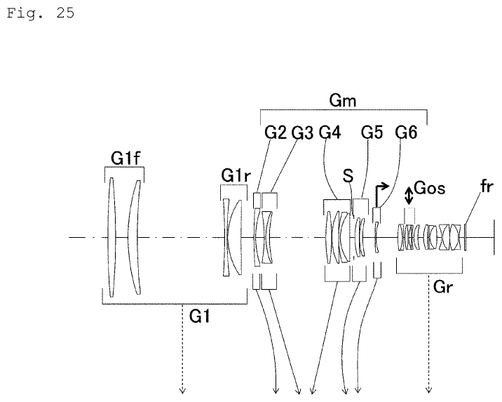

FIG. 25 is a lens configuration diagram, of a telephoto zoom lens according to Example 4 of the present invention.

A first lens group G1 is composed of: a front sub-lens group Gif consisting of a biconvex positive lens and a meniscus positive lens with a convex surface directed to an object side, in order from the object side to the image side; and a rear sub-lens group G1r consisting of a biconcave negative lens and a meniscus positive lens with a convex surface directed to the object side, in order from the object side to the image side. The first lens group G1 has a positive refractive power as a whole, and is fixed with respect to an image surface at the time of zooming.

A middle lens group Gm is composed of a second lens group G2, a third lens group G3, a fourth lens group G4, a fifth lens group G5, an aperture diaphragm S, and a sixth lens group G6.

The second lens group G2 is composed of a meniscus negative lens with a concave surface directed to the object side.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of a biconvex positive lens, a meniscus positive lens with a convex surface directed to the object side, and a cemented lens of a meniscus negative lens with a convex surface directed to the object side and a meniscus positive lens with a convex surface directed to the object side, and has a positive refractive power as a whole.

The aperture diaphragm S is disposed between the fourth lends group G4 and the fifth lens group G5, and moves integrally with the fifth lens group G5 at the time of zooming.

The fifth lens group G5 is composed of a meniscus positive lens with a convex surface directed to the object side and a meniscus positive lens with a convex surface directed to the object side in order from the object side to the image side, and has a positive refractive power as a whole.

The sixth lens group G6 is composed of a meniscus negative lens with a convex surface directed to the object side. The sixth lens group G6 moves toward the image side along the optical axis at the time of focusing from the infinity object distance to the extremely close range.

A final lens group Gr is composed of: a cemented lens of a biconvex positive lens and a biconcave negative lens; a vibration reduction group Gos composed of a cemented lens of a biconvex positive lens and a biconcave negative lens, and a biconcave negative lens; a meniscus positive lens with a convex surface directed to the object side; a meniscus positive lens with a convex surface directed to the object side; a cemented lens of a plano-concave negative lens and a biconvex positive lens; a cemented lens of a biconcave negative lens and a biconvex positive lens; and a cemented lens of a biconvex positive lens and a biconcave negative lens in order from the object side to the image side. The final lens group Gr has a positive refractive power as a whole, and is fixed with respect to the image surface at the time of zooming.

A filter fr is a rear filter of an insertion type.

### Example 5

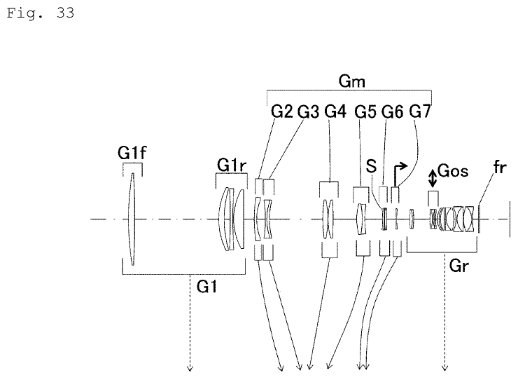

FIG. 33 is a lens configuration diagram of a telephoto zoom lens according to Example 5 of the present invention.

A first lens group G1 is composed of: a front sub-lens group G1f consisting of a biconvex positive lens; and a rear sub-lens group G1r consisting of a meniscus positive lens with a convex surface directed to an object side, a biconcave negative lens, and a biconvex positive lens in order from the object side to an image side. The first lens group G1 has a positive refractive power as a whole, and is fixed with respect to an image surface at the time of zooming.

A middle lens group Gm is composed of a second lens group G2, a third lens group G3, a fourth lens group G4, a fifth lens group G5, an aperture diaphragm S, a sixth lens group G6, and a seventh lens group G7.

The second lens group G2 is composed of a meniscus negative lens with a concave surface directed to the object side.

The third lens group G3 is composed of a cemented lens of a biconcave negative lens and a meniscus positive lens with a convex surface directed to the object side in order form the object side to the image side, and has a negative refractive power as a whole.

The fourth lens group G4 is composed of a biconvex lens and a biconvex lens in order from the object side to the image side, and has a positive refractive power as a whole.

The fifth lens group G5 is composed of a cemented lens of a biconvex lens and a biconcave lens in order from the object side to the image side, and has a negative refractive power as a whole.

The aperture diaphragm S is disposed between the fifth lens group G5 and the sixth lens group G6, and moves integrally with the sixth lens group G6 at the time of zooming.

The sixth lens group G6 is composed of a meniscus positive lens with a convex surface directed to the object side and a meniscus positive lens with a convex surface directed to the object side in order from the object side to the image side, and has a positive refractive power as a whole.

The seventh lens group G7 is composed of a biconcave negative lens. The seventh lens group G7 moves toward the image side along an optical axis at the time of focusing from an infinity object distance to an extremely close range.

A final lens group Gr is composed of: a cemented lens of a biconvex positive lens and a meniscus negative lens with a concave surface directed to the object side; a vibration reduction group Gos composed of a cemented lens of a biconvex positive lens and a biconcave negative lens and a biconcave negative lens; a meniscus positive lens with a convex surface directed to the object side; a meniscus positive lens with a convex surface directed to the object side; a cemented lens of a plano concave negative lens and a biconvex positive lens; a cemented lens of a biconcave negative lens and a biconvex positive lens; and a cemented lens of a biconvex positive lens and a biconcave negative lens in order from the object side to the image side. The final lens group Gr has a positive refractive power as a whole, and is fixed with respect to an image surface at the time of zooming.

A filter fr is a rear filter of an insertion type.

### Example 6

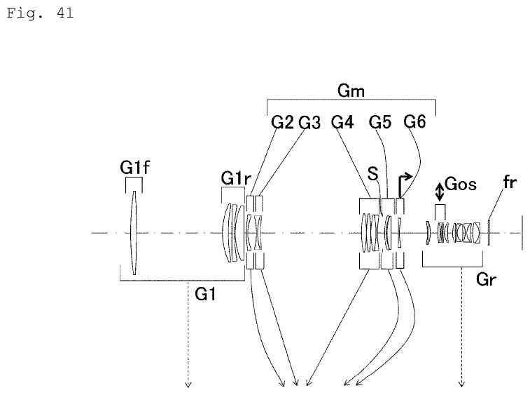

FIG. 41 is a lens configuration diagram of a telephoto zoom lens according to Example 6 of the present invention.

A first lens group G1 is composed of: a front sub-lens group Gif consisting of a biconvex positive lens; and a rear sub-lens group G1r consisting of a meniscus positive lens with a convex surface directed to an object side, a biconcave negative lens, and a biconvex positive lens in order from the object side to an image side. The first lens group G1 has a positive refractive power as a whole, and is fixed with respect to an image surface at the time of zooming.

A middle lens group Gm is composed of a second lens group G2, a third lens group G3, a fourth lens group G4, an aperture diaphragm S, a fifth lens group G5, and a sixth lens group G6.

The second lens group G2 is composed of a meniscus negative lens with a concave surface directed to the object side.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of a biconvex lens, a biconvex lens, and a cemented lens of a biconvex lens and a biconcave lens in order from the object side to the image side, and has a positive refractive power as a whole.

The aperture diaphragm S is disposed between the fourth lends group G4 and the fifth lens group G5, and moves integrally with the fifth lens group G5 at the time of zooming.

The fifth lens group G5 is composed of a meniscus negative lens with a convex surface directed to the object side and a biconvex positive lens in order from the object side to the image side, and has a positive refractive power as a whole.

The sixth lens group G6 is composed of a biconcave negative lens. The sixth lens group G6 moves toward the image side along an optical axis at the time of focusing from an infinity object distance to an extremely close range.

A final lens group Gr is composed of: a cemented lens of a meniscus negative lens with a concave surface directed to the object side and a meniscus positive lens with a concave surface directed to the object side; a vibration reduction group Gos composed of a cemented lens of a biconvex positive lens and a biconcave negative lens and a meniscus negative lens with a convex surface directed to the object side; a meniscus positive lens with a convex surface directed to the object side; a meniscus positive lens with a convex surface directed to the object side; a cemented lens of a plano-concave negative lens and a biconvex positive lens; a cemented lens of a biconcave negative lens and a meniscus positive lens with a convex surface directed to the object side; and a cemented lens of a biconvex lens and a meniscus negative lens with a concave surface directed to the object side in order from the object side to the image side. The final lens group Gr has a negative refractive power as a whole, and is fixed with respect to the image surface at the time of zooming.

A filter fr is a rear filter of an insertion type.

### Example 7

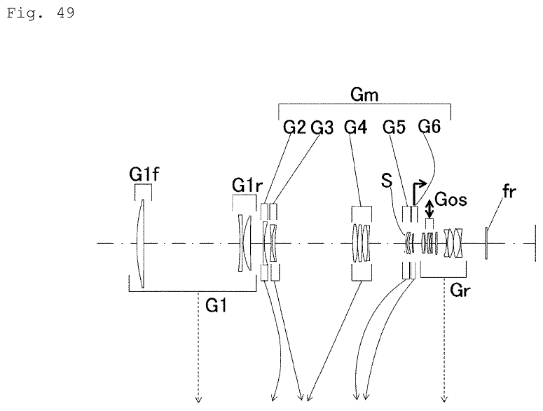

FIG. 49 is a lens configuration diagram of a telephoto zoom lens according to Example 7 of the present invention.

A first lens group G1 is composed of: a front sub-lens group G1f consisting of a biconvex positive lens; and a rear sub-lens group G1r consisting of a meniscus negative lens with a concave surface directed to an object side and a meniscus positive lens with a convex surface directed to the object side in order from the object side to an image side. The first lens group G1 has a positive refractive power as a whole, and is fixed with respect to an image surface at the time of zooming.

A middle lens group Gm is composed of a second lens group G2, a third lens group G3, a fourth lens group G4, an aperture diaphragm S, a fifth lens group G5, and a sixth lens group G6.

The second lens group G2 is composed of a biconcave negative lens.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of a biconvex lens, a biconvex lens, and a cemented lens of a biconvex lens and a biconcave lens in order from the object side to the image side, and has a positive refractive power as a whole.

The aperture diaphragm S is disposed between the fourth lens group G4 and the fifth lens group G5, and moves integrally with the fifth lens group G5 at the time of zooming.

The fifth lens group G5 is composed of a meniscus negative lens with a convex surface directed to the object side and a meniscus positive lens with a convex surface directed to the object side in order from the object side to the image side, and has a negative refractive power as a whole.

The sixth lens group G6 is composed of a meniscus negative lens with a convex surface directed to the object side. The sixth lens group G6 moves toward the image side along an optical axis at the time of focusing from an infinity object distance to an extremely close range.

A final lens group Gr is composed of: a cemented lens of a biconvex positive lens and a meniscus negative lens with a concave surface directed to the object side; a vibration reduction group Gos composed of a cemented lens of a biconvex positive lens and a biconcave negative lens, and a biconcave negative lens; a biconvex positive lens; a biconcave negative lens; a biconvex positive lens; and a cemented lens of a biconvex lens and a biconcave negative lens in order from the object side to the image side. The final lens group Gr has a positive refractive power as a whole, and is fixed with respect to the image surface at the time of zooming.

A filter fr is a rear filter of an insertion type.

### Example 8

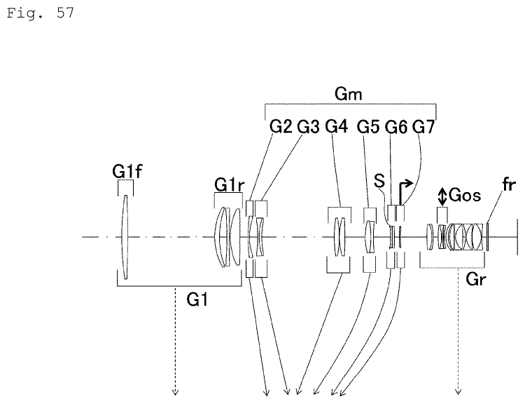

FIG. 57 is a lens configuration diagram of a telephoto zoom lens according to Example 8 of the present invention.

A first lens group G1 is composed of: a front sub-lens group Gif consisting of a biconvex positive lens; and a rear sub-lens group G1r consisting of a meniscus positive lens with a convex surface directed to an object side, a meniscus negative lens with a concave surface directed to the object side, and a biconvex positive lens in order from the object side to an image side. The first lens group G1 has a positive refractive power as a whole, and is fixed with respect to an image surface at the time of zooming.

A middle lens group Gm is composed of a second lens group G2, a third lens group G3, a fourth lens group G4, a fifth lens group G5, an aperture diaphragm S, a sixth lens group G6, and a seventh lens group G7.

The second lens group G2 is composed of a meniscus negative lens with a concave surface directed to the object side.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of a biconvex lens and a biconvex lens in order from the object side to the image side, and has a positive refractive power as a whole.

The fifth lens group G5 is composed of a cemented lens of a biconvex les and a biconcave lens in order from the object side to the image side, and has a negative refractive power as a whole.

The aperture diaphragm S is disposed between the fifth lens group G5 and the sixth lens group G6, and moves integrally with the sixth lens group G6 at the time of zooming.

The sixth lens group G6 is composed of a meniscus negative lens with a concave surface directed to the object side and a biconvex positive lens in order from the object side to the image side, and has a positive refractive power as a whole.

The seventh lens group G7 is composed of a biconcave negative lens. The sixth lens group G6 moves toward the image side along an optical axis at the time of focusing from an infinity object distance to an extremely close range.

A final lens group Gr is composed of: a cemented lens of a biconvex positive lens and a meniscus negative lens with a concave surface directed to the object side; a vibration reduction group Gos composed of a cemented lens of a biconvex positive lens and a biconcave negative lens, and a meniscus negative lens with a concave surface directed to the object side; a meniscus positive lens with a convex surface directed to the object side; a biconvex positive lens; a cemented lens of a plano-concave negative lens and a biconvex positive lens; a cemented lens of a biconcave negative lens and a meniscus positive lens with a convex surface directed to the object side; and a cemented lens of a biconvex lens and a biconcave negative lens in order from the object side to the image side. The final lens group Gr has a negative refractive power as a whole, and is fixed with respect to the image surface at the time of zooming.

A filter fr is a rear filter of an insertion type.

### Example 9

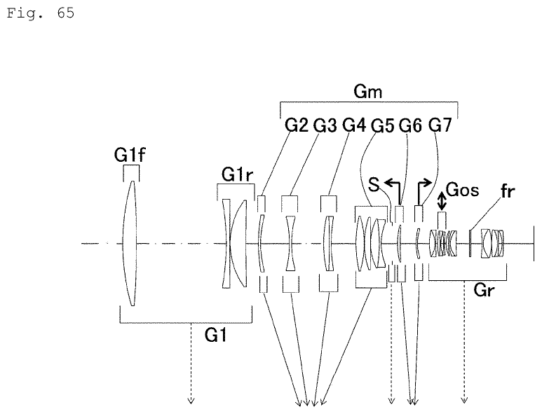

FIG. 65 is a lens configuration diagram of a telephoto zoom lens according to Example 9 of the present invention.

A first lens group G1 is composed of: a front sub-lens group G1f consisting of a biconvex positive lens; and a rear sub-lens group G1r consisting of a meniscus negative lens with a concave surface directed to an object side and a meniscus positive lens with a convex surface directed to the object side. The first lens group G1 has a positive refractive power as a whole, and is fixed with respect to an image surface at the time of zooming.

A middle lens group Gm is composed of a second lens group G2, a third lens group G3, a fourth lens group G4, a fifth lens group G5, an aperture diaphragm S, a sixth lens group G6, and a seventh lens group G7.

The second lens group G2 is composed of a meniscus negative lens with a concave surface directed to the object side.

The third lens group G3 is composed of a biconcave negative lens.

The fourth lens group G4 is composed of a cemented lens of a biconvex lens and a biconcave lens in order from the object side to an image side, and has a positive refractive power as a whole.

The fifth lens group G5 is composed of a biconvex positive lens, a biconvex positive lens, and a cemented lens of a biconvex positive lens and a biconcave negative lens in order from the object side to the image side, and has a positive refractive power as a whole.

The aperture diaphragm S is disposed between the fifth lens group G5 and the sixth lens group G6, and is fixed with respect to the image surface at the time of zooming.

The sixth lens group G6 is composed of a meniscus positive lens with a convex surface directed to the object side. The sixth lens group G6 moves toward the object side along an optical axis at the time of focusing from an infinity object distance to an extremely close range.

The seventh lens group G7 is composed of a meniscus negative lens with a convex surface directed to the object side. The seventh lens group G7 moves toward the image side along the optical axis at the time of focusing from the infinity object distance to the extremely close range.

A final lens group Gr is composed of: a cemented lens of a biconvex positive lens and a biconcave negative lens; a vibration reduction group Gos composed of a cemented lens of a biconvex positive lens and a biconcave negative lens, and a biconcave negative lens; a meniscus positive lens with a convex surface directed to the object side; a cemented lens of a meniscus negative lens with a convex surface directed to the object side and a meniscus positive lens with a convex surface directed to the object side; a filter fr; a cemented lens of a biconcave negative lens and a biconvex positive lens; a cemented lens of a biconvex positive lens and a meniscus negative lens with a concave surface directed to the object side; and a meniscus negative lens with a concave surface directed to the object side in order from the object side to the image side. The final lens group Gr has a positive refractive power as a whole, and is fixed with respect to the image surface at the time of zooming.

### Example 10

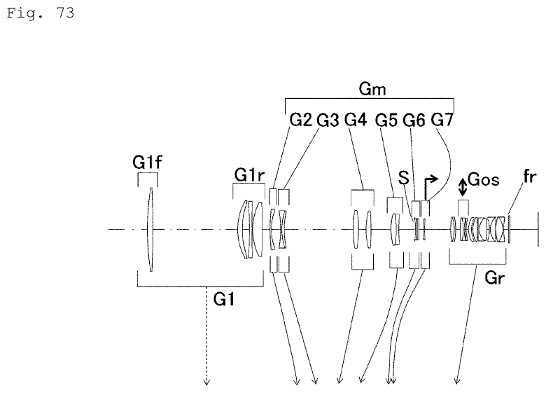

FIG. 73 is a lens configuration diagram of a telephoto zoom lens according to Example 10 of the present invention.

A first lens group G1 is composed of: a front sub-lens group G1f consisting of a biconvex positive lens; and a rear sub-lens group G1r consisting of a meniscus positive lens with a convex surface directed to an object side, a meniscus negative lens with a concave surface directed to the object side, and a biconvex positive lens. The first lens group G1 has a positive refractive power as a whole, and is fixed with respect to an image surface at the time of zooming.

A middle lens group Gm is composed of a second lens group G2, a third lens group G3, a fourth lens group G4, a fifth lens group G5, an aperture diaphragm S, a sixth lens group G6, and a seventh lens group G7.

The second lens group G2 is composed of a meniscus negative lens with a concave surface directed to the object side.

The third lens group G3 is composed of a biconcave negative lens.

The fourth lens group G4 is composed of a biconvex lens and a biconvex lens in order from the object side to the image side, and has a positive refractive power as a whole.

The fifth lens group G5 is composed of a cemented lens of a biconvex lens and a biconcave lens in order from the object side to the image side, and has a negative refractive power as a whole.

The aperture diaphragm S is disposed between the fifth lens group G5 and the sixth lens group G6, and moves integrally with the sixth lens group G6 at the time of zooming.

The sixth lens group G6 is composed of a meniscus negative lens with a concave surface directed to the object side and a biconvex positive lens in order from the object side to the image side, and has a positive refractive power as a whole.

The seventh lens group G7 is composed of a biconcave negative lens. The seventh lens group G7 moves toward the image side along an optical axis at the time of focusing on an infinity object distance to an extremely close range.

A final lens group Gr is composed of: a cemented lens of a biconvex positive lens and a meniscus negative lens with a concave surface directed to the object side; a vibration reduction group Gos composed of a cemented lens of a biconvex positive lens and a biconcave negative lens, and a meniscus negative lens with a concave surface directed to the object side; a meniscus positive lens with a convex surface directed to the object side; a biconvex positive lens, a cemented lens of a plano-concave negative lens and a biconvex positive lens; a cemented lens of a biconcave negative lens and a meniscus positive lens with a convex surface directed to the object side; and a cemented lens of a biconvex positive lens and a biconcave negative lens in order from the object side to the image side. The final lens group Gr has a negative refractive power as a whole.

A filter fr is a rear filter of an insertion type.

### Example 11

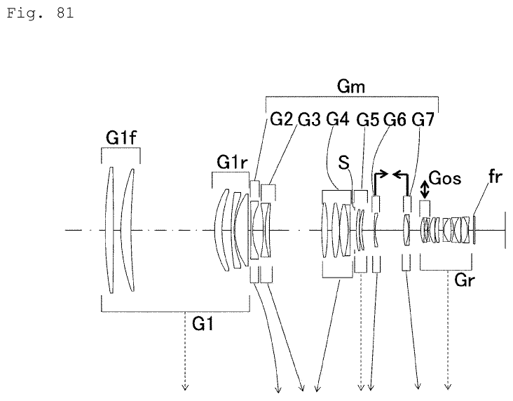

FIG. 81 is a lens configuration diagram of a telephoto zoom lens according to Example 11 of the present invention.

A first lens group G1 is composed of: a front sub-lens group Gif consisting of a biconvex positive lens; and a meniscus positive lens with a convex surface directed to an object side and a rear sub-lens group G1r consisting of a meniscus positive lens with a convex surface directed to the object side, a meniscus negative lens with a convex surface directed to the object side, and a meniscus positive lens with a convex surface directed to the object side in order from the object side to the image side. The first lens group G1 has a positive refractive power as a whole, and is fixed with respect to an image surface at the time of zooming.

A middle lens group Gm is composed of a second lens group G2, a third lens group G3, a fourth lens group G4, an aperture diaphragm S, a fifth lens group G5, a sixth lens group G6, and a seventh lens group G7.

The second lens group G2 is composed of a biconcave negative lens.

The third lens group G3 is composed of a cemented lens of a biconcave negative lens and a meniscus positive lens with a convex surface directed to the object side, and has a negative refractive power as a whole.

The fourth lens group G4 is composed of a biconvex positive lens, a biconvex positive lens, and a cemented lens of a biconvex positive lens and a biconcave negative lens, and has a positive refractive power as a whole.

The aperture diaphragm S is disposed between the fourth lens group G4 and the fifth lens group G5, and is fixed with respect to the image surface at the time of zooming.

The fifth lens group G5 is composed of a meniscus positive lens with a convex surface directed to the object side and a meniscus positive lens with a convex surface directed to the object side in order from the object side to the image side, has a positive refractive power as a whole, and is fixed with respect to the image surface at the time of zooming.

The sixth lens group G6 is composed of a meniscus negative lens with a convex surface directed to the object side. The sixth lens group G6 moves toward the image side along an optical axis at the time of focusing from an infinity object distance to an extremely close range.

The seventh lens group G7 is composed of a cemented lens of a biconvex positive lens and a meniscus negative lens with a concave surface directed to the object side in order from the object side to the image side, and has a positive refractive power as a whole. The seventh lens group G7 moves toward the object side along the optical axis at the time of focusing from the infinity object distance to the extremely close range.

A final lens group Gr is composed of: a vibration reduction group Gos composed of a cemented lens of a biconvex positive lens and a biconcave negative lens, and a biconcave negative lens; a meniscus positive lens with a convex surface directed to the object side; a meniscus positive lens with a convex surface directed to the object side; a cemented lens with a plano concave negative lens and a biconvex positive lens; a cemented lens of a biconcave negative lens and a biconvex positive lens; and a cemented lens of a biconvex positive lens and a biconcave negative lens. The final lens group Gr has a negative refractive power as a whole, and is fixed with respect to the image surface at the time of zooming.

A filter fr is a rear filter of an insertion type.

### Example 12

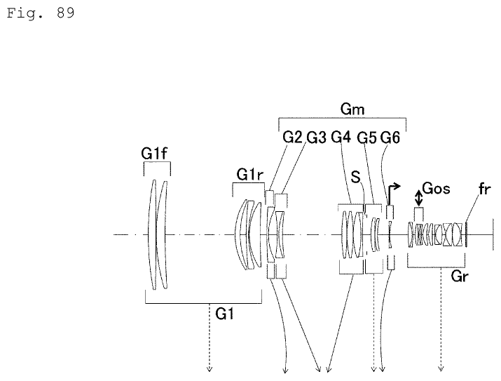

FIG. 89 is a lens configuration diagram of a telephoto zoom lens according to Example 12 of the present invention.

A first lens group G1 is composed of: a front sub-lens group G1f consisting of a biconvex positive lens and a meniscus positive lens with a convex surface directed to an object side; and a rear sub-lens group G1r consisting of a meniscus positive lens with a convex surface directed to the object side, a meniscus negative lens with a convex surface directed to the object side, and a meniscus positive lens with a convex surface directed to the object side in order from the object side to an image side. The first lens group G1 has a positive refractive power as a whole, and is fixed with respect to an image surface at the time of zooming.

A middle lens group Gm is composed of a second lens group G2, a third lens group G3, a fourth lens group G4, an aperture diaphragm S, a fifth lens group G5, and a sixth lens group G6.

The second lens group G2 is composed of a meniscus negative lens with a convex surface directed to the object side.

The third lens group G3 is composed of a cemented lens of a biconcave negative lens and a meniscus positive lens with a convex surface directed to the object side, and has a negative refractive power as a whole.

The fourth lens group G4 is composed of a biconvex positive lens, a biconvex positive lens, and a cemented lens of a biconvex positive lens and a biconcave negative lens in order from the object side to the image side, and has a positive refractive power as a whole.

The aperture diaphragm S is disposed between the fourth lends group G4 and the fifth lens group G5, and is fixed with respect to the image surface at the time of zooming.

The fifth lens group G5 is composed of a meniscus positive lens with a convex surface directed to the object side and a meniscus positive lens with a convex surface directed to the object side in order from the object side to the image side, has a positive refractive power as a whole, and is fixed with respect to the image surface at the time of zooming.

The sixth lens group G6 is composed of a biconcave negative lens. The sixth lens group G6 moves toward the image side along an optical axis at the time of focusing from an infinity object distance to an extremely close range.

A final lens group Gr is composed of: a cemented lens of a biconvex positive lens and a meniscus negative lens with a concave surface directed to the object side; a vibration reduction group Gos composed of a cemented lens of a biconvex positive lens and a biconcave negative lens, and a biconcave negative lens; a meniscus positive lens with a convex surface directed to the object side; a meniscus positive lens with a convex surface directed to the object side; a cemented lens of a plano concave negative lens and a biconvex positive lens; a cemented lens of a biconcave negative lens and a biconvex positive lens; and a cemented lens of a biconvex positive lens and a biconcave negative lens in order from the object side to the image side. The final lens group Gr has a positive refractive power as a whole, and is fixed with respect to the image surface at the time of zooming.

A filter fr is a rear filter of an insertion type.

### Example 13

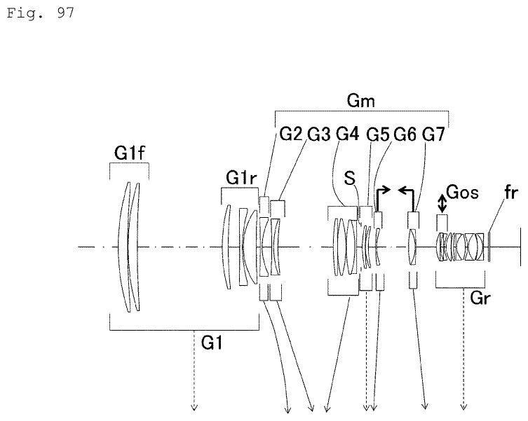

FIG. 97 is a lens configuration diagram of a telephoto zoom lens according to Example 13 of the present invention.

A first lens group G1 is composed of: a front sub-lens group Gif consisting of a meniscus positive lens with a convex surface directed to an object side and a meniscus positive lens with a convex surface directed to the object side; and a rear sub-lens group G1r consisting of a meniscus positive lens with a convex surface directed to the object side, a biconcave negative lens, and a meniscus positive lens with a convex surface directed to the object side in order from the object side to an image side. The first lens group G1 has a positive refractive power as a whole, and is fixed with respect to an image surface at the time of zooming.

A middle lens group Gm is composed of a second lens group G2, a third lens group G3, a fourth lens group G4, an aperture diaphragm S, a fifth lens group G5, a sixth lens group G6, and a seventh lens group G7.

The second lens group G2 is composed of a biconcave negative lens.

The third lens group G3 is composed of a cemented lens of a biconcave negative lens and a meniscus positive lens with a convex surface directed to the object side in order from the object side to the image side, and has a negative refractive power as a whole.

The fourth lens group G4 is composed of a biconvex positive lens, a biconvex positive lens, and a cemented lens of a biconvex positive lens and a meniscus negative lens with a concave surface directed to the object side in order from the object side to the image side, and has a positive refractive power as a whole.

The aperture diaphragm S is disposed between the fourth lens group G4 and the fifth lens group G5, and is fixed with respect to the image surface at the time of zooming.

The fifth lens group G5 is composed of a meniscus positive lens with a convex surface directed to the object side and a meniscus positive lens with a convex surface directed to the object side in order from the object side to the image side, has a positive refractive power as a whole, and is fixed with respect to the image surface at the time of zooming.

The sixth lens group G6 is composed of a meniscus negative lens with a concave surface directed to the object side. The sixth lens group G6 moves toward the image side along an optical axis at the time of focusing from an infinity object distance to an extremely close range.

The seventh lens group G7 is composed of a cemented lens of a biconvex positive lens and a meniscus negative lens with a concave surface directed to the object side in order from the object side to the image side, and has a positive refractive power as a whole. The seventh lens group G7 moves toward the object side along the optical axis at the time of focusing from the infinity object distance to the extremely close range.

A final lens group Gr is composed of: a vibration reduction group Gos composed of a cemented lens of a meniscus positive lens with a convex surface directed to the object side and a meniscus negative lens having an aspherical surface as an image-side surface and with a convex surface directed to the object side and a biconcave negative lens; a meniscus positive lens with a convex surface directed to the object side; a meniscus positive lens with a convex surface directed to the object side; a cemented lens of a plano concave negative lens and a biconvex positive lens; a cemented lens of a biconcave negative lens and a biconvex positive lens; and a cemented lens of a meniscus positive lens with a concave surface directed to the object side and a biconcave negative lens in order from the object side to the image side. The final lens group Gr has a positive refractive power as a whole, and is fixed with respect to the image surface at the time of zooming.

A filter fr is a rear filter of an insertion type.

Hereinafter, numerical value examples of the telephoto zoom lenses in the examples will be described.

In [Surface Data], the surface number is a number of a lens surface or an aperture diaphragm counted from the object side, r denotes a curvature radius of each surface, d denotes a distance of each surface, nd denotes a refractive index with respect to a d ray (wavelength of 587.56 nm), and vd denotes an Abbe number with respect to the d ray.

* (asterisk) added to the surface number indicates that the lens surface shape is an aspherical surface. Also, BF represents back focus.

(Diaphragm) added to the surface number indicates that the aperture diaphragm is located at that position. ∞ (infinity) is indicated with a curvature radius for a plane or an aperture diaphragm.

In [Aspherical Surface Data], each coefficient value that provides an aspherical surface shape of a lens surface with * added thereto in [Surface Data] is shown. As for the aspherical surface shape, coordinates of the aspherical surface are assumed to be represented by the following equation when displacement from the optical axis in a direction perpendicularly intersecting the optical axis is defined as y, displacement (sag amount) in the direction of the optical axis from an intersection between the aspherical surface and the optical axis is defined as z, a curvature radius of a reference spherical surface is defined as r, a conic coefficient is defined as K, and each of fourth to twelfth order aspherical surface coefficients is defined as A4, . . . , A12, respectively.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

In [Various Kinds of Data], values of a zoom ratio, a focal length in each focal length state, and the like are shown.

In [Variable Distance Data], values of variable distances and BF in each focal length state are shown.

In [Lens Group Data], a surface number configuring each lens group on the side closest to the object and a synthetic focal length of the entire lens group are shown.

Note that although millimeter (mm) is used as a unit of the described focal length f, curvature radius r, distance d of each surface, and other lengths for all element values below, the present invention is not limited thereto since equivalent optical performance can also be obtained in proportional expansion and proportional contraction in the optical system.

Also, d, g, and C represent a d ray, a g ray, and a C ray, respectively in the longitudinal aberration diagrams and the lateral aberration diagrams corresponding to the numerical value examples, and ΔS and ΔM represent a sagittal image surface and a meridional image surface, respectively.

### Numerical Value Example 1

Unit: mm
[Surface Data]

| Surface Number | r | d | nd | vd |
|---|---|---|---|---|
| Object surface | ∞ | (d0) | | |
| 1 | 308.3804 | 12.1417 | 1.65844 | 50.88 |
| 2 | −3649.7230 | 168.1994 | | |
| 3 | −261.2310 | 3.0000 | 1.73037 | 32.23 |
| 4 | −3157.1029 | 1.0000 | | |
| 5 | 80.5876 | 15.0226 | 1.43385 | 95.23 |
| 6 | 3261.4013 | (d6) | | |
| 7 | 305.4391 | 2.0001 | 1.59349 | 67.00 |
| 8 | 112.9881 | (d8) | | |
| 9 | −189.4529 | 1.9991 | 1.75500 | 52.32 |
| 10 | 86.1863 | 3.6030 | 1.84666 | 23.78 |
| 11 | 120.8517 | (d11) | | |
| 12 | 123.6941 | 8.6585 | 1.43700 | 95.10 |
| 13 | −183.0518 | 0.1500 | | |
| 14 | 76.9579 | 7.8263 | 1.43700 | 95.10 |
| 15 | 815.2272 | 0.1500 | | |
| 16 | 138.7498 | 1.9997 | 1.85150 | 40.78 |
| 17 | 46.1907 | 10.8594 | 1.43700 | 95.10 |
| 18 | 535.1939 | (d18) | | |
| 19(diaphragm) | ∞ | 1.2000 | | |
| 20 | 58.7452 | 4.9070 | 1.43700 | 95.10 |
| 21 | 175.3393 | (d21) | | |
| 22 | 86.7014 | 3.6451 | 1.92119 | 23.96 |
| 23 | 111.0354 | (d23) | | |
| 24 | 213.6562 | 1.0000 | 1.92119 | 23.96 |
| 25 | 42.5990 | (d25) | | |
| 26 | 54.1558 | 5.3803 | 1.80450 | 39.64 |
| 27 | −37.3236 | 0.9000 | 1.70154 | 41.15 |
| 28 | 204.1212 | 2.0000 | | |
| 29 | 109.0911 | 3.3758 | 1.85451 | 25.15 |
| 30 | −52.7229 | 0.8000 | 1.83481 | 42.72 |
| 31 | 46.1980 | 2.0283 | | |
| 32 | −540.0023 | 0.8000 | 1.75500 | 52.32 |
| 33 | 56.5343 | 2.0000 | | |
| 34 | 25.1774 | 2.2850 | 1.65160 | 58.54 |
| 35 | 28.1764 | 1.7966 | | |
| 36 | 33.6840 | 4.3330 | 1.85451 | 25.15 |
| 37 | 259.5917 | 1.6635 | | |
| 38 | ∞ | 0.9500 | 2.00069 | 25.46 |
| 39 | 20.5556 | 9.5810 | 1.64769 | 33.84 |
| 40 | −47.2086 | 2.6237 | | |
| 41 | −32.8250 | 1.0000 | 1.55032 | 75.50 |
| 42 | 21.5897 | 9.0130 | 1.72047 | 34.71 |
| 43 | −224.5989 | 0.2000 | | |
| 44 | 36.8387 | 10.2782 | 1.77047 | 29.74 |
| 45 | −25.3631 | 0.9500 | 2.00069 | 25.46 |
| 46 | 44.0298 | 7.2666 | | |
| 47 | ∞ | 1.5000 | 1.51680 | 64.20 |
| 48 | ∞ | (BF) | | |
| Image surface | ∞ | | | |

[Various Kinds of Data]
Zoom ratio 1.87

| | Wide angle | middle | telephoto |
|---|---|---|---|
| Focal length | 309.00 | 409.00 | 579.00 |
| F number | 4.11 | 4.11 | 4.12 |
| Full angle of view 2ω | 7.89 | 5.98 | 4.21 |
| Image height Y | 21.63 | 21.63 | 21.63 |
| Entire length of lens | 480.57 | 480.57 | 480.57 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d6 | 6.5601 | 17.1499 | 26.7034 |
| d8 | 9.8426 | 14.5216 | 11.7568 |
| d11 | 63.9645 | 39.3424 | 3.0000 |
| d18 | 6.4240 | 8.5570 | 39.3860 |
| d21 | 6.1171 | 16.1760 | 28.5622 |
| d23 | 25.6542 | 17.4582 | 3.4795 |
| d25 | 9.3203 | 14.6778 | 14.9950 |
| BF | 34.6000 | 34.6000 | 34.6000 |

At time of photographing magnification of 1:40

| | | | |
|---|---|---|---|
| d0 | 11874.6883 | 15849.7449 | 22587.8518 |
| d6 | 6.5601 | 17.1499 | 26.7034 |
| d8 | 9.8426 | 14.5216 | 11.7568 |
| d11 | 63.9645 | 39.3424 | 3.0000 |
| d18 | 6.4240 | 8.5570 | 39.3860 |
| d21 | 5.5162 | 13.8369 | 22.4115 |
| d23 | 27.7734 | 21.2121 | 10.9312 |
| d25 | 7.8020 | 13.2631 | 13.6941 |
| BF | 34.6000 | 34.6000 | 34.6000 |

[Lens Group Data]

| Group | start surface | focal length |
|---|---|---|
| G1 | 1 | 255.94 |
| G2 | 7 | −303.32 |
| G3 | 9 | −100.06 |
| G4 | 12 | 127.89 |
| G5 | 19 | 199.60 |
| G6 | 22 | 400.68 |
| G7 | 24 | −57.92 |
| Gr | 26 | 201.78 |
| G1f | 1 | 432.39 |

### Numerical Value Example 2

Unit: mm
[Surface Data]

| Surface Number | r | d | nd | vd |
|---|---|---|---|---|
| Object surface | ∞ | (d0) | | |
| 1 | 1926.2625 | 4.9106 | 1.65844 | 50.88 |
| 2 | −596.6861 | 0.2000 | | |
| 3 | 150.1873 | 8.3355 | 1.43385 | 95.23 |
| 4 | 396.5474 | 133.7762 | | |
| 5 | −567.9872 | 3.0000 | 1.73037 | 32.23 |
| 6 | 396.5773 | 1.0000 | | |
| 7 | 59.5412 | 9.9438 | 1.43700 | 95.10 |
| 8 | −1195.3807 | (d8) | | |
| 9 | 635.2395 | 1.5000 | 1.59349 | 67.00 |
| 10 | 71.2360 | (d10) | | |
| 11 | −131.3265 | 1.5000 | 1.75500 | 52.32 |
| 12 | 65.0793 | 2.8915 | 1.84666 | 23.78 |
| 13 | 99.2070 | (d13) | | |
| 14 | 151.4192 | 5.2621 | 1.43700 | 95.10 |
| 15 | −98.6498 | 0.1500 | | |
| 16 | 91.3229 | 5.3563 | 1.43700 | 95.10 |
| 17 | −274.2978 | (d17) | | |
| 18 | 79.2926 | 6.2933 | 1.43700 | 95.10 |
| 19 | −97.7855 | 3.0000 | 1.85150 | 40.78 |
| 20 | 142.2616 | (d20) | | |
| 21(diaphragm) | ∞ | 1.2000 | | |
| 22 | 241.4020 | 2.1095 | 1.43700 | 95.10 |
| 23 | 415.3724 | 0.2000 | | |
| 24 | 122.4511 | 3.3232 | 1.90110 | 27.06 |
| 25 | 331.4186 | (d25) | | |
| 26 | −539.1737 | 1.0000 | 1.92119 | 23.96 |
| 27 | 121.6542 | (d27) | | |
| 28 | 156.8764 | 3.0349 | 1.67300 | 38.26 |
| 29 | −50.2031 | 0.9000 | 1.92119 | 23.96 |
| 30 | −83.0136 | 10.5976 | | |
| 31 | 59.6036 | 3.1877 | 1.85451 | 25.15 |
| 32 | −77.7218 | 1.0000 | 1.83481 | 42.72 |
| 33 | 31.3590 | 2.5364 | | |
| 34 | −128.8969 | 0.8000 | 1.75500 | 52.32 |
| 35 | 85.2572 | 2.0000 | | |
| 36 | 23.8275 | 3.6867 | 1.65160 | 58.54 |
| 37 | 29.4065 | 2.9424 | | |
| 38 | 30.4639 | 4.3782 | 1.85451 | 25.15 |
| 39 | 358.6765 | 1.4996 | | |
| 40 | ∞ | 0.9500 | 2.00069 | 25.46 |
| 41 | 17.1884 | 7.6419 | 1.64769 | 33.84 |
| 42 | −68.2923 | 4.7703 | | |
| 43 | −27.2679 | 1.0000 | 1.55032 | 75.50 |
| 44 | 19.9158 | 7.0170 | 1.72047 | 34.71 |
| 45 | −125.8655 | 0.2000 | | |
| 46 | 40.0924 | 8.2849 | 1.77047 | 29.74 |
| 47 | −22.3224 | 0.9500 | 2.00069 | 25.46 |
| 48 | 50.7964 | 10.5153 | | |
| 49 | ∞ | 1.5000 | 1.51680 | 64.20 |
| 50 | ∞ | (BF) | | |
| Image surface | ∞ | | | |

[Various Kinds of Data]
Zoom ratio 1.92

| | Wide angle | middle | telephoto |
|---|---|---|---|
| Focal length | 409.00 | 565.00 | 785.00 |
| F number | 8.20 | 8.22 | 8.21 |
| Full angle of view 2ω | 5.96 | 4.31 | 3.09 |
| Image height Y | 21.63 | 21.63 | 21.63 |
| Entire length of lens | 447.39 | 447.39 | 447.39 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 3.6396 | 9.4276 | 13.8497 |
| d10 | 10.5662 | 8.3927 | 16.3762 |
| d13 | 54.3574 | 30.5916 | 3.5276 |
| d17 | 15.5349 | 18.3133 | 0.9767 |
| d20 | 15.4658 | 19.2034 | 44.9323 |
| d25 | 7.1509 | 4.1104 | 10.0950 |
| d27 | 27.3775 | 44.0533 | 44.3347 |
| BF | 38.9535 | 38.9535 | 38.9535 |

At time of photographing magnification of 1:40

| | | | |
|---|---|---|---|
| d0 | 15915.2631 | 22238.5692 | 31123.2403 |
| d8 | 3.6396 | 9.4276 | 13.8497 |
| d10 | 10.5662 | 8.3927 | 16.3762 |
| d13 | 54.3574 | 30.5916 | 3.5276 |
| d17 | 15.5349 | 18.3133 | 0.9767 |
| d20 | 15.4658 | 19.2034 | 44.9323 |
| d25 | 9.4791 | 6.9692 | 14.0741 |
| d27 | 25.0493 | 41.1945 | 40.3555 |
| BF | 38.9535 | 38.9535 | 38.9535 |

[Lens Group Data]

| Group | start surface | focal length |
|---|---|---|
| G1 | 1 | 176.39 |
| G2 | 9 | −135.32 |
| G3 | 11 | −77.11 |
| G4 | 14 | 74.06 |
| G5 | 18 | −224.57 |
| G6 | 21 | 184.28 |
| G7 | 26 | −107.67 |
| Gr | 28 | −390.39 |
| G1f | 1 | 306.37 |

### Numerical Value Example 3

Unit: mm
[Surface Data]

| Surface Number | r | d | nd | vd |
|---|---|---|---|---|
| Object surface | ∞ | (d0) | | |
| 1 | 250.0000 | 12.6962 | 1.65844 | 50.88 |
| 2 | 3000.0194 | 123.8205 | | |
| 3 | 99.5913 | 17.5007 | 1.43700 | 95.10 |
| 4 | −415.1640 | 3.2661 | | |
| 5 | −234.5824 | 3.0000 | 1.58913 | 61.25 |
| 6 | 223.9424 | 9.4262 | | |
| 7 | 116.0390 | 13.9079 | 1.43700 | 95.10 |
| 8 | −250.7555 | (d8) | | |
| 9 | −5391.8278 | 3.0000 | 1.65844 | 50.86 |
| 10 | 77.5452 | (d10) | | |
| 11 | −287.6017 | 4.4768 | 1.92119 | 23.96 |
| 12 | −88.1507 | 2.5000 | 1.95375 | 32.32 |
| 13 | 160.6312 | (d13) | | |
| 14 | 207.2404 | 5.3648 | 1.43700 | 95.10 |
| 15 | −218.5121 | 0.1500 | | |
| 16 | 156.3457 | 7.2177 | 1.43700 | 95.10 |
| 17 | −107.7805 | 0.1500 | | |
| 18 | 85.8902 | 7.9170 | 1.43700 | 95.10 |
| 19 | 103.1145 | 2.0000 | 1.95375 | 32.32 |
| 20 | 141.8206 | (d20) | | |
| 21(diaphragm) | ∞ | (d21) | | |
| 22 | 97.3957 | 3.7601 | 2.05090 | 26.94 |
| 23 | 622.1170 | (d23) | | |
| 24 | 87.2729 | 1.5000 | 2.00069 | 25.46 |
| 25 | 41.8064 | (d25) | | |
| 26 | 172.1951 | 1.0000 | 1.85883 | 30.00 |
| 27 | 26.8501 | 5.6111 | 2.00100 | 29.13 |
| 28 | −2991.6219 | 2.0000 | | |
| 29 | 96.7368 | 2.8205 | 1.85451 | 25.15 |
| 30 | −150.3475 | 0.8000 | 1.55032 | 75.50 |
| 31 | 42.9904 | 2.8733 | | |
| 32 | −141.8494 | 0.8000 | 1.75500 | 52.32 |
| 33 | 60.7926 | 2.0000 | | |
| 34 | 27.5162 | 5.4374 | 1.65412 | 39.68 |
| 35 | 262.4088 | 0.2000 | | |
| 36 | 33.2352 | 3.2040 | 1.76634 | 35.82 |
| 37 | 58.7332 | 2.9000 | | |
| 38 | −4199.6372 | 1.0000 | 2.05090 | 26.94 |
| 39 | 19.1235 | 7.5498 | 1.60342 | 38.01 |
| 40 | −135.5829 | 8.0000 | | |
| 41 | ∞ | 1.5000 | 1.51680 | 64.20 |
| 42 | ∞ | 8.7026 | | |
| 43 | −25.0794 | 1.0000 | 1.43700 | 95.10 |
| 44 | 31.0891 | 8.5740 | 1.73037 | 32.23 |
| 45 | −55.1142 | 0.2000 | | |
| 46 | 108.2324 | 7.5171 | 1.58144 | 40.89 |
| 47 | −28.1121 | 1.0000 | 2.00069 | 25.46 |
| 48 | 142.1264 | (BF) | | |
| Image surface | ∞ | | | |

[Various Kinds of Data]
Zoom ratio 1.87

| | Wide angle | middle | telephoto |
|---|---|---|---|
| Focal length | 309.00 | 409.00 | 579.00 |
| F number | 4.14 | 4.14 | 4.13 |
| Full angle of view 2ω | 7.98 | 6.02 | 4.24 |
| Image height Y | 21.63 | 21.63 | 21.63 |
| Entire length of lens | 464.29 | 464.29 | 464.29 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 3.0000 | 12.1383 | 13.4210 |
| d10 | 8.8683 | 8.0760 | 27.8332 |
| d13 | 69.3297 | 46.8023 | 3.4012 |
| d20 | 8.9119 | 23.0933 | 45.4546 |
| d21 | 5.7099 | 11.5892 | 20.6479 |
| d23 | 24.1464 | 14.7423 | 6.0000 |
| d25 | 11.6945 | 15.2193 | 14.9029 |
| BF | 36.2843 | 36.2843 | 36.2843 |

At time of photographing magnification of 1:40

| | | | |
|---|---|---|---|
| d0 | 11895.9373 | 15861.6722 | 22576.5000 |
| d8 | 3.0000 | 12.1383 | 13.4210 |
| d10 | 8.8683 | 8.0760 | 27.8332 |
| d13 | 69.3297 | 46.8023 | 3.4012 |
| d20 | 8.9119 | 23.0933 | 45.4546 |
| d21 | 5.6900 | 10.4702 | 17.8998 |
| d23 | 26.4611 | 17.7695 | 10.4001 |
| d25 | 9.3999 | 13.3111 | 13.2509 |
| BF | 36.2843 | 36.2843 | 36.2843 |

[Lens Group Data]

| Group | start surface | focal length |
|---|---|---|
| G1 | 1 | 166.63 |
| G2 | 9 | −116.08 |
| G3 | 11 | −104.34 |
| G4 | 14 | 182.52 |
| G5 | 22 | 109.48 |
| G6 | 24 | −81.54 |
| Gr | 26 | 279.43 |
| G1f | 1 | 413.44 |

### Numerical Value Example 4

Unit: mm
[Surface Data]

| Surface Number | r | d | nd | vd |
|---|---|---|---|---|
| Object surface | ∞ | (d0) | | |
| 1 | 896.6174 | 9.2834 | 1.65844 | 50.88 |
| 2 | −773.8842 | 15.0000 | | |
| 3 | 228.5965 | 11.0086 | 1.49700 | 81.61 |
| 4 | 619.4330 | 104.7205 | | |
| 5 | −775.1508 | 3.0000 | 1.73037 | 32.23 |
| 6 | 414.0022 | 1.0000 | | |
| 7 | 83.0150 | 15.6824 | 1.43700 | 95.10 |
| 8 | 1863.5145 | (d8) | | |
| 9 | 625.8318 | 2.0000 | 1.59349 | 67.00 |
| 10 | 101.2067 | (d10) | | |
| 11 | −172.9059 | 1.9998 | 1.75500 | 52.32 |
| 12 | 82.8708 | 4.2654 | 1.84666 | 23.78 |
| 13 | 137.9177 | (d13) | | |
| 14 | 200.6601 | 6.9902 | 1.43700 | 95.10 |
| 15 | −200.6601 | 0.1500 | | |
| 16 | 74.6578 | 8.0432 | 1.43700 | 95.10 |
| 17 | 621.6305 | 0.1500 | | |
| 18 | 117.4146 | 2.0000 | 1.85150 | 40.78 |
| 19 | 50.2339 | 11.2345 | 1.43700 | 95.10 |
| 20 | 15258.2290 | (d20) | | |
| 21(diaphragm) | ∞ | 1.2000 | | |
| 22 | 83.6978 | 5.2456 | 1.43700 | 95.10 |
| 23 | 309.2614 | 0.2000 | | |
| 24 | 75.3719 | 3.8660 | 1.90110 | 27.06 |
| 25 | 97.0710 | (d25) | | |
| 26 | 275.3938 | 1.0000 | 1.85451 | 25.15 |
| 27 | 54.0294 | (d27) | | |
| 28 | 85.8550 | 5.5533 | 1.80450 | 39.64 |
| 29 | −46.9887 | 1.0000 | 1.70154 | 41.15 |
| 30 | 496.1664 | 2.0000 | | |
| 31 | 70.7514 | 3.9649 | 1.85451 | 25.15 |
| 32 | −95.2728 | 1.0000 | 1.83481 | 42.72 |
| 33 | 41.4020 | 2.9603 | | |
| 34 | −151.5232 | 0.8000 | 1.75500 | 52.32 |
| 35 | 93.2781 | 2.0000 | | |
| 36 | 29.4135 | 4.9496 | 1.65160 | 58.54 |
| 37 | 63.5814 | 6.6935 | | |
| 38 | 41.3656 | 4.6858 | 1.85451 | 25.15 |
| 39 | 141.4357 | 1.9176 | | |
| 40 | ∞ | 1.0000 | 2.00069 | 25.46 |
| 41 | 19.9625 | 8.5087 | 1.64769 | 33.84 |
| 42 | −74.2727 | 5.7328 | | |
| 43 | −31.3011 | 1.0000 | 1.55032 | 75.50 |
| 44 | 21.7431 | 8.3936 | 1.72047 | 34.71 |
| 45 | 141.1595 | 0.2000 | | |
| 46 | 51.2959 | 10.4356 | 1.77047 | 29.74 |
| 47 | −23.4832 | 0.9500 | 2.00069 | 25.46 |
| 48 | 60.1336 | 6.5558 | | |
| 49 | ∞ | 1.5000 | 1.51680 | 64.20 |
| 50 | ∞ | (BF) | | |
| Image surface | ∞ | | | |

[Various Kinds of Data]
Zoom ratio 1.87

| | Wide angle | middle | telephoto |
|---|---|---|---|
| Focal length | 309.00 | 409.00 | 579.00 |
| F number | 4.11 | 4.13 | 4.14 |
| Full angle of view 2ω | 7.88 | 5.96 | 4.20 |
| Image height Y | 21.63 | 21.63 | 21.63 |
| Entire length of lens | 463.50 | 463.50 | 463.50 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 15.6086 | 26.0567 | 26.5284 |
| d10 | 10.3292 | 12.1217 | 21.1241 |
| d13 | 67.6815 | 43.6712 | 3.9571 |
| d20 | 5.0186 | 10.0473 | 44.3408 |
| d25 | 14.9944 | 11.2665 | 7.2840 |
| d27 | 26.1412 | 36.6101 | 36.5389 |
| BF | 33.8845 | 33.8845 | 33.8845 |

At time of photographing magnification of 1:40

| | | | |
|---|---|---|---|
| d0 | 11922.0721 | 15934.7951 | 22831.4681 |
| d8 | 15.6086 | 26.0567 | 26.5284 |
| d10 | 10.3292 | 12.1217 | 21.1241 |
| d13 | 67.6815 | 43.6712 | 3.9571 |
| d20 | 5.0186 | 10.0473 | 44.3408 |
| d25 | 16.6505 | 13.3219 | 10.2021 |
| d27 | 24.4851 | 34.5547 | 33.6208 |
| BF | 33.8845 | 33.8845 | 33.8845 |

[Lens Group Data]

| Group | start surface | focal length |
|---|---|---|
| G1 | 1 | 226.75 |
| G2 | 9 | −203.71 |
| G3 | 11 | −105.59 |
| G4 | 14 | 115.54 |
| G5 | 21 | 148.19 |
| G6 | 26 | −78.83 |
| Gr | 28 | 1137.66 |
| G1f | 1 | 340.47 |

### Numerical Value Example 5

Unit: mm
[Surface Data]

| Surface Number | r | d | nd | vd |
|---|---|---|---|---|
| Object surface | ∞ | (d0) | | |
| 1 | 342.1942 | 7.0721 | 1.65844 | 50.88 |
| 2 | −1123.0795 | 96.7120 | | |
| 3 | 84.3569 | 6.2522 | 1.43700 | 95.10 |
| 4 | 127.5199 | 6.9470 | | |
| 5 | −785.9129 | 3.0000 | 1.73037 | 32.23 |
| 6 | 549.0677 | 1.0000 | | |
| 7 | 73.4814 | 11.5924 | 1.43700 | 95.10 |
| 8 | −42527.2922 | (d8) | | |
| 9 | 172.1862 | 2.8116 | 1.59349 | 67.00 |
| 10 | 61.1641 | (d10) | | |
| 11 | −135.6270 | 1.5000 | 1.75500 | 52.32 |
| 12 | 68.6574 | 3.1598 | 1.84666 | 23.78 |
| 13 | 103.3711 | (d13) | | |
| 14 | 180.6839 | 5.8065 | 1.43700 | 95.10 |
| 15 | −111.1683 | 0.1500 | | |
| 16 | 78.0521 | 5.7507 | 1.43700 | 95.10 |
| 17 | −592.0242 | (d17) | | |
| 18 | 67.9899 | 6.3323 | 1.43700 | 95.10 |
| 19 | −110.9787 | 3.0000 | 1.85150 | 40.78 |
| 20 | 96.6568 | (d20) | | |
| 21(diaphragm) | ∞ | 1.2000 | | |
| 22 | 147.5532 | 2.1192 | 1.43700 | 95.10 |
| 23 | 213.6147 | 0.2000 | | |
| 24 | 98.1524 | 2.2515 | 1.90110 | 27.06 |
| 25 | 174.5915 | (d25) | | |
| 26 | −2602.1290 | 1.0000 | 1.92119 | 23.96 |
| 27 | 112.4259 | (d27) | | |
| 28 | 201.5283 | 2.8329 | 1.67300 | 38.26 |
| 29 | −47.9825 | 1.5000 | 1.92119 | 23.96 |
| 30 | −84.2728 | 18.7072 | | |
| 31 | 137.9760 | 2.9351 | 1.85451 | 25.15 |
| 32 | −38.0964 | 0.8000 | 1.83481 | 42.72 |
| 33 | 37.9367 | 1.8085 | | |
| 34 | −247.4698 | 0.8000 | 1.75500 | 52.32 |
| 35 | 58.7882 | 2.0000 | | |
| 36 | 22.1982 | 2.1615 | 1.65160 | 58.54 |
| 37 | 24.6925 | 1.5825 | | |
| 38 | 28.5361 | 4.1943 | 1.85451 | 25.15 |
| 39 | 348.8273 | 1.5056 | | |
| 40 | ∞ | 0.9500 | 2.00069 | 25.46 |
| 41 | 17.2356 | 8.8346 | 1.64769 | 33.84 |
| 42 | −43.2087 | 2.5516 | | |
| 43 | −29.3589 | 1.0000 | 1.55032 | 75.50 |
| 44 | 19.6764 | 7.3921 | 1.72047 | 34.71 |
| 45 | −400.4967 | 0.2000 | | |
| 46 | 45.3537 | 9.3357 | 1.77047 | 29.74 |
| 47 | −20.8158 | 0.9500 | 2.00069 | 25.46 |
| 48 | 75.9961 | 6.7821 | | |
| 49 | ∞ | 1.5000 | 1.51680 | 64.20 |
| 50 | ∞ | (BF) | | |
| Image surface | ∞ | | | |

[Various Kinds of Data]
Zoom ratio 1.92

| | Wide angle | middle | telephoto |
|---|---|---|---|
| Focal length | 409.00 | 565.00 | 785.00 |
| F number | 8.21 | 8.22 | 8.21 |
| Full angle of view 2ω | 5.96 | 4.31 | 3.09 |
| Image height Y | 21.63 | 21.63 | 21.63 |
| Entire length of lens | 438.88 | 438.88 | 438.88 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 12.0085 | 16.2288 | 21.2672 |
| d10 | 10.1883 | 11.8119 | 13.5641 |
| d13 | 61.2710 | 34.0762 | 3.8954 |
| d17 | 27.2063 | 29.7842 | 18.2688 |
| d20 | 19.2294 | 15.2192 | 44.2320 |
| d25 | 10.7471 | 6.1325 | 3.3905 |
| d27 | 15.2148 | 42.6125 | 51.2472 |
| BF | 34.8381 | 34.8381 | 34.8381 |

At time of photographing magnification of 1:40

| | | | |
|---|---|---|---|
| d0 | 16011.6922 | 22338.5778 | 31193.4379 |
| d8 | 12.0085 | 16.2288 | 21.2672 |
| d10 | 10.1883 | 11.8119 | 13.5641 |
| d13 | 61.2710 | 34.0762 | 3.8954 |
| d17 | 27.2063 | 29.7842 | 18.2688 |
| d20 | 19.2294 | 15.2192 | 44.2320 |
| d25 | 13.5536 | 9.1944 | 7.3763 |
| d27 | 12.4083 | 39.5505 | 47.2615 |
| BF | 34.8380 | 34.8381 | 34.8381 |

[Lens Group Data]

| Group | start surface | focal length |
|---|---|---|
| G1 | 1 | 155.22 |
| G2 | 9 | −161.36 |
| G3 | 11 | −79.91 |
| G4 | 14 | 79.71 |
| G5 | 18 | −174.77 |
| G6 | 21 | 200.50 |
| G7 | 26 | −116.97 |
| Gr | 28 | −229.65 |
| G1f | 1 | 399.10 |

### Numerical Value Example 6

Unit: mm
[Surface Data]

| Surface Number | r | d | nd | vd |
|---|---|---|---|---|
| Object surface | ∞ | (d0) | | |
| 1 | 399.4423 | 6.8888 | 1.65844 | 50.88 |
| 2 | −1040.8294 | 105.3470 | | |
| 3 | 87.0559 | 7.1333 | 1.43700 | 95.10 |
| 4 | 193.2646 | 4.4866 | | |
| 5 | 3799.6391 | 3.0000 | 1.73037 | 32.23 |
| 6 | 188.7599 | 1.0000 | | |
| 7 | 86.3685 | 10.6749 | 1.43700 | 95.10 |
| 8 | −2162.3872 | (d8) | | |
| 9 | 159.3444 | 1.7453 | 1.59349 | 67.00 |
| 10 | 54.4583 | (d10) | | |
| 11 | −88.3013 | 1.5000 | 1.75500 | 52.32 |
| 12 | 75.6262 | 3.7483 | 1.84666 | 23.78 |
| 13 | 207.5943 | (d13) | | |
| 14 | 111.0115 | 6.1699 | 1.43700 | 95.10 |
| 15 | −123.4365 | 0.1500 | | |
| 16 | 145.0404 | 5.0912 | 1.43700 | 95.10 |
| 17 | −182.1608 | 0.1500 | | |
| 18 | 97.9589 | 6.4654 | 1.43700 | 95.10 |
| 19 | −97.0370 | 1.5000 | 1.85150 | 40.78 |
| 20 | 117.0546 | (d20) | | |
| 21(diaphragm) | ∞ | 2.0000 | | |
| 22 | 68.3220 | 2.0000 | 1.92119 | 23.96 |
| 23 | 53.1093 | 1.0989 | | |
| 24 | 67.3226 | 4.9270 | 1.87070 | 40.73 |
| 25 | −1642.0300 | (d25) | | |
| 26 | −342.9184 | 1.0000 | 1.48749 | 70.44 |
| 27 | 86.3576 | (d27) | | |
| 28 | −67.4837 | 0.9000 | 1.65160 | 58.54 |
| 29 | −171.7890 | 2.5820 | 1.60342 | 38.01 |
| 30 | −47.4840 | 9.4839 | | |
| 31 | 94.9138 | 2.7665 | 1.85451 | 25.15 |
| 32 | −73.2244 | 1.0000 | 1.83481 | 42.72 |
| 33 | 51.8196 | 1.4767 | | |
| 34 | 1918.4578 | 0.8673 | 1.75500 | 52.32 |
| 35 | 66.7685 | 2.0000 | | |
| 36 | 24.4375 | 3.8839 | 1.65160 | 58.54 |
| 37 | 97.6818 | 5.8865 | | |
| 38 | 30.9602 | 3.3466 | 1.61772 | 49.81 |
| 39 | 203.1533 | 1.5631 | | |
| 40 | ∞ | 0.9500 | 2.05090 | 26.94 |
| 41 | 15.1691 | 6.6448 | 1.64769 | 33.84 |
| 42 | −108.6175 | 3.0232 | | |
| 43 | −26.8285 | 2.0000 | 1.55032 | 75.50 |
| 44 | 17.1079 | 4.2513 | 1.72047 | 34.71 |
| 45 | 43.1493 | 2.7041 | | |
| 46 | 45.3253 | 7.9603 | 1.77047 | 29.74 |
| 47 | −17.6336 | 0.9500 | 2.05090 | 26.94 |
| 48 | −175.0223 | 10.1327 | | |
| 49 | ∞ | 1.5000 | 1.51680 | 64.20 |
| 50 | ∞ | (BF) | | |
| Image surface | ∞ | | | |

[Various Kinds of Data]
Zoom ratio 4.23

| | Wide angle | middle | telephoto |
|---|---|---|---|
| Focal length | 185.40 | 380.00 | 785.00 |
| F number | 5.76 | 6.81 | 8.39 |
| Full angle of view 2ω | 13.15 | 6.40 | 3.09 |
| Image height Y | 21.63 | 21.63 | 21.63 |
| Entire length of lens | 478.85 | 478.85 | 478.85 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 3.0000 | 25.4738 | 36.9305 |
| d10 | 10.4671 | 17.5105 | 11.3121 |
| d13 | 123.1873 | 63.7917 | 3.0000 |
| d20 | 6.7538 | 44.4053 | 52.2288 |
| d25 | 9.2335 | 18.1199 | 11.2969 |
| d27 | 34.1460 | 17.4865 | 72.0196 |
| BF | 40.1124 | 40.1125 | 40.1124 |

At time of photographing magnification of 1:40

| | | | |
|---|---|---|---|
| d0 | 7071.0996 | 14656.7217 | 30963.5486 |
| d8 | 3.0000 | 25.4738 | 36.9305 |
| d10 | 10.4671 | 17.5105 | 11.3121 |
| d13 | 123.1873 | 63.7917 | 3.0000 |
| d20 | 6.7538 | 44.4053 | 52.2288 |
| d25 | 10.0561 | 20.1397 | 13.8010 |
| d27 | 33.3234 | 15.4668 | 69.5154 |
| BF | 40.1124 | 40.1124 | 40.1124 |

[Lens Group Data]

| Group | start surface | focal length |
|---|---|---|
| G1 | 1 | 181.54 |
| G2 | 9 | −140.27 |
| G3 | 11 | −86.97 |
| G4 | 14 | 144.66 |
| G5 | 21 | 103.13 |
| G6 | 26 | −141.40 |
| Gr | 28 | −95.14 |
| G1f | 1 | 439.24 |

### Numerical Value Example 7

Unit: mm
[Surface Data]

| Surface Number | r | d | nd | vd |
|---|---|---|---|---|
| Object surface | ∞ | (d0) | | |
| 1 | 205.5470 | 8.1582 | 1.59349 | 67.00 |
| 2 | −5066.0929 | 113.8473 | | |
| 3 | −327.3713 | 3.0000 | 1.78800 | 47.37 |
| 4 | −2087.2089 | 1.0000 | | |
| 5 | 70.8804 | 8.7731 | 1.43385 | 95.23 |
| 6 | 1592.2289 | (d6) | | |
| 7 | −2934.5418 | 1.5000 | 1.63930 | 44.87 |
| 8 | 86.4212 | (d8) | | |
| 9 | −194.6539 | 1.5000 | 1.75500 | 52.32 |
| 10 | 73.6057 | 3.1124 | 1.92119 | 23.96 |
| 11 | 117.3083 | (d11) | | |
| 12 | 171.9624 | 5.6700 | 1.43385 | 95.23 |
| 13 | −113.5774 | 0.1500 | | |
| 14 | 123.5238 | 5.3702 | 1.43385 | 95.23 |
| 15 | −187.0039 | 0.1500 | | |
| 16 | 79.1939 | 6.4847 | 1.43385 | 95.23 |
| 17 | −132.0964 | 1.5000 | 1.80400 | 46.58 |
| 18 | 256.8232 | (d18) | | |
| 19(diaphragm) | ∞ | 1.2000 | | |
| 20 | 42.6286 | 1.5028 | 1.43700 | 95.10 |
| 21 | 27.9179 | 2.3806 | 1.57135 | 52.95 |
| 22 | 36.1218 | (d22) | | |
| 23 | 144.7252 | 1.0000 | 1.92119 | 23.96 |
| 24 | 53.9750 | (d24) | | |
| 25 | 95.6062 | 3.3841 | 1.60342 | 38.03 |
| 26 | −47.8972 | 0.9000 | 2.00069 | 25.46 |
| 27 | −78.7880 | 2.0000 | | |
| 28 | 84.4981 | 2.4388 | 1.68893 | 31.16 |
| 29 | −86.8367 | 0.8000 | 1.75500 | 52.32 |
| 30 | 48.4218 | 1.8405 | | |
| 31 | −208.5168 | 0.8000 | 1.75500 | 52.32 |
| 32 | 88.5546 | 4.0278 | | |
| 33 | 237.1443 | 2.2256 | 1.51680 | 64.20 |
| 34 | −252.2873 | 10.9623 | | |
| 35 | −34.2997 | 1.0000 | 1.43700 | 95.10 |
| 36 | 83.7551 | 0.1000 | | |
| 37 | 68.4817 | 6.8333 | 1.56732 | 42.84 |
| 38 | −39.0163 | 0.1000 | | |
| 39 | 64.6359 | 7.9700 | 1.85451 | 25.15 |
| 40 | −32.2243 | 0.9000 | 1.96300 | 24.11 |
| 41 | 94.9330 | 29.4104 | | |
| 42 | ∞ | 1.5000 | 1.51680 | 64.20 |
| 43 | ∞ | (BF) | | |
| Image surface | ∞ | | | |

[Various Kinds of Data]
Zoom ration 2.54

| | Wide angle | middle | telephoto |
|---|---|---|---|
| Focal length | 309.00 | 490.00 | 785.00 |
| F number | 8.09 | 8.06 | 8.10 |
| Full angle of view 2ω | 8.04 | 5.07 | 3.16 |
| Image height Y | 21.63 | 21.63 | 21.63 |
| Entire length of lens | 471.87 | 471.87 | 471.87 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d6 | 14.7261 | 24.1020 | 21.7050 |
| d8 | 7.9149 | 10.3108 | 38.0328 |
| d11 | 92.0001 | 54.2025 | 3.5345 |
| d18 | 42.3297 | 29.6515 | 55.0533 |
| d22 | 3.8084 | 12.9959 | 4.1302 |
| d24 | 10.3351 | 39.8516 | 48.6585 |
| BF | 57.2665 | 57.2665 | 57.2665 |

At time of photographing magnification of 1:40

| | | | |
|---|---|---|---|
| d0 | 11942.2245 | 19235.4556 | 31313.0395 |
| d6 | 14.7261 | 24.1020 | 21.7050 |
| d8 | 7.9149 | 10.3108 | 38.0328 |
| d11 | 92.0001 | 54.2025 | 3.5345 |
| d18 | 42.3297 | 29.6515 | 55.0533 |
| d22 | 5.9460 | 15.6449 | 8.1110 |
| d24 | 8.1975 | 37.2025 | 44.6777 |
| BF | 57.2665 | 57.2665 | 57.2665 |

[Lens Group Data]

| Group | start surface | focal length |
|---|---|---|
| G1 | 1 | 183.69 |
| G2 | 7 | −131.29 |
| G3 | 9 | −105.12 |
| G4 | 12 | 82.95 |
| G5 | 19 | −3624.00 |
| G6 | 23 | −93.94 |
| Gr | 25 | 349.62 |
| G1f | 1 | 333.02 |

### Numerical Value Example 8

Unit: mm
[Surface Data]

| Surface Number | r | d | nd | vd |
|---|---|---|---|---|
| Object surface | ∞ | (d0) | | |
| 1 | 342.9535 | 6.9593 | 1.65844 | 50.88 |
| 2 | −1231.9673 | 102.8659 | | |
| 3 | 74.3323 | 5.5667 | 1.43700 | 95.10 |
| 4 | 101.2612 | 8.8022 | | |
| 5 | −444.8254 | 3.0000 | 1.73037 | 32.23 |
| 6 | 2756.6186 | 1.0000 | | |
| 7 | 78.1770 | 11.5248 | 1.43700 | 95.10 |
| 8 | −896.6522 | (d8) | | |
| 9 | 223.9990 | 1.5000 | 1.59349 | 67.00 |
| 10 | 65.0522 | (d10) | | |
| 11 | −134.9075 | 1.5000 | 1.75500 | 52.32 |
| 12 | 68.9790 | 3.1142 | 1.84666 | 23.78 |
| 13 | 99.4279 | (d13) | | |
| 14 | 167.5147 | 5.8477 | 1.43700 | 95.10 |
| 15 | −125.3067 | 0.1500 | | |
| 16 | 86.1804 | 6.4043 | 1.43700 | 95.10 |
| 17 | −365.8933 | (d17) | | |
| 18 | 78.3072 | 6.5903 | 1.43700 | 95.10 |
| 19 | −107.8277 | 3.0000 | 1.85150 | 40.78 |
| 20 | 179.1904 | (d20) | | |
| 21(diaphragm) | ∞ | 1.2000 | | |
| 22 | −100.3907 | 1.8337 | 1.43700 | 95.10 |
| 23 | −132.7235 | 0.2000 | | |
| 24 | 327.3233 | 2.2767 | 1.90110 | 27.06 |
| 25 | −1076.2996 | (d25) | | |
| 26 | −3844.5266 | 1.0000 | 1.92119 | 23.96 |
| 27 | 107.9560 | (d27) | | |
| 28 | 124.2249 | 6.0509 | 1.67300 | 38.26 |
| 29 | −41.4667 | 1.5000 | 1.92119 | 23.96 |
| 30 | −75.5678 | 5.8201 | | |
| 31 | 129.6605 | 3.9910 | 1.85451 | 25.15 |
| 32 | −49.1680 | 0.8000 | 1.83481 | 42.72 |
| 33 | 48.0981 | 1.5946 | | |
| 34 | 193.6845 | 0.8000 | 1.75500 | 52.32 |
| 35 | 44.2096 | 2.0000 | | |
| 36 | 25.8093 | 2.8102 | 1.65160 | 58.54 |
| 37 | 28.8248 | 1.6476 | | |
| 38 | 32.6930 | 4.9982 | 1.85451 | 25.15 |
| 39 | −640.6369 | 1.1515 | | |
| 40 | ∞ | 0.9500 | 2.00069 | 25.46 |
| 41 | 18.4848 | 8.5745 | 1.64769 | 33.84 |
| 42 | −118.8492 | 3.1334 | | |
| 43 | −39.9423 | 1.0000 | 1.55032 | 75.50 |
| 44 | 21.1061 | 6.5025 | 1.72047 | 34.71 |
| 45 | 133.1516 | 0.2000 | | |
| 46 | 46.5045 | 10.6691 | 1.77047 | 29.74 |
| 47 | −23.3126 | 0.9500 | 2.00069 | 25.46 |
| 48 | 95.5438 | 6.0232 | | |
| 49 | ∞ | 1.5000 | 1.51680 | 64.20 |
| 50 | ∞ | (BF) | | |
| Image surface | ∞ | | | |

[Various Kinds of Data]
Zoom ratio 2.54

| | Wide angle | middle | telephoto |
|---|---|---|---|
| Focal length | 309.00 | 490.00 | 785.00 |
| F number | 6.57 | 7.75 | 8.33 |
| Full angle of view 2ω | 7.92 | 4.97 | 3.09 |
| Image height Y | 21.63 | 21.63 | 21.63 |
| Entire length of lens | 467.57 | 467.57 | 467.57 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 9.5618 | 14.9887 | 20.8187 |
| d10 | 9.9722 | 10.0803 | 11.1450 |
| d13 | 85.7718 | 45.5313 | 3.9266 |
| d17 | 24.1771 | 29.4115 | 15.9939 |
| d20 | 19.2294 | 15.2192 | 44.2320 |
| d25 | 6.0692 | 6.5094 | 3.0000 |
| d27 | 31.1879 | 64.2291 | 86.8534 |
| BF | 34.6000 | 34.6000 | 34.6000 |

At time of photographing magnification of 1:40

| | | | |
|---|---|---|---|
| d0 | 11985.7436 | 19313.6046 | 31334.9593 |
| d8 | 9.5618 | 14.9887 | 20.8187 |
| d10 | 9.9722 | 10.0803 | 11.1450 |
| d13 | 85.7718 | 45.5313 | 3.9266 |
| d17 | 24.1771 | 29.4115 | 15.9939 |
| d20 | 19.2294 | 15.2192 | 44.2320 |
| d25 | 8.4023 | 9.3942 | 6.9735 |
| d27 | 28.8549 | 61.3444 | 82.8798 |
| BF | 34.6000 | 34.6000 | 34.6000 |

[Lens Group Data]

| Group | start surface | focal length |
|---|---|---|
| G1 | 1 | 153.97 |
| G2 | 9 | −155.01 |
| G3 | 11 | −77.65 |
| G4 | 14 | 82.01 |
| G5 | 18 | −359.55 |
| G6 | 21 | 389.56 |
| G7 | 26 | −113.98 |
| Gr | 28 | −387.10 |
| G1f | 1 | 408.15 |

### Numerical Value Example 9

Unit: mm
[Surface Data]

| Surface Number | r | d | nd | vd |
|---|---|---|---|---|
| Object surface | ∞ | (d0) | | |
| 1 | 278.2117 | 16.3646 | 1.51742 | 52.15 |
| 2 | −1000.0000 | 107.0000 | | |
| 3 | −285.0503 | 4.0000 | 1.58913 | 61.25 |
| 4 | 5358.3135 | 0.5000 | | |
| 5 | 90.6153 | 18.8457 | 1.43700 | 95.10 |
| 6 | 2904.6158 | (d6) | | |
| 7 | 210.8342 | 2.4759 | 1.80610 | 33.27 |
| 8 | 119.4862 | (d8) | | |
| 9 | −134.7183 | 2.5000 | 1.69680 | 55.46 |
| 10 | 115.0237 | (d10) | | |
| 11 | 160.2499 | 6.5758 | 1.85451 | 25.15 |
| 12 | −921.3377 | 2.5000 | 1.77047 | 29.74 |
| 13 | 199.9665 | (d13) | | |
| 14 | 155.9544 | 9.8593 | 1.43700 | 95.10 |
| 15 | −118.1367 | 0.1500 | | |
| 16 | 101.7684 | 7.3312 | 1.43700 | 95.10 |
| 17 | −1630.4433 | 0.1500 | | |
| 18 | 68.6294 | 10.1572 | 1.43700 | 95.10 |
| 19 | −195.1290 | 2.5000 | 1.80610 | 33.27 |
| 20 | 70.3102 | (d20) | | |
| 21(diaphragm) | ∞ | (d21) | | |
| 22 | 91.5324 | 3.4332 | 1.85883 | 30.00 |
| 23 | 306.7548 | (d23) | | |
| 24 | 79.3150 | 1.5000 | 2.05090 | 26.94 |
| 25 | 46.5202 | (d25) | | |
| 26 | 76.1667 | 6.4400 | 1.80610 | 33.27 |
| 27 | −30.7601 | 1.0000 | 1.80450 | 39.64 |
| 28 | 317.0395 | 2.0000 | | |
| 29 | 82.5677 | 3.2787 | 1.73037 | 32.23 |
| 30 | −106.2487 | 0.8000 | 1.55032 | 75.50 |
| 31 | 40.7489 | 3.2984 | | |
| 32 | −84.2074 | 0.8000 | 1.75500 | 52.32 |
| 33 | 102.0286 | 2.0000 | | |
| 34 | 35.7528 | 2.5021 | 1.49700 | 81.61 |
| 35 | 64.9923 | 1.3000 | | |
| 36 | 41.4048 | 1.5000 | 1.92119 | 23.96 |
| 37 | 23.8488 | 6.6531 | 1.61340 | 44.27 |
| 38 | 378.7108 | 16.0989 | | |
| 39 | ∞ | 1.5000 | 1.51680 | 64.20 |
| 40 | ∞ | 13.3293 | | |
| 41 | −148.7079 | 1.5000 | 1.43700 | 95.10 |
| 42 | 25.9638 | 9.7357 | 1.64769 | 33.84 |
| 43 | −59.6219 | 0.2000 | | |
| 44 | 167.3872 | 6.7248 | 1.67270 | 32.17 |
| 45 | −36.4121 | 1.5000 | 2.05090 | 26.94 |
| 46 | −258.0267 | 4.1560 | | |
| 47 | −33.4544 | 1.5000 | 2.05090 | 26.94 |
| 48 | −169.5667 | (BF) | | |
| Image surface | ∞ | | | |

[Various Kinds of Data]
Zoom ratio 1.87

| | Wide angle | middle | telephoto |
|---|---|---|---|
| Focal length | 309.00 | 409.00 | 579.00 |
| F number | 4.14 | 4.14 | 4.13 |
| Full angle of view 2ω | 7.94 | 5.99 | 4.24 |
| Image height Y | 21.63 | 21.63 | 21.63 |
| Entire length of lens | 489.28 | 489.28 | 489.28 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d6 | 14.8606 | 31.5631 | 47.9170 |
| d8 | 34.3848 | 23.7515 | 10.6461 |
| d10 | 38.3289 | 31.3154 | 3.1591 |
| d13 | 29.3152 | 9.1662 | 2.0000 |
| d20 | 13.2924 | 34.3859 | 66.4598 |
| d21 | 5.8277 | 10.8663 | 16.1993 |
| d23 | 18.7783 | 11.7460 | 3.0000 |
| d25 | 14.5520 | 16.5457 | 19.9587 |
| BF | 36.2845 | 36.2845 | 36.2846 |

At time of photographing magnification of 1:40

| | | | |
|---|---|---|---|
| d0 | 11940.1871 | 15919.4748 | 22659.3773 |
| d6 | 14.8606 | 31.5631 | 47.9170 |
| d8 | 34.3848 | 23.7515 | 10.6461 |
| d10 | 38.3289 | 31.3154 | 3.1591 |
| d13 | 29.3152 | 9.1662 | 2.0000 |
| d20 | 13.2924 | 34.3859 | 66.4598 |
| d21 | 5.5573 | 10.3051 | 14.8407 |
| d23 | 21.6425 | 15.5228 | 8.3456 |
| d25 | 11.9582 | 13.3301 | 15.9717 |
| BF | 36.2845 | 36.2845 | 36.2846 |

[Lens Group Data]

| Group | start surface | focal length |
|---|---|---|
| G1 | 1 | 239.41 |
| G2 | 7 | −346.30 |
| G3 | 9 | −88.68 |
| G4 | 11 | 598.38 |
| G5 | 14 | 159.91 |
| G6 | 22 | 150.79 |
| G7 | 24 | −109.63 |
| Gr | 26 | 1153.71 |
| G1f | 1 | 422.50 |

### Numerical Value Example 10

Unit: mm
[Surface Data]

| Surface Number | r | d | nd | vd |
|---|---|---|---|---|
| Object surface | ∞ | (d0) | | |
| 1 | 353.1292 | 6.5026 | 1.65844 | 50.88 |
| 2 | −1117.4136 | 103.4926 | | |
| 3 | 75.2157 | 5.5556 | 1.43700 | 95.10 |
| 4 | 102.9785 | 8.7501 | | |
| 5 | −469.9968 | 3.0000 | 1.73037 | 32.23 |
| 6 | 1988.7956 | 1.0000 | | |
| 7 | 77.3542 | 11.5237 | 1.43700 | 95.10 |
| 8 | −1041.2822 | (d8) | | |
| 9 | 237.3335 | 1.5013 | 1.59349 | 67.00 |
| 10 | 64.2402 | (d10) | | |
| 11 | −135.0811 | 1.5000 | 1.75500 | 52.32 |
| 12 | 72.3211 | 3.0104 | 1.84666 | 23.78 |
| 13 | 104.1754 | (d13) | | |
| 14 | 155.3859 | 6.5320 | 1.43700 | 95.10 |
| 15 | −135.4312 | 9.0225 | | |
| 16 | 89.0182 | 6.1800 | 1.43700 | 95.10 |
| 17 | −345.1508 | (d17) | | |
| 18 | 78.5291 | 6.4960 | 1.43700 | 95.10 |
| 19 | −103.3848 | 3.0000 | 1.85150 | 40.78 |
| 20 | 190.4526 | (d20) | | |
| 21(diaphragm) | ∞ | 1.2000 | | |
| 22 | −101.4344 | 1.8285 | 1.43700 | 95.10 |
| 23 | −136.3784 | 0.2000 | | |
| 24 | 469.9272 | 2.2940 | 1.90110 | 27.06 |
| 25 | −469.9406 | (d25) | | |
| 26 | −815.7041 | 1.0000 | 1.92119 | 23.96 |
| 27 | 121.6636 | (d27) | | |
| 28 | 101.8747 | 4.4631 | 1.67300 | 38.26 |
| 29 | −43.3986 | 1.5000 | 1.92119 | 23.96 |
| 30 | −80.5636 | 5.6986 | | |
| 31 | 119.5650 | 3.7522 | 1.85451 | 25.15 |
| 32 | −54.2207 | 1.0000 | 1.83481 | 42.72 |
| 33 | 46.1706 | 1.6844 | | |
| 34 | 242.8739 | 0.8000 | 1.75500 | 52.32 |
| 35 | 46.8431 | 2.6488 | | |
| 36 | 26.9879 | 3.6746 | 1.65160 | 58.54 |
| 37 | 29.3999 | 1.8624 | | |
| 38 | 33.1030 | 5.1638 | 1.85451 | 25.15 |
| 39 | −600.2979 | 1.1512 | | |
| 40 | ∞ | 1.3753 | 2.00069 | 25.46 |
| 41 | 18.7998 | 9.3110 | 1.64769 | 33.84 |
| 42 | −128.0053 | 3.1565 | | |
| 43 | −39.5949 | 1.0000 | 1.55032 | 75.50 |
| 44 | 21.5549 | 6.4091 | 1.72047 | 34.71 |
| 45 | 179.7006 | 0.2000 | | |
| 46 | 50.5017 | 8.7021 | 1.77047 | 29.74 |
| 47 | −24.6526 | 0.9500 | 2.00069 | 25.46 |
| 48 | 100.7060 | (d48) | | |
| 49 | ∞ | 1.5000 | 1.51680 | 64.20 |
| 50 | ∞ | (BF) | | |
| Image surface | ∞ | | | |

[Various Kinds of Data]
Zoom ratio 2.54

| | Wide angle | middle | telephoto |
|---|---|---|---|
| Focal length | 309.00 | 490.00 | 785.00 |
| F number | 6.39 | 7.66 | 8.22 |
| Full angle of view 2ω | 7.90 | 4.97 | 3.10 |
| Image height Y | 21.63 | 21.63 | 21.63 |
| Entire length of lens | 476.26 | 476.26 | 476.26 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d8 | 9.6263 | 15.3842 | 20.7897 |
| d10 | 11.3439 | 10.4556 | 11.0361 |
| d13 | 84.0042 | 44.5411 | 3.6763 |
| d17 | 24.2522 | 28.5472 | 16.4343 |
| d20 | 19.2294 | 15.2192 | 44.2320 |
| d25 | 5.7422 | 6.4806 | 3.0000 |
| d27 | 31.8972 | 62.9671 | 80.9562 |
| d48 | 5.9702 | 8.4707 | 11.9410 |
| BF | 34.5999 | 34.5999 | 34.5999 |

At time of photographing magnification of 1:40

| | | | |
|---|---|---|---|
| d0 | 11966.4471 | 19315.3473 | 31308.2297 |
| d8 | 9.6263 | 15.3842 | 20.7897 |
| d10 | 11.3439 | 10.4556 | 11.0361 |
| d13 | 84.0042 | 44.5411 | 3.6763 |
| d17 | 24.2522 | 28.5472 | 16.4343 |
| d20 | 19.2294 | 15.2192 | 44.2320 |
| d25 | 8.1835 | 9.4252 | 6.9703 |
| d27 | 29.4560 | 60.0225 | 76.9859 |
| d48 | 5.9702 | 8.4707 | 11.9410 |
| BF | 34.5999 | 34.5999 | 34.5999 |

[Lens Group Data]

| Group | start surface | focal length |
|---|---|---|
| G1 | 1 | 154.34 |
| G2 | 9 | −148.89 |
| G3 | 11 | −79.75 |
| G4 | 14 | 85.45 |
| G5 | 18 | −371.74 |
| G6 | 21 | 361.19 |
| G7 | 26 | −114.87 |
| Gr | 28 | −514.23 |
| G1f | 1 | 408.24 |

### Numerical Value Example 11

Unit: mm
[Surface Data]

| Surface Number | r | d | nd | vd |
|---|---|---|---|---|
| Object surface | ∞ | (d0) | | |
| 1 | 480.4814 | 9.1865 | 1.65844 | 50.86 |
| 2 | −3601.8351 | 8.5320 | | |
| 3 | 207.7729 | 11.5068 | 1.43385 | 95.23 |
| 4 | 663.1847 | 95.0167 | | |
| 5 | 95.4334 | 8.5152 | 1.43700 | 95.10 |
| 6 | 130.9898 | 10.5135 | | |
| 7 | 294.1774 | 3.1464 | 1.73037 | 32.23 |
| 8 | 110.1009 | 1.0000 | | |
| 9 | 75.1546 | 14.8614 | 1.43700 | 95.10 |
| 10 | 3663.2470 | (d10) | | |
| 11 | −3008.3343 | 1.9999 | 1.59349 | 67.00 |
| 12 | 69.7806 | (d12) | | |
| 13 | −158.5516 | 1.9999 | 1.75500 | 52.32 |
| 14 | 112.8870 | 4.7815 | 1.84666 | 23.78 |
| 15 | 384.9032 | (d15) | | |
| 16 | 225.8322 | 6.7267 | 1.43700 | 95.10 |
| 17 | −201.9352 | 5.2281 | | |
| 18 | 194.1023 | 8.3631 | 1.43700 | 95.10 |
| 19 | −144.0931 | 0.1500 | | |
| 20 | 122.4028 | 9.7780 | 1.43700 | 95.10 |
| 21 | −113.2253 | 2.0000 | 1.85150 | 40.78 |
| 22 | 1092.4344 | (d22) | | |
| 23(diaphragm) | ∞ | 1.8915 | | |
| 24 | 122.0196 | 3.3915 | 1.43700 | 95.10 |
| 25 | 309.3819 | 0.2178 | | |
| 26 | 81.5515 | 3.0713 | 1.89190 | 37.13 |
| 27 | 122.5713 | (d27) | | |
| 28 | 257.2547 | 1.0000 | 1.85478 | 24.80 |
| 29 | 55.8428 | (d29) | | |
| 30 | 105.6837 | 5.7910 | 1.80450 | 39.64 |
| 31 | −45.9501 | 0.9000 | 1.70154 | 41.15 |
| 32 | −609.6345 | (d32) | | |
| 33 | 44.0206 | 3.6708 | 1.85451 | 25.15 |
| 34 | −264.4793 | 0.8000 | 1.82080 | 42.71 |
| 35* | 36.9693 | 2.8821 | | |
| 36 | −231.7817 | 0.8000 | 1.75500 | 52.32 |
| 37 | 40.5913 | 2.0000 | | |
| 38 | 29.5496 | 5.6642 | 1.65160 | 58.54 |
| 39 | 139.3026 | 0.2000 | | |
| 40 | 48.7902 | 4.0812 | 1.85451 | 25.15 |
| 41 | 105.4440 | 5.1468 | | |
| 42 | ∞ | 1.0000 | 2.00069 | 25.46 |
| 43 | 18.6418 | 8.2271 | 1.64769 | 33.84 |
| 44 | −72.5015 | 2.8418 | | |
| 45 | −36.6547 | 1.0000 | 1.55032 | 75.50 |
| 46 | 23.1445 | 7.0797 | 1.72047 | 34.71 |
| 47 | −374.8219 | 0.2000 | | |
| 48 | 80.9709 | 7.7465 | 1.77047 | 29.74 |
| 49 | −24.9849 | 0.9500 | 2.00069 | 25.46 |
| 50 | 149.5518 | 5.6500 | | |
| 51 | ∞ | 1.5000 | 1.51680 | 64.20 |
| 52 | ∞ | (BF) | | |
| Image surface | ∞ | | | |

[Aspherical Surface Data]

| | 35 surfaces |
|---|---|
| K | 0.0000 |
| A4 | −1.16469E−06 |
| A6 | −1.17638E−09 |
| A8 | −5.26393E−13 |

[Various Kinds of Data]
Zoom ratio 1.87

| | Wide angle | middle | telephoto |
|---|---|---|---|
| Focal length | 309.00 | 470.87 | 579.00 |
| F number | 4.13 | 4.10 | 4.11 |
| Full angle of view 2ω | 7.89 | 5.17 | 4.20 |
| Image height Y | 21.63 | 21.63 | 21.63 |
| Entire length of lens | 454.85 | 454.85 | 454.85 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d10 | 3.2481 | 15.9458 | 18.6805 |
| d12 | 12.2374 | 15.8119 | 17.2718 |
| d15 | 59.4545 | 21.9875 | 3.0000 |
| d22 | 5.2569 | 26.4516 | 41.2446 |
| d27 | 13.8064 | 6.8671 | 5.4708 |
| d29 | 32.2289 | 43.3155 | 51.5687 |
| d32 | 13.0042 | 8.8569 | 2.0000 |
| BF | 34.6000 | 34.6000 | 34.6000 |

At time of photographing magnification of 1:40

| | | | |
|---|---|---|---|
| d0 | 11961.3586 | 18398.4998 | 22707.3668 |
| d10 | 3.2481 | 15.9458 | 18.6805 |
| d12 | 12.2374 | 15.8119 | 17.2718 |
| d15 | 59.4545 | 21.9875 | 3.0000 |
| d22 | 5.2569 | 26.4516 | 41.2446 |
| d27 | 15.2980 | 8.8089 | 7.8982 |
| d29 | 30.2844 | 40.3857 | 48.2281 |
| d32 | 13.4571 | 9.8449 | 2.9133 |
| BF | 34.6000 | 34.6000 | 34.6000 |

[Lens Group Data]

| Group | start surface | focal length |
|---|---|---|
| G1 | 1 | 206.50 |
| G2 | 11 | −114.88 |
| G3 | 13 | −161.82 |
| G4 | 16 | 115.41 |
| G5 | 23 | 167.73 |
| G6 | 28 | −83.63 |
| G7 | 30 | 91.62 |
| Gr | 33 | −58.36 |
| G1f | 1 | 336.17 |

### Numerical Value Example 12

Unit: mm
[Surface Data]

| Surface Number | r | d | nd | vd |
|---|---|---|---|---|
| Object surface | ∞ | (d0) | | |
| 1 | 404.6267 | 10.1334 | 1.65844 | 50.88 |
| 2 | −3831.7856 | 0.5000 | | |
| 3 | 252.2980 | 11.4716 | 1.43385 | 95.23 |
| 4 | 1017.5168 | 91.9969 | | |
| 5 | 86.2041 | 6.7519 | 1.43700 | 95.10 |
| 6 | 115.4236 | 7.9478 | | |
| 7 | 411.5948 | 3.0000 | 1.73037 | 32.23 |
| 8 | 125.7737 | 1.0000 | | |
| 9 | 79.7197 | 14.3844 | 1.43700 | 95.10 |
| 10 | 843.9377 | (d10) | | |
| 11 | 588.4911 | 1.9999 | 1.59349 | 67.00 |
| 12 | 73.7950 | (d12) | | |
| 13 | −190.7125 | 1.9998 | 1.75500 | 52.32 |
| 14 | 90.8758 | 4.7609 | 1.84666 | 23.78 |
| 15 | 201.9207 | (d15) | | |
| 16 | 196.7784 | 6.7361 | 1.43700 | 95.10 |
| 17 | −231.1870 | 0.1500 | | |
| 18 | 145.2225 | 8.0467 | 1.43700 | 95.10 |
| 19 | −184.1237 | 0.1500 | | |
| 20 | 100.3010 | 10.1152 | 1.43700 | 95.10 |
| 21 | −134.3077 | 1.9999 | 1.85150 | 40.78 |
| 22 | 643.1694 | (d22) | | |
| 23(diaphragm) | ∞ | 5.2896 | | |
| 24 | 95.4347 | 5.1536 | 1.43700 | 95.10 |
| 25 | 857.8402 | 0.2000 | | |
| 26 | 82.8474 | 3.3667 | 1.90110 | 27.06 |
| 27 | 89.7760 | (d27) | | |
| 28 | −702.8285 | 1.0000 | 1.85451 | 25.15 |
| 29 | 67.1564 | (d29) | | |
| 30 | 168.1702 | 5.0792 | 1.80450 | 39.64 |
| 31 | −40.5788 | 1.0000 | 1.70154 | 41.15 |
| 32 | −160.2239 | 3.1286 | | |
| 33 | 67.9686 | 3.7928 | 1.85451 | 25.15 |
| 34 | −97.8213 | 1.0000 | 1.83481 | 42.72 |
| 35 | 40.6889 | 2.5950 | | |
| 36 | −206.4650 | 0.8000 | 1.75500 | 52.32 |
| 37 | 70.6192 | 2.0000 | | |
| 38 | 26.6306 | 4.8077 | 1.65160 | 58.54 |
| 39 | 50.0569 | 2.6880 | | |
| 40 | 40.2573 | 4.6375 | 1.85451 | 25.15 |
| 41 | 142.2125 | 3.5545 | | |
| 42 | ∞ | 1.0000 | 2.00069 | 25.46 |
| 43 | 17.6564 | 8.4039 | 1.64769 | 33.84 |
| 44 | −66.8099 | 4.3169 | | |
| 45 | −27.8712 | 1.0000 | 1.55032 | 75.50 |
| 46 | 21.6406 | 7.9627 | 1.72047 | 34.71 |
| 47 | −179.9346 | 0.2000 | | |
| 48 | 52.8552 | 10.6761 | 1.77047 | 29.74 |
| 49 | −22.3760 | 0.9500 | 2.00069 | 25.46 |
| 50 | 99.4572 | 5.9810 | | |
| 51 | ∞ | 1.5000 | 1.51680 | 64.20 |
| 52 | ∞ | (BF) | | |
| Image surface | ∞ | | | |

[Various Kinds of Data]
Zoom ratio 1.87

| | Wide angle | middle | telephoto |
|---|---|---|---|
| Focal length | 309.00 | 468.15 | 579.00 |
| F number | 4.16 | 4.17 | 4.19 |
| Full angle of view 2ω | 7.90 | 5.20 | 4.20 |
| Image height Y | 21.63 | 21.63 | 21.63 |
| Entire length of lens | 453.46 | 453.46 | 453.46 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d10 | 8.7382 | 14.8139 | 13.3515 |
| d12 | 11.7251 | 34.4996 | 52.0309 |
| d15 | 78.0111 | 31.3571 | 3.0000 |
| d22 | 5.7022 | 23.5061 | 35.7942 |
| d27 | 15.1860 | 9.5160 | 9.5588 |
| d29 | 24.2651 | 29.9351 | 29.8922 |
| BF | 34.6000 | 34.6000 | 34.6000 |

At time of photographing magnification of 1:40

| | | | |
|---|---|---|---|
| d0 | 11945.2658 | 18303.7890 | 22836.0851 |
| d10 | 8.7382 | 14.8139 | 13.3515 |
| d12 | 11.7251 | 34.4996 | 52.0309 |
| d15 | 78.0111 | 31.3571 | 3.0000 |
| d22 | 5.7022 | 23.5061 | 35.7942 |
| d27 | 16.7907 | 11.8718 | 12.4756 |
| d29 | 22.6603 | 27.5793 | 26.9754 |
| BF | 34.6000 | 34.6000 | 34.6000 |

[Lens Group Data]

| Group | start surface | focal length |
|---|---|---|
| G1 | 1 | 214.12 |
| G2 | 11 | −142.37 |
| G3 | 13 | −139.09 |
| G4 | 16 | 103.06 |
| G5 | 23 | 193.59 |
| G6 | 28 | −71.69 |
| Gr | 30 | 505.75 |
| G1f | 1 | 323.78 |

### Numerical Value Example 13

Unit: mm
[Surface Data]

| Surface Number | r | d | nd | vd |
|---|---|---|---|---|
| Object surface | ∞ | (d0) | | |
| 1 | 246.1490 | 10.5674 | 1.66672 | 48.32 |
| 2 | 808.5325 | 0.5000 | | |
| 3 | 256.0515 | 10.3600 | 1.43385 | 95.23 |
| 4 | 1098.7832 | 95.2385 | | |
| 5 | 179.6273 | 6.6172 | 1.43700 | 95.10 |
| 6 | 399.7019 | 13.0690 | | |
| 7 | −2414.9230 | 3.0000 | 1.73037 | 32.23 |
| 8 | 144.2653 | 1.0000 | | |
| 9 | 72.5793 | 14.5347 | 1.43700 | 95.10 |
| 10 | 916.1688 | (d10) | | |
| 11 | −798.8116 | 1.9999 | 1.60311 | 60.64 |
| 12 | 68.6859 | (d12) | | |
| 13 | −598.1034 | 1.9995 | 1.75500 | 52.32 |
| 14 | 92.8578 | 4.9572 | 1.92119 | 23.96 |
| 15 | 230.8275 | (d15) | | |
| 16 | 235.1517 | 4.4980 | 1.43700 | 95.10 |
| 17 | −5192.6122 | 0.1500 | | |
| 18 | 145.5140 | 9.5038 | 1.43700 | 95.10 |
| 19 | −118.5206 | 0.1500 | | |
| 20 | 137.3500 | 9.9066 | 1.43700 | 95.10 |
| 21 | −104.3365 | 1.9996 | 1.85150 | 40.78 |
| 22 | −4843.5303 | (d22) | | |
| 23(diaphragm) | ∞ | 1.2000 | | |
| 24 | 99.5571 | 3.4516 | 1.43700 | 95.10 |
| 25 | 224.3639 | 0.2003 | | |
| 26 | 63.7225 | 3.1411 | 1.89190 | 37.13 |
| 27 | 86.0013 | (d27) | | |
| 28 | 190.1783 | 1.0000 | 1.96300 | 24.11 |
| 29 | 52.8549 | (d29) | | |
| 30 | 117.7347 | 7.3832 | 1.80440 | 39.58 |
| 31 | −40.7972 | 0.9000 | 1.76684 | 46.78 |
| 32 | −215.9869 | (d32) | | |
| 33 | 36.1154 | 4.0126 | 1.85451 | 25.15 |
| 34 | 338.3700 | 0.8000 | 1.82080 | 42.71 |
| 35* | 34.5629 | 3.3591 | | |
| 36 | −249.5775 | 0.8000 | 1.75500 | 52.32 |
| 37 | 32.3152 | 2.0000 | | |
| 38 | 29.2974 | 5.3638 | 1.65160 | 58.54 |
| 39 | 770.6298 | 0.2000 | | |
| 40 | 44.3154 | 2.8001 | 1.85451 | 25.15 |
| 41 | 78.8198 | 2.5233 | | |
| 42 | ∞ | 0.9500 | 2.00069 | 25.46 |
| 43 | 19.6362 | 9.5956 | 1.64769 | 33.84 |
| 44 | −46.4945 | 2.4578 | | |
| 45 | −33.1428 | 1.0000 | 1.55032 | 75.50 |
| 46 | 21.7541 | 10.0013 | 1.72047 | 34.71 |
| 47 | −38.6436 | 0.2000 | | |
| 48 | −50.1243 | 5.7169 | 1.77047 | 29.74 |
| 49 | −20.3455 | 0.9500 | 2.00069 | 25.46 |
| 50 | 278.0263 | 5.6492 | | |
| 51 | ∞ | 1.5000 | 1.51680 | 64.20 |
| 52 | ∞ | (BF) | | |
| Image surface | ∞ | | | |

[Aspherical Surface Data]

| | 35 surfaces |
|---|---|
| K | 0.00000 |
| A4 | −2.32586E−06 |
| A6 | −3.73048E−09 |
| A8 | 6.48941E−13 |
| A10 | −2.13024E−14 |
| A12 | 3.12177E−17 |

[Various Kinds of Data]
Zoom ratio 1.87

| | Wide angle | middle | telephoto |
|---|---|---|---|
| Focal length | 309.00 | 483.00 | 579.00 |
| F number | 4.11 | 4.13 | 4.14 |
| Full angle of view 2ω | 7.89 | 5.04 | 4.20 |
| Image height Y | 21.63 | 21.63 | 21.63 |
| Entire length of lens | 451.46 | 451.46 | 451.46 |

[Variable Distance Data]

| | | |
|---|---|---|
| Wide angle | middle | telephoto |

At time of focusing on infinity

| | | | |
|---|---|---|---|
| d0 | ∞ | ∞ | ∞ |
| d10 | 4.5597 | 20.9195 | 22.8196 |
| d12 | 10.8460 | 11.4681 | 16.4553 |
| d15 | 62.1280 | 23.5054 | 3.0000 |
| d22 | 4.9418 | 26.5825 | 40.2005 |
| d27 | 8.3267 | 7.8223 | 7.8115 |
| d29 | 35.8612 | 50.9536 | 57.3665 |
| d32 | 22.9901 | 8.4021 | 2.0000 |
| BF | 34.6008 | 34.6008 | 34.6008 |

At time of photographing magnification of 1:40

| | | | |
|---|---|---|---|
| d0 | 11994.7788 | 18880.9840 | 22668.6274 |
| d10 | 4.5597 | 20.9195 | 22.8196 |
| d12 | 10.8460 | 11.4681 | 16.4553 |
| d15 | 62.1280 | 23.5054 | 3.0000 |
| d22 | 4.9418 | 26.5825 | 40.2005 |
| d27 | 9.7116 | 9.5807 | 9.8124 |
| d29 | 33.9763 | 48.1051 | 54.0775 |
| d32 | 23.4901 | 9.4922 | 3.2881 |
| BF | 34.6008 | 34.6008 | 34.6008 |

[Lens Group Data]

| Group | start surface | focal length |
|---|---|---|
| G1 | 1 | 238.17 |
| G2 | 11 | −104.78 |
| G3 | 13 | −288.92 |
| G4 | 16 | 122.24 |
| G5 | 23 | 158.01 |
| G6 | 28 | −76.28 |
| G7 | 30 | 89.57 |
| Gr | 33 | −56.98 |
| G1f | 1 | 314.04 |

Also, a list of corresponding values in the conditional expressions in these examples will be shown.

[Corresponding Values in Conditional Expressions]

| Conditional | Exam- | Exam- | Exam- | Exam- |
|---|---|---|---|---|
| expression | ple 1 | ple 2 | ple 3 | ple 4 |
| (1) LT/ft | 0.83 | 0.57 | 0.80 | 0.80 |
| (2) d1/LT | 0.35 | 0.30 | 0.27 | 0.23 |
| (3) f1f/f1 | 1.69 | 1.74 | 2.48 | 1.50 |
| (4) f1/ft | 0.44 | 0.22 | 0.29 | 0.39 |
| (5) SG1fp | 3.50 | 3.50/3.70 | 3.50 | 3.50/3.70 |
| (6)vd1fp | 50.88 | 50.88/95.23 | 50.88 | 50.88/81.62 |
| (7)f2/ft | −0.52 | −0.17 | −0.20 | −0.35 |
| (8) f 3/ft | −0.17 | −0.10 | −0.18 | −0.18 |
| (9) EXP/LT wide- | 0.18 | 0.20 | 0.18 | 0.19 |
| angle end | | | | |
| Middle zoom position | 0.19 | 0.21 | 0.18 | 0.19 |
| Telephoto end | 0.19 | 0.22 | 0.18 | 0.19 |
| (10) \| βTosb × | 2.00 | 2.53 | 2.00 | 2.00 |
| (1 − βTos) \| | | | | |
| (11)Ds/LT | 0.33 | 0.36 | 0.34 | 0.36 |
| (12)2ωw | 7.89 | 5.96 | 7.98 | 7.88 |
| (13)2ωt | 4.21 | 3.09 | 4.24 | 4.20 |

| Conditional | Exam- | Exam- | Exam- | Exam- |
|---|---|---|---|---|
| expression | ple 5 | ple 6 | ple 7 | ple 8 |
| (1) LT/ft | 0.56 | 0.61 | 0.60 | 0.60 |
| (2) d1/LT | 0.22 | 0.22 | 0.24 | 0.22 |
| (3) f1f/f1 | 2.57 | 2.42 | 1.81 | 2.65 |
| (4) f1/ft | 0.20 | 0.23 | 0.23 | 0.20 |
| (5) SG1fp | 3.50 | 3.50 | 3.28 | 3.50 |
| (6) vd1fp | 50.88 | 50.88 | 67.00 | 50.88 |
| (7) f2/ft | −0.21 | −0.18 | −0.17 | −0.20 |
| (8) f 3/ft | −0.10 | −0.11 | −0.13 | −0.10 |
| (9) EXP/LT wide- | 0.20 | 0.20 | 0.32 | 0.18 |
| angle end | | | | |
| Middle zoom position | 0.21 | 0.19 | 0.45 | 0.20 |
| Telephoto end | 0.22 | 0.21 | 0.45 | 0.21 |
| (10) \| βTosb × | 2.42 | 2.00 | 2.00 | 2.00 |
| (1 − βTos) \| | | | | |
| (11)Ds/LT | 0.34 | 0.36 | 0.33 | 0.32 |
| (12)2ωw | 5.96 | 13.15 | 8.04 | 7.92 |
| (13)2ωt | 3.09 | 3.09 | 3.16 | 3.09 |

| Conditional | Exam- | Exam- | Exam- | Exam- |
|---|---|---|---|---|
| expression | ple 9 | ple 10 | ple 11 | ple 12 |
| (1)LT/ft | 0.85 | 0.61 | 0.79 | 0.78 |
| (2) d1/LT | 0.22 | 0.22 | 0.21 | 0.20 |
| (3) f1f/f1 | 1.76 | 2.64 | 1.63 | 1.51 |
| (4) f1/ft | 0.41 | 0.20 | 0.36 | 0.37 |
| (5)SG1fp | 2.43 | 3.50 | 3.64/3.18 | 3.50/3.18 |
| (6)vd1fp | 52.15 | 50.88 | 50.86/95.23 | 50.88/95.23 |
| (7) f2/ft | −0.60 | −0.19 | −0.20 | −0.25 |
| (8) f 3/ft | −0.15 | −0.10 | −0.28 | −0.24 |
| (9) EXP/LT wide- | 0.17 | 0.18 | 0.20 | 0.20 |
| angle end | | | | |
| Middle zoom position | 0.17 | 0.20 | 0.20 | 0.20 |
| Telephoto end | 0.17 | 0.22 | 0.21 | 0.20 |
| (10) \| βTosb × | 2.00 | 2.19 | 2.00 | 2.00 |
| (1 − βTos) \| | | | | |
| (11)Ds/LT | 0.34 | 0.32 | 0.38 | 0.37 |
| (12)2ωw | 7.94 | 7.90 | 7.89 | 7.90 |
| (13)2ωt | 4.24 | 3.10 | 4.20 | 4.20 |

| Conditional Expression | Example 13 |
|---|---|
| (1) LT/ft | 0.78 |
| (2) d1/LT | 0.21 |
| (3) f1f/f1 | 1.32 |
| (4) f1/ft | 0.41 |
| (5) SG1fp | 3.59/3.18 |
| (6) vd1fp | 48.32/95.23 |
| (7) f2/ft | −0.18 |
| (8) f 3/ft | −0.50 |
| (9) EXP/LT wide-angle end | 0.19 |
| Middle zoom position | 0.20 |
| Telephoto end | 0.21 |
| (10) \| βTosb × (1 − βTos) \| | 2.00 |
| (11)Ds/LT | 0.40 |
| (12)2ωw | 7.89 |
| (13)2ωt | 4.20 |

Furthermore, the present technology can also adopt configurations as follows.

### [Item 1]

A telephoto zoom lens comprising, in order from an object side to an image side: a first lens group G1 with a positive refractive power; a middle lens group Gm; and a final lens group Gr, in which at a time of zooming from a wide-angle end to a telephoto end, the first lens group G1 is fixed with respect to an image surface, distances between adjacent lens groups change, focusing from an infinity object distance to an extremely close range is performed by moving a part or a plurality of lens groups in the middle lens group Gm, the first lens group G1 includes a front sub-lens group Gif located on the object side and a rear sub-lens group G1r located on the image side, and conditional expressions below are satisfied:

$$LT / ft < 0.93 \qquad ( 1 )$$

$$0.17 < d 1 / LT < 0. 45 \qquad ( 2 )$$

where
LT is a distance from a surface on a side closest to an object in an entire lens system to an image surface on an optical axis,
ft is a focal length of the entire lens system at the telephoto end at the time of focusing on infinity, and
d1 is a distance from a surface of the front sub-lens group Gif on a side closest to an image to a surface of the rear sub-lens group G1r on a side closest to the object.

### [Item 2]

The telephoto zoom lens according to [Item 1], in which a conditional expression below is satisfied:

$$1. 01 < f 1 f / f 1 < 3.45 \qquad ( 3 )$$

where
f1f is a focal length of the front sub-lens group G1f, and
f1 is a focal length of the first lens group G1.

### [Item 3]

The telephoto zoom lens according to [Item 1] or [Item 2], in which the first lens group G1 satisfies a conditional expression below:

$$0.15 < f 1 / ft < 0.57 \qquad ( 4 )$$

where
f1 is a focal length of the first lens group G1.

### [Item 4]

The telephoto zoom lens according to any one of [Item 1] to [Item 3], in which the first lens group G1 is composed of five or less lens elements.

### [Item 5]

The telephoto zoom lens according to any one of [Item 1] to [Item 4], in which the front sub-lens group Gif includes at least one positive lens element that satisfies a conditional expression below:

$$SG 1 fp < 4. \qquad ( 5 )$$

$$45. < vd 1 fp \qquad ( 6 )$$

where

SG1fp is a specific weight of the positive lens element, and
vd1fp is an Abbe number of the positive lens element.

### [Item 6]

The telephoto zoom lens according to any one of [Item 1] to [Item 5], in which a second lens group G2 with a negative refractive power is disposed on a side closest to the object in the middle lens group Gm, and a conditional expression below is satisfied:

$$- 0.78 < f 2 / ft < - 0.13 \qquad ( 7 )$$

where
f2 is a focal length of the second lens group G2.

### [Item 7]

The telephoto zoom lens according to [Item 6], in which the middle lens group Gm includes a third lens group G3 that is disposed to be adjacent to the second lens group G2 on the image side and has negative reflective power, and a conditional expression below is satisfied:

$$- 0.65 < f 3 / ft < - 0.07 \qquad ( 8 )$$

where
f3 is a focal length of the third lens group G3.

### [Item 8]

The telephoto zoom lens according to any one of [Item 1] to [Item 7], in which a conditional expression below is satisfied:

$$0.13 < EXP / LT < 0.75 \qquad ( 9 )$$

where
EXP is a distance from an exit pupil to the image surface at the wide-angle end in an entire zoom range from a wide-angle end to a telephoto end at the time of focusing on infinity.

### [Item 9]

The telephoto zoom lens according to any one of [Item 1] to [Item 8], in which the final lens group Gr includes a vibration reduction lens group Gos that performs vibration reduction by moving a part of the vibration reduction lens group Gos in a substantially vertical direction, and a conditional expression below is satisfied:

$$1.54 < \vert β Tosb \times ( 1 - β Tos ) \vert < 3.3 \qquad ( 10 )$$

where
BTosb is a lateral magnification of a lens group disposed on a side closer to the image than the vibration reduction lens group Gos at the telephoto end at the time of focusing on infinity, and
BTos is a lateral magnification of the vibration reduction lens group Gos at the telephoto end at the time of focusing on infinity.

### [Item 10]

The telephoto zoom lens according to [Item 6], in which the second lens group G2 consists of one negative lens element.

### [Item 11]

The telephoto zoom lens according to any one of [Item 1] to [Item 10], comprising an aperture diaphragm S, wherein focusing from an infinity object distance to an extremely close range is performed by moving at least one lens group disposed on the side closer to the image than the aperture diaphragm S.

### [Item 12]

The telephoto zoom lens according to [Item 11], in which a conditional expression below is satisfied:

$$0.24 < Ds / LT < 0.52 \qquad ( 11 )$$

where
Ds is a distance from the aperture diaphragm S to the image surface at the wide angle end.

### [Item 13]

The telephoto zoom lens according to any one of [Item 1] to [Item 12], in which one or two lens groups that move at the time of focusing, each consists of a single lens element.

### [Item 14]

The telephoto zoom lens according to any one of [Item 1] to [Item 13], in which a diffractive optical element is not included.

The above description of the examples explains illustrative examples of the telephoto zoom lens according to the present invention, and the present invention is not limited by the examples without departing from the gist thereof. Various design modifications, modified implementations, combinations, and sub-combinations can be made, and all of these are also included within a scope equivalent to the present invention.

### REFERENCE SIGNS LIST

G1 First lens group
Gm Middle lens group
Gr Final lens group
G2 Second lens group
G3 Third lens group
G4 Fourth lens group
G5 Fifth lens group
G6 Sixth lens group
G7 Seventh lens group
G1f Front sub-lens group
G1r Rear sub-lens group
Gos Vibration reduction lens group
S Aperture diaphragm
fr Filter

What is claimed is:

1. A telephoto zoom lens comprising, in order from an object side to an image side: a first lens group G1 with a positive refractive power; a middle lens group Gm; and a final lens group Gr, wherein at a time of zooming from a wide-angle end to a telephoto end, the first lens group G1 is fixed with respect to an image surface, distances between adjacent lens groups change, focusing from an infinity object distance to an extremely close range is performed by moving a part or a plurality of lens groups in the middle lens group Gm, the first lens group G1 includes a front sub-lens group Gif located on the object side and a rear sub-lens group G1r located on the image side, and conditional expressions below are satisfied:
$$LT / ft < 0.93 \qquad ( 1 )$$
$$0.17 < d 1 / LT < 0.45 \qquad ( 2 )$$
where
LT is a distance from a surface on a side closest to an object in an entire lens system to an image surface on an optical axis,
ft is a focal length of the entire lens system at the telephoto end at the time of focusing on infinity, and
d1 is a distance from a surface of the front sub-lens group Gif on a side closest to an image to a surface of the rear sub-lens group G1r on a side closest to the object.

2. The telephoto zoom lens according to claim 1, wherein a conditional expression below is satisfied:
$$1.01 < f 1 f / f 1 < 3.45 \qquad ( 3 )$$
where
f1f is a focal length of the front sub-lens group G1f, and
f1 is a focal length of the first lens group G1.

3. The telephoto zoom lens according to claim 1, wherein the first lens group G1 satisfies a conditional expression below:
$$0.15 < f 1 / ft < 0.57 \qquad ( 4 )$$
where f1 is a focal length of the first lens group G1.

4. The telephoto zoom lens according to claim 1, wherein the first lens group G1 is composed of five or less lens elements.

5. The telephoto zoom lens according to claim 1, wherein the front sub-lens group Gif includes at least one positive lens element that satisfies a conditional expression below:
$$SG 1 fp < 4. \qquad ( 5 )$$
$$45. < vd 1 fp \qquad ( 6 )$$
where
SG1fp is a specific weight of the positive lens element, and
vd1fp is an Abbe number of the positive lens element.

6. The telephoto zoom lens according to claim 1, wherein a second lens group G2 with a negative refractive power is disposed on a side closest to the object in the middle lens group Gm, and a conditional expression below is satisfied:
$$- 0.78 < f 2 / ft < - 0.13 \qquad ( 7 )$$
where
f2 is a focal length of the second lens group G2.

7. The telephoto zoom lens according to claim 6, wherein the middle lens group Gm includes a third lens group G3 that is disposed to be adjacent to the second lens group G2 on the image side and has negative reflective power, and a conditional expression below is satisfied:
$$- 0.65 < f 3 / ft < - 0.07 \qquad ( 8 )$$
where f3 is a focal length of the third lens group G3.

8. The telephoto zoom lens according to claim 1, wherein a conditional expression below is satisfied:
$$0.13 < EXP / LT < 0.75 \qquad ( 9 )$$
where EXP is a distance from an exit pupil to the image surface at the wide-angle end in an entire zoom range from a wide-angle end to a telephoto end at the time of focusing on infinity.

9. The telephoto zoom lens according to claim 1, wherein the final lens group Gr includes a vibration reduction lens group Gos that performs vibration reduction by moving a part of the vibration reduction lens group Gos in a substantially vertical direction, and a conditional expression below is satisfied:
$$1.54 < \vert β Tosb \times ( 1 - β Tos ) \vert < 3.3 \qquad ( 10 )$$
where
BTosb is a lateral magnification of a lens group disposed on a side closer to the image than the vibration reduction lens group Gos at the telephoto end at the time of focusing on infinity, and
BTos is a lateral magnification of the vibration reduction lens group Gos at the telephoto end at the time of focusing on infinity.

10. The telephoto zoom lens according to claim 6, wherein the second lens group G2 consists of one negative lens element.

11. The telephoto zoom lens according to claim 1, comprising an aperture diaphragm S, wherein focusing from an infinity object distance to an extremely close range is performed by moving at least one lens group disposed on the side closer to the image than the aperture diaphragm S.

12. The telephoto zoom lens according to claim 11, wherein a conditional expression below is satisfied:
$$0.24 < Ds / LT < 0.52 \qquad ( 11 )$$
where Ds is a distance from the aperture diaphragm S to the image surface at the wide angle end.

13. The telephoto zoom lens according to claim 1, wherein one or two lens groups that move at the time of focusing, each consists of a single lens element.

14. The telephoto zoom lens according to claim 1, wherein a diffractive optical element is not included.
